(19) United States
(12) Patent Application Publication
(10) Pub. No.: US 2025/0102766 A1
(43) Pub. Date: Mar. 27, 2025

(54) OPTICAL IMAGING SYSTEM

(71) Applicant: SAMSUNG ELECTRO-MECHANICS CO., LTD., Suwon-si (KR)

(72) Inventors: Do Hyeong JANG, Suwon-si (KR); Tae Yeon LIM, Suwon-si (KR); Seong Il CHO, Suwon-si (KR); Hag Chul KIM, Suwon-si (KR)

(73) Assignee: SAMSUNG ELECTRO-MECHANICS CO., LTD., Suwon-si (KR)

(21) Appl. No.: 18/678,851

(22) Filed: May 30, 2024

(30) Foreign Application Priority Data
Sep. 27, 2023 (KR) 10-2023-0130723
Jan. 12, 2024 (KR) 10-2024-0005236

(51) Int. Cl. G02B 9/62; G02B 5/04

(52) U.S. Cl. CPC G02B 9/62; G02B 5/04

(57) ABSTRACT

An optical imaging system includes a first lens group, including at least one lens disposed on a first optical axis, a second lens group, including at least one lens disposed on a second optical axis, perpendicular to the first optical axis, and a prism disposed between the first lens group and the second lens group to convert a light path from the first optical axis to the second optical axis. A conditional expression 0.20<d(LG1P)/d(PLG2)<0.60 is satisfied, where d(LG1P) is a distance on the first optical axis from an image-side surface of a lens disposed closest to an image side of the first lens group to an incident surface of the prism, and d(PLG2) is a distance on the second optical axis from an exit surface of the prism to an object-side surface of a lens disposed closest to an object side of the second lens group.

### CROSS-REFERENCE TO RELATED APPLICATIONS

This application claims the benefit under 35 USC 119 (a) of Korean Patent Application Nos. 10-2023-0130723 filed on Sep. 27, 2023, and 10-2024-0005236 filed on Jan. 12, 2024, in the Korean Intellectual Property Office, the entire disclosures of which are incorporated herein by reference for all purposes.

### BACKGROUND

### 1. Field

The present disclosure relates to an optical imaging system.

### 2. Description of the Background

Recently, in the camera market for mobile devices, the need for slim, high-magnification telephoto camera modules has been increasing. Since high-magnification telephoto camera modules require a long focal length, there may be a problem that physically, an overall length of the camera must increase. Accordingly, the overall length of the camera is secured by arranging a prism, altering a path of incident light, on an object side of a plurality of lenses. Instead, with this structure, there is a limit to increasing a diameter of the lens, which may make it difficult to lower an f-number.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group, including at least one lens disposed in a direction of a first optical axis; a second lens group, including at least one lens disposed in a direction of a second optical axis, perpendicular to the first optical axis; and a prism disposed between the first lens group and the second lens group and configured to convert a path of light from the direction of the first optical axis to the direction of the second optical axis, wherein a conditional expression 0.20<d(LG1P)/d(PLG2)<0.60 is satisfied, where d(LG1P) is a distance on the first optical axis from an image-side surface of a lens disposed closest to an image side of the first lens group to an incident surface of the prism, and d(PLG2) is a distance on the second optical axis from an exit surface of the prism to an object-side surface of a lens disposed closest to an object side of the second lens group.

The first lens group may include a first lens having positive refractive power, and the second lens group may include a second lens having positive refractive power, a third lens having negative refractive power, a fourth lens having refractive power, a fifth lens having positive refractive power, and a sixth lens having negative refractive power.

A conditional expression 0.70 (mm⁻¹)≤Fno/dP1<1.00 (mm⁻¹) may be satisfied by the optical imaging system, where Fno is an f-number of the optical imaging system, and dP1 is a distance on the first optical axis from the incident surface of the prism to a reflection surface of the prism.

A conditional expression 0.95≤fLG1/fLG2≤3.50 may be satisfied by the optical imaging system, where fLG1 is a focal length of the first lens group, and fLG2 is a focal length of the second lens group.

A conditional expression 2.20≤Fno<3.20 may be satisfied by the optical imaging system.

A conditional expression 8.00 mm<dLG12<11.00 mm may be satisfied by the optical imaging system, where dLG12 is a distance from an image-side surface of a lens disposed closest to the image side in the first lens group to an object-side surface of a lens disposed closest to an object side in the second lens group.

A conditional expression 0.10≤f/fLG1<0.60 may be satisfied by the optical imaging system, where f is a total focal length of the optical imaging system.

A conditional expression 0.50≤f/fLG2<0.95 may be satisfied by the optical imaging system.

A conditional expression 0.20<dLG2/OAL≤0.40 may be satisfied by the optical imaging system, where dLG2 is a distance on an optical axis from an object-side surface of a lens disposed closest to an object side to an image-side surface of a lens disposed closest to an image side, among lenses included in the second lens group, and OAL is a sum of a distance on the first optical axis from the object-side surface of the lens disposed closest to the object side in the first lens group to the reflection surface of the prism and a distance on the second optical axis from the reflection surface of the prism to an image plane.

In another general aspect, an optical imaging system includes a first lens, a second lens, a third lens, a fourth lens, a fifth lens, and a sixth lens disposed in order from an object side toward an image side, and a prism disposed between the first lens and the second lens to convert a path of incident light from a direction of a first optical axis to a direction of a second optical axis, wherein a conditional expression 8.00 mm<dLG12<11.00 mm is satisfied, where dLG12 is a distance on an optical axis from an image-side surface of the first lens to an object-side surface of the second lens.

The third lens may have negative refractive power, and both an object-side surface and an image-side surface thereof may have a concave shape.

A conditional expression 17.00 mm<R1+R2<30.00 mm may be satisfied by the optical imaging system, where R1 is a radius of curvature of an object-side surface of the first lens, and R2 is a radius of curvature of an image-side surface of the first lens.

The fourth lens may have negative refractive power and a concave image-side surface.

A conditional expression 0.20<dLG2/OAL≤0.40 may be satisfied by the optical imaging system, where dLG2 is a distance from an object-side surface of the second lens to an image-side surface of the sixth lens, and OAL is a sum of a distance on the first optical axis from an object-side surface of the first lens to a reflection surface of the prism and a distance on the second optical axis from the reflection surface of the prism to an image plane.

A conditional expression 0.20≤OAL1/OAL2≤0.35 may be satisfied by the optical imaging system, where OAL1 is a distance on the first optical axis from an object-side surface of the first lens to a reflection surface of the prism, and OAL2 is a distance on the second optical axis from the reflection surface of the prism to an image plane.

The first lens may constitute a first lens group, and the second to sixth lenses may constitute a second lens group.

A conditional expression 1.25<ODL1/PSi<1.60 may be satisfied by the optical imaging system, where ODL1 is half an outer diameter of the first lens, and PSi is a length of an incident surface of the prism in a direction, perpendicular to the first optical axis.

In another general aspect, an optical imaging system includes a first lens group including a first lens having refractive power, a second lens group, including a second lens having refractive power, a third lens having negative refractive power, a fourth lens having refractive power, a fifth lens having refractive power, and a sixth lens having negative refractive power disposed in order from an object side toward an image side, and a prism disposed between the first lens and the second lens to convert a path of incident light from a direction of a first optical axis to a direction of a second optical axis.

The third lens may have a concave object-side surface.

Other features and aspects will be apparent from the following detailed description, the drawings, and the claims.

### BRIEF DESCRIPTION OF DRAWINGS

FIG. 1A is a block diagram of an optical imaging system according to a first embodiment of the present disclosure.

FIG. 1B is a graph illustrating aberration characteristics of an optical imaging system according to the first embodiment of the present disclosure.

FIG. 2A is a block diagram of an optical imaging system according to a second embodiment of the present disclosure.

FIG. 2B is a graph illustrating aberration characteristics of an optical imaging system according to the second embodiment of the present disclosure.

FIG. 3A is a block diagram of an optical imaging system according to a third embodiment of the present disclosure.

FIG. 3B is a graph illustrating aberration characteristics of an optical imaging system according to the third embodiment of the present disclosure.

FIG. 4A is a block diagram of an optical imaging system according to a fourth embodiment of the present disclosure.

FIG. 4B is a graph illustrating aberration characteristics of an optical imaging system according to the fourth embodiment of the present disclosure.

FIG. 5A is a block diagram of an optical imaging system according to a fifth embodiment of the present disclosure.

FIG. 5B is a graph illustrating aberration characteristics of an optical imaging system according to the fifth embodiment of the present disclosure.

FIG. 6A is a block diagram of an optical imaging system according to a sixth embodiment of the present disclosure.

FIG. 6B is a graph illustrating aberration characteristics of an optical imaging system according to the sixth embodiment of the present disclosure.

FIG. 7A is a block diagram of an optical imaging system according to a seventh embodiment of the present disclosure.

FIG. 7B is a graph illustrating aberration characteristics of an optical imaging system according to the seventh embodiment of the present disclosure.

FIG. 8A is a block diagram of an optical imaging system according to an eighth embodiment of the present disclosure.

FIG. 8B is a graph illustrating aberration characteristics of an optical imaging system according to the eighth embodiment of the present disclosure.

FIG. 9A is a block diagram of an optical imaging system according to a ninth embodiment of the present disclosure.

FIG. 9B is a graph illustrating aberration characteristics of an optical imaging system according to the ninth embodiment of the present disclosure.

FIG. 10A is a block diagram of an optical imaging system according to a tenth embodiment of the present disclosure.

FIG. 10B is a graph illustrating aberration characteristics of an optical imaging system according to the tenth embodiment of the present disclosure.

FIG. 11A is a block diagram of an optical imaging system according to an eleventh embodiment of the present disclosure.

FIG. 11B is a graph illustrating aberration characteristics of an optical imaging system according to the eleventh embodiment of the present disclosure.

FIG. 12A is a block diagram of an optical imaging system according to a twelfth embodiment of the present disclosure.

FIG. 12B is a graph illustrating aberration characteristics of an optical imaging system according to the twelfth embodiment of the present disclosure.

FIG. 13A is a block diagram of an optical imaging system according to a thirteenth embodiment of the present disclosure.

FIG. 13B is a graph illustrating aberration characteristics of an optical imaging system according to the thirteenth embodiment of the present disclosure.

FIG. 14A is a block diagram of an optical imaging system according to a fourteenth embodiment of the present disclosure.

FIG. 14B is a graph illustrating aberration characteristics of an optical imaging system according to the fourteenth embodiment of the present disclosure.

FIG. 15A is a block diagram of an optical imaging system according to a fifteenth embodiment of the present disclosure.

FIG. 15B is a graph illustrating aberration characteristics of an optical imaging system according to the fifteenth embodiment of the present disclosure.

FIG. 16A is a block diagram of an optical imaging system according to a sixteenth embodiment of the present disclosure.

FIG. 16B is a graph illustrating aberration characteristics of an optical imaging system according to the sixteenth embodiment of the present disclosure.

FIG. 17A is a block diagram of an optical imaging system according to a seventeenth embodiment of the present disclosure.

FIG. 17B is a graph illustrating aberration characteristics of an optical imaging system according to the seventeenth embodiment of the present disclosure.

FIG. 18A is a block diagram of an optical imaging system according to an eighteenth embodiment of the present disclosure.

FIG. 18B is a graph illustrating aberration characteristics of an optical imaging system according to then eighteenth embodiment of the present disclosure.

FIG. 19A is a block diagram of an optical imaging system according to a nineteenth embodiment of the present disclosure.

FIG. 19B is a graph illustrating aberration characteristics of an optical imaging system according to the nineteenth embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide an optical imaging system having improved low-light image capturing performance. In an example, such an optical imaging system may be adopted in a mobile telephoto camera module.

Herein, numerical values for a radius of curvature of a lens, a thickness, a gap or a distance, a focal length, IMG HT (½ of a diagonal length of an image plane), and an effective radius (semi-aperture) are all in millimeters (mm), and the unit of a field of view (FOV) is degree. Additionally, a thickness of a lens and a gap between lenses refers to a thickness and a gap on an optical axis, respectively.

Herein, an object side may indicate a direction in which an object is disposed, and an image side may indicate, for example, a direction in which an image plane having an image formed thereon is disposed or a direction in which an image sensor is disposed. For example, an object side may indicate a direction along an optical axis in which an object is disposed, and an image side may indicate, a direction along an optical axis in which an image plane in which an image may be formed is disposed.

In the description related to a shape of a lens in this specification, the disclosure that a surface is convex denotes that a paraxial region of the corresponding surface is convex, and the disclosure that a surface is concave denotes that the paraxial region of the corresponding surface is concave. Accordingly, even if one surface of the lens is described as having a convex shape, an edge of the lens may be concave. Similarly, even if one surface of the lens is described as having a concave shape, an edge of the lens may have a convex shape.

An optical imaging system according to example embodiments of the present disclosure may be employed in a telephoto camera module for a mobile device. For example, the mobile device may be any type of portable electronic device, such as a mobile communication terminal, a smart phone, or a tablet PC.

According to example embodiments of the present disclosure, an optical imaging system may include six lenses. For example, the optical imaging system may include a first lens, a second lens, a third lens, a fourth lens, a fifth lens, and a sixth lens arranged in order from an object side toward an image side.

Additionally, according to example embodiments of the present disclosure, the optical imaging system may include a plurality of lens groups. For example, the optical imaging system may include a first lens group and a second lens group arranged in order from the object side toward the image side and each including at least one lens among the first to sixth lenses.

The optical imaging system according to example embodiments of the present disclosure may not be comprised of only six lenses, but may also include an optical path conversion member for converting a path of incident light, an image sensor for converting the incident light into an electrical signal, an infrared cut-off filter for blocking light in an infrared range incident on the image sensor, and an aperture for controlling the amount of light.

According to example embodiments of the present disclosure, the optical path conversion member may be a prism, and the prism may be disposed between the first lens group and the second lens group. The prism may be tilt-driven with respect to two axes when correcting camera shake (the optical path conversion member is described herein as a prism, but other types of reflective members (e.g., mirrors) capable of converting the optical path may be adopted in place of the prism). Additionally, the infrared cut-off filter may be disposed between the sixth lens and the image sensor, and the aperture may be disposed inside the second lens group.

An optical imaging system according to example embodiments of the present disclosure may include a plastic lens. For example, at least some of the first to sixth lenses may be formed of plastic, for example, the first to sixth lenses may be formed of plastic.

Additionally, the optical imaging system according to example embodiments of the present disclosure may include an aspherical lens. For example, at least one of the first to sixth lenses may be an aspherical lens, and in at least one of the first to sixth lenses, at least one surface of an object-side surface and an image-side surface may be aspherical. The aspherical surface of the lens is expressed by Equation 1.

$$Z = \frac{c {Y}^{2}}{1 + \sqrt{1 - ( 1 + K ) {c}^{2} {Y}^{2}}} + A {Y}^{4} + B {Y}^{6} + C {Y}^{8} + D {Y}^{10} + E {Y}^{12} + F {Y}^{14} + G {Y}^{16} + H {Y}^{18} + J {Y}^{20} \qquad Equation 1$$

In Equation 1, c represents an inverse number of the radius of curvature of a lens, K represents the Conic constant, and Y represents a distance from any point on an aspherical surface of the lens to the optical axis. Additionally, constants A to H and J are aspheric constants from fourth to twentieth order, and Z (or SAG) is a distance in an optical axis direction between any point on the aspherical surface and a vertex of the corresponding aspherical surface.

In example embodiments of the present disclosure, the first lens group may be disposed on an object side of the prism and may include a first lens. The first lens may be disposed in a direction of a first optical axis c1. The second lens group may be disposed on an image side of the prism and may include second to sixth lenses. The second to sixth lenses may be disposed in a direction of a second optical axis c2.

The prism may be disposed between the first lens group and the second lens group to convert a path of incident light from the direction of the first optical axis c1 to the direction of the second optical axis c2. The direction of the first optical axis c1 and the direction of the second optical axis c2 may be substantially perpendicular to each other.

In example embodiments of the present disclosure, the prism may be tilted by a predetermined angle with respect to two axes perpendicular to the second optical axis c2 during shake correction of a camera module. Additionally, in example embodiments of the present disclosure, the second lens group may be moved in the direction of the second optical axis c2 when adjusting a focus of the camera module.

The optical imaging system according to example embodiments of the present disclosure may satisfy the following conditional expressions.

$$0.1 < f / f 1 \leq 0.6 \qquad [ Conditional Expression 1 ]$$

$$0.2 \leq OAL 1 / OAL 2 \leq 0.35 \qquad [ Conditional Expression 2 ]$$

$$2.2 \leq Fno < 3.2 \qquad [ Conditional Expression 3 ]$$

$$0.7 ( {mm}^{- 1} ) \leq Fno / dP 1 < 1. ( {mm}^{- 1} ) \qquad [ Conditional Expression 4 ]$$

$$0.95 \leq fLG 1 / fLG 2 \leq 3.50 \qquad [ Conditional Expression 5 ]$$

$$0.1 \leq f / fLG 1 < 0.6 \qquad [ Conditional Expression 6 ]$$

$$0.5 \leq f / fLG 2 < 0.95 \qquad [ Conditional Expression 7 ]$$

$$0.2 < d ( LG 1 P ) / d ( P L G 2 ) < 0 \text{.60} \qquad [ Conditional Expression 8 ]$$

$$0.02 5 \leq d ( LG 1 P ) / OAL < 0.0 \; 70 \qquad [ Conditional Expression 9 ]$$

$$0.08 < d ( PLG 2 ) / OAL < 0.14 \qquad [ Conditional Expression 10 ]$$

$$8. mm < d ( L G 12 ) < 11. \qquad [ Conditional Expression 11 ]$$

$$1.2 \leq dP / ( d ( LG 1 P ) + d ( P L G 2 ) ) \leq 2 \text{.00} \qquad [ Conditional Expression 12 ]$$

$$1.25 < ODL 1 / PSi < 1.6 \qquad [ Conditional Expression 13 ]$$

$$17. mm < R 1 + R 2 < 30. mm \qquad [ Conditional Expression 14 ]$$

$$0.2 < dLG 2 / OAL \leq 0.40 \qquad [ Conditional Expression 15 ]$$

In Conditional Expression 1, f is a focal length of an entire optical imaging system, and f1 is a focal length of the first lens, and Conditional Expression 1 is related to a focal length range of the first lens to form an appropriate focal length for a telephoto camera module.

In Conditional Expression 2, OAL1 is a distance on the first optical axis from an object-side surface of a lens (or a first lens) disposed closest to the object side in the first lens group to a reflection surface of the prism, and OAL2 is the distance on the second optical axis from the reflection surface of the prism to an image plane. Conditional Expression 2 is related to characteristics (lens lead-type optical system) in which a lens is disposed on an object side of the prism according to embodiments of the present disclosure, and when the conditional expression deviates, it may be difficult to manufacture a module to an appropriate size (length and thickness).

In Conditional Expression 3 and Conditional Expression 4, Fno is an f-number of the optical imaging system, and dP1 is a distance on the first optical axis from an incident surface of the prism to the reflection surface of the prism. Conditional Expression 3 is related to the brightness of the telephoto camera module, and Conditional Expression 4 is related to the brightness performance of a lens lead-type optical system according to example embodiments of the present disclosure.

In Conditional Expression 5 to Conditional Expression 7, fLG1 is a focal length of the first lens group, fLG2 is a focal length of the second lens group, and f is a focal length of the entire optical imaging system. Conditional Expression 5 to Conditional Expression 7 are related to a focal length range of the first lens group and the second lens group to form an appropriate focal length for a telephoto camera module.

In Conditional Expression 8 to Conditional Expression 10, d(LG1P) is a distance on the first optical axis from the image side of the lens (or first lens) disposed closest to the image side in the first lens group to the incident surface of the prism, d(PLG2) is a distance on the second optical axis from an exit surface of the prism to an object-side surface of a lens (or second lens) disposed closest to an object side in the second lens group, and OAL is a sum of a distance on the first optical axis from the object-side surface of the lens (or first lens) disposed closest to the object side in the first lens group to the reflection surface of the prism and a distance on the second optical axis from the reflection surface of the prism to the image plane. Conditional Expression 8 and Conditional Expression 10 are related to characteristics that a gap between the prism and the second lens group according to the example embodiments of the present disclosure is large, and are for focus adjustment and shake correction operation. Conditional Expression 9 is a condition for miniaturization of the module under the shape condition of the first lens.

In Conditional Expression 11, d(LG12) is a sum of a distance on the first optical axis from the image-side surface of the lens (or first lens) disposed closest to the image side in the first lens group to the reflection surface of the prism and a distance on the second optical axis from the reflection surface of the prism to the object-side surface of the lens (or second lens) disposed closest to the object in the second lens group. Conditional Expression 11 is related to characteristics that a gap between the prism and the first lens group and the second lens group according to example embodiments of the present disclosure is large.

In Conditional Expression 12 and Conditional Expression 13, dP is a sum of a distance on the first optical axis from the incident surface of the prism to the reflection surface of the prism and a distance on the second optical axis from the reflection surface of the prism to the exit surface of the prism, ODL1 is half an outer diameter of the lens (or first lens) disposed closest to the object side in the first lens group, and PSi is half a length of the incident surface of the prism in a direction, perpendicular to the first optical axis. Here, the direction perpendicular to the first optical axis may denote a direction substantially parallel to the second optical axis among the two directions, perpendicular to the first optical axis. Conditional Expression 12 and Conditional Expression 13 are related to the prism miniaturization characteristics according to example embodiments of the present disclosure.

In Conditional Expression 14, R1 and R2 are curvature radii of the object-side surface and the image-side surface of the first lens, respectively, and Conditional Expression 14 is related to a curvature (shape) condition of the first lens for prism miniaturization.

In Conditional Expression 15, dLG2 is a distance on the optical axis from the object-side surface of the lens (or second lens) disposed closest to the object to an image-side surface of a lens (or sixth lens) disposed closest to the image side, among the lenses included in the second lens group. Conditional Expression 15 is related to characteristics that a distance between the prism and the second lens group according to the example embodiments of the present disclosure is large, and is intended to secure a driving space.

Additionally, the optical imaging system according to example embodiments of the present disclosure may additionally satisfy the following conditional expressions.

$$0.2 < d ( LG 1 P ) / dP 1 < 0.5 \qquad [ Conditional Expression 16 ]$$

$$0.9 \leq dP 1 / ODL 2 \leq 1.2 \qquad [ Conditional Expression 17 ]$$

$$0.5 < ( d L G 1 + d ( LG 1 P ) ) / dP 1 \leq 1. \qquad [ Conditional Expression 18 ]$$

$$- 0.3 < ( R 1 - R 2 ) / ( R 1 + R 2 ) < 0.00 \qquad [ Conditional Expression 19 ]$$

$$0.1 \leq R 3 / fLG 2 < 0.25 \qquad [ Conditional Expression 20 ]$$

$$0.8 \leq d ( PLG 2 ) / dP 1 < 1.1 \qquad [ Conditional Expression 21 ]$$

$$1.35 < fLG 1 / OAL < 3.00 \qquad [ Conditional Expression 22 ]$$

In Conditional Expression 16 and Conditional Expression 17, dP1 is a distance on the first optical axis from the incident surface of the prism to the reflection surface thereof, and ODL2 is half an outer diameter of the lens (or second lens) disposed closest to the object side in the second lens group. Conditional Expression 16 and Conditional Expression 17 are related to distances and conditions between the prism and the first lens group and the second lens group for tilt-driving of the prism, and when the conditional expressions deviate from the range, it may be difficult to secure sufficient distances therebetween, or the volume of the optical system may increase, which may disadvantageous in ensuring portability.

In Conditional Expression 18, dLG1 is a distance from the object-side surface of the lens (or first lens) disposed closest to the object side in the first lens group to the image-side surface of the lens (or first lens) disposed closest to the image side, and Conditional Expression 18 suggests an appropriate distance range between the first lens group and the prism in terms of securing prism a driving space and miniaturizing the module.

Conditional Expression 19 is related to the shape condition of the first lens for a lens through which light is incident, that is, the first lens to have an appropriate focal length, and when the conditional expression deviates from the range, the refractive power may be significantly reduced so that a focal length becomes significantly long, or vice versa, which may increase the aberration burden on subsequent lenses.

In Conditional Expression 20, R3 is a radius of curvature of the object-side surface of the second lens, and is a shape condition of the second lens for the optical system to have an appropriate size (length and thickness).

Conditional Expression 21 and Conditional Expression 22 respectively suggest an appropriate range related to a distance between the prism and the second lens group, and Conditional Expression 22 suggests an appropriate range related to a size of the optical system.

Hereinafter, an optical imaging system according to example embodiments of the present disclosure will be described with reference to the attached drawings.

### First Embodiment

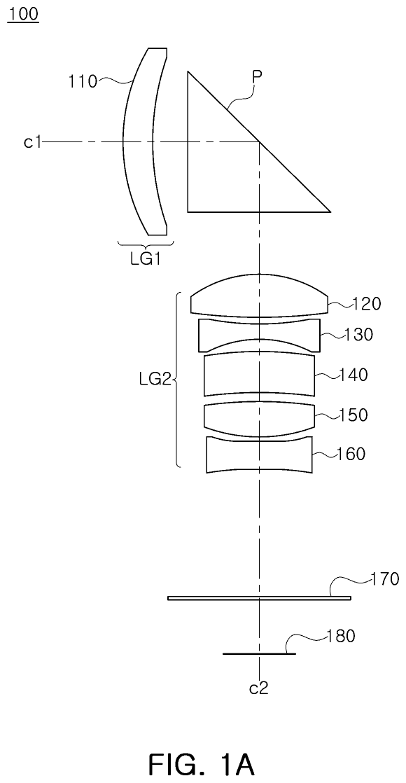

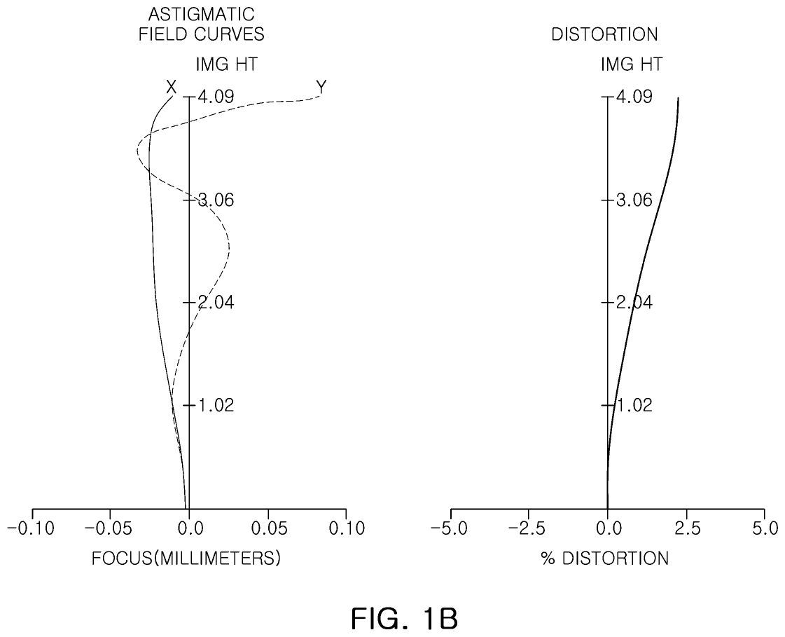

FIG. 1A is a block diagram of an optical imaging system according to a first embodiment of the present disclosure, and FIG. 1B is a graph illustrating aberration characteristics of an optical imaging system according to the first embodiment of the present disclosure.

An optical imaging system 100 according to a first embodiment may include a first lens 110, a second lens 120, a third lens 130, a fourth lens 140, a fifth lens 150, and a sixth lens 160 arranged in order from an object side toward an image side, and may further include an infrared cut-off filter 170 and an image sensor 180 disposed on an image side of the sixth lens 160.

The first lens 110 may have positive refractive power. An object-side surface of the first lens 110 may have a convex shape in the paraxial region, and an image-side surface of the first lens 110 may have a concave shape in the paraxial region, that is, a meniscus shape convex toward the object side. The first lens 110 may be formed of plastic. The first lens 110 may be an aspherical lens. For example, the object-side surface and the image-side surface of the first lens 110 may be aspherical.

The second lens 120 may have positive refractive power. An object-side surface and an image-side surface of the second lens 120 may have a convex shape in the paraxial region. The second lens 120 may be formed of plastic. The second lens 120 may be an aspherical lens. For example, the object-side surface and the image-side surface of the second lens 120 may be aspherical.

The third lens 130 may have negative refractive power. An object-side surface and an image-side surface of the third lens 130 may have a concave shape in the paraxial region. The third lens 130 may be formed of plastic. In detail, the third lens 130 may be formed of a plastic material with optical properties (e.g., refractive index and Abbe number) different from the second lens 120. The third lens 130 may be an aspherical lens. For example, the object-side surface and the image-side surface of the third lens 130 may be aspherical.

The fourth lens 140 may have negative refractive power. An object-side surface of the fourth lens 140 has a convex shape in the paraxial region, and an image-side surface of the fourth lens 140 may have a concave shape in the paraxial region. The fourth lens 140 may be formed of plastic. In detail, the fourth lens 140 may be formed of a plastic material with optical properties (e.g., refractive index and Abbe number) different from the third lens 130. The fourth lens 140 may be an aspherical lens. For example, the object-side surface and the image-side surface of the fourth lens 140 may be aspherical.

The fifth lens 150 may have positive refractive power. An object-side surface and an image-side surface of the fifth lens 150 may have a convex shape in the paraxial region. The fifth lens 150 may be formed of plastic. In detail, the fifth lens 150 may be formed of a plastic material with optical properties (e.g., refractive index and Abbe number) different from the fourth lens 140. The fifth lens 150 may be an aspherical lens. For example, the object-side surface and the image-side surface of the fifth lens 150 may be aspherical.

The sixth lens 160 may have negative refractive power. An object-side surface and an image-side surface of the sixth lens 160 may have a concave shape in the paraxial region. The sixth lens 160 may be formed of plastic. In detail, the sixth lens 160 may be formed of a plastic material with optical properties (e.g., refractive index and Abbe number) different from the fifth lens 150. The sixth lens 160 may be an aspherical lens. For example, the object-side surface and the image-side surface of the sixth lens 160 may be aspherical.

A prism P may be disposed between the first lens 110 and the second lens 120. The first lens 110 disposed on the object side with respect to the prism P may constitute a first lens group LG1, and the second to sixth lenses 120 to 160 disposed on the image side with respect to the prism P may constitute a second lens group LG2. Both the first lens group LG1 and the second lens group LG2 may have positive refractive power.

Table 1 illustrates optical and physical parameters of the optical imaging system 100 according to the first embodiment of the present disclosure.

TABLE 1

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.370 | 1.306 | 1.535 | 55.7 | 3.60 |
| 3 | 15.813 | 1.427 | | | 3.44 |
| 4 | Infinity | 3.000 | 1.717 | 29.5 | 2.70 |
| 5 | Infinity | 3.000 | 1.717 | 29.5 | 3.85 |
| 6 | Infinity | 2.631 | | | 2.70 |
| 7 | 4.477 | 1.798 | 1.535 | 55.7 | 2.65 |
| 8 | −19.553 | 0.279 | | | 2.50 |
| 9 | −14.215 | 0.682 | 1.614 | 25.9 | 2.32 |
| 10 | 3.875 | 0.538 | | | 2.00 |
| 11 | 24.202 | 1.792 | 1.544 | 56.0 | 2.10 |
| 12 | 22.906 | 0.287 | | | 2.04 |
| 13 | 26.648 | 1.565 | 1.660 | 20.4 | 2.10 |
| 14 | −6.815 | 0.131 | | | 2.10 |
| 15 | −132.954 | 1.237 | 1.639 | 23.5 | 2.00 |
| 16 | 9.611 | 5.392 | | | 2.00 |
| 17 | Infinity | 0.210 | 1.518 | 64.2 | 3.40 |
| 18 | Infinity | 2.309 | | | 3.44 |
| Image | Infinity | | | | 4.10 |

Table 2 illustrates aspheric data of the optical system imaging 100 according to the first embodiment of the present disclosure.

TABLE 2

| Surface | 2 | 3 | 7 | 8 | 9 | 10 |
|---|---|---|---|---|---|---|
| K | −4.78E+00 | 0.00E+00 | 8.80E−01 | −4.52E+00 | −6.51E−02 | −1.12E+00 |
| A | 1.08E−03 | 0.00E+00 | −1.45E−03 | 4.60E−03 | −1.25E−04 | −5.62E−03 |
| B | 5.18E−05 | 0.00E+00 | −7.86E−05 | −1.70E−03 | 6.04E−05 | 2.40E−03 |
| C | −7.61E−06 | 0.00E+00 | −6.52E−05 | 8.27E−04 | 1.16E−05 | −1.58E−03 |
| D | 5.04E−07 | 0.00E+00 | 3.68E−05 | −3.69E−04 | 2.13E−06 | 1.09E−03 |
| E | 2.36E−08 | 0.00E+00 | −1.41E−05 | 1.21E−04 | 0.00E+00 | −5.18E−04 |
| F | −5.48E−09 | 0.00E+00 | 3.20E−06 | −2.53E−05 | 0.00E+00 | 1.56E−04 |
| G | 3.38E−10 | 0.00E+00 | −4.25E−07 | 3.12E−06 | 0.00E+00 | −2.73E−05 |
| H | −9.19E−12 | 0.00E+00 | 2.85E−08 | −2.02E−07 | 0.00E+00 | 2.57E−06 |
| J | 8.88E−14 | 0.00E+00 | −7.28E−10 | 5.28E−09 | 0.00E+00 | −1.00E−07 |

| Surface | 11 | 12 | 13 | 14 | 15 | 16 |
|---|---|---|---|---|---|---|
| K | 4.90E+01 | 7.53E+01 | −1.05E+01 | −5.70E−01 | 0.00E+00 | 8.43E+00 |
| A | 3.65E−04 | 8.54E−04 | 1.51E−04 | 2.99E−03 | −3.46E−03 | −7.28E−03 |
| B | 3.41E−05 | 4.51E−04 | 1.43E−03 | −1.57E−04 | −1.19E−03 | −3.78E−04 |
| C | 1.23E−05 | 2.59E−05 | −1.93E−04 | −1.85E−04 | −2.09E−04 | −2.00E−05 |
| D | 1.16E−05 | −2.61E−05 | −1.00E−05 | 1.40E−06 | 2.78E−05 | 1.33E−05 |
| E | −8.39E−07 | 0.00E+00 | 3.88E−06 | 3.58E−06 | −7.81E−07 | −1.27E−06 |
| F | 0.00E+00 | 0.00E+00 | −3.35E−07 | 1.89E−07 | 0.00E+00 | 0.00E+00 |
| G | 0.00E+00 | 0.00E+00 | 1.39E−08 | −8.85E−08 | 0.00E+00 | 0.00E+00 |
| H | 0.00E+00 | 0.00E+00 | −2.85E−10 | 6.28E−09 | 0.00E+00 | 0.00E+00 |
| J | 0.00E+00 | 0.00E+00 | 2.35E−12 | −1.38E−10 | 0.00E+00 | 0.00E+00 |

### Second Embodiment

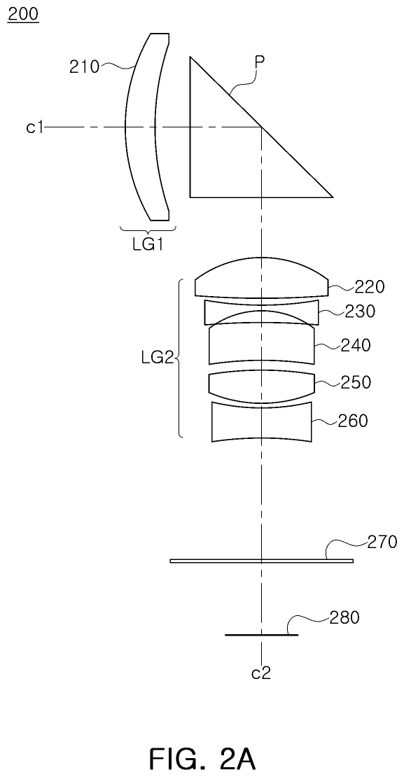

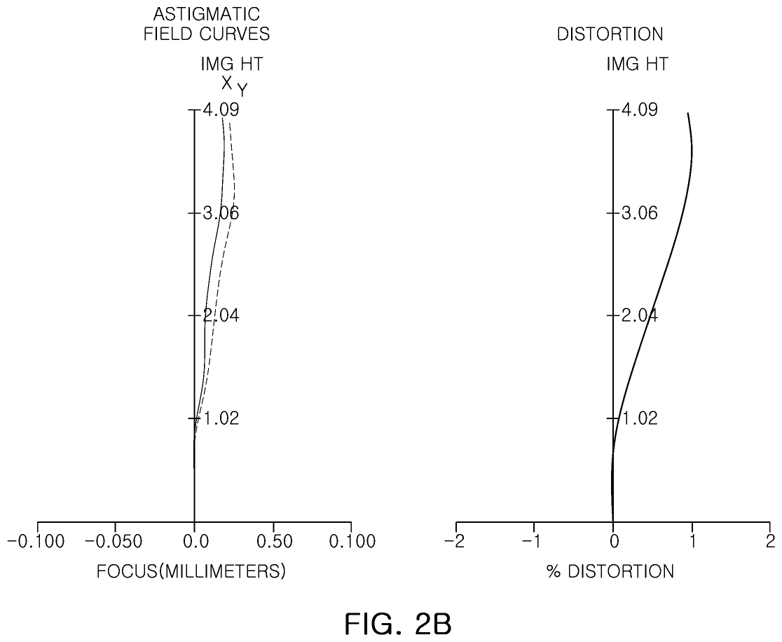

FIG. 2A is a block diagram of an optical imaging system according to a second embodiment of the present disclosure, and FIG. 2B is a graph illustrating aberration characteristics of an optical imaging system according to the second embodiment of the present disclosure.

An optical imaging system 200 according to the second embodiment may include a first lens 210, a second lens 220, a third lens 230, a fourth lens 240, a fifth lens 250, and a sixth lens 260 arranged in order from an object side toward an image side, and may further include an infrared cut-off filter 270 and an image sensor 280 disposed on an image side of the sixth lens 260.

The first lens 210 may have positive refractive power. An object-side surface of the first lens 210 may have a convex shape in the paraxial region, and an image-side surface of the first lens 210 may have a concave shape in the paraxial region, that is, a meniscus shape convex toward the object side. The first lens 210 may be formed of plastic. The first lens 210 may be an aspherical lens. For example, the object-side surface and the image-side surface of the first lens 210 may be aspherical.

The second lens 220 may have positive refractive power. An object-side surface and an image-side surface of the second lens 220 may have a convex shape in the paraxial region. The second lens 220 may be formed of plastic. The second lens 220 may be an aspherical lens. For example, the object-side surface and the image-side surface of the second lens 220 may be aspherical.

The third lens 230 may have negative refractive power. An object-side surface and an image-side surface of the third lens 230 may have a concave shape in the paraxial region. The third lens 230 may be formed of plastic. In detail, the third lens 230 may be formed of a plastic material with optical properties (e.g., refractive index and Abbe number) different from the second lens 220. The third lens 230 may be an aspherical lens. For example, the object-side surface and the image-side surface of the third lens 230 may be aspherical.

The fourth lens 240 may have negative refractive power. An object-side surface of the fourth lens 240 may have a convex shape in the paraxial region, and an image-side surface of the fourth lens 240 may have a concave shape in the paraxial region. The fourth lens 240 may be formed of plastic. In detail, the fourth lens 240 may be formed of a plastic material with optical properties (e.g., refractive index and Abbe number) different from the third lens 230. The fourth lens 240 may be an aspherical lens. For example, the object-side surface and the image-side surface of the fourth lens 240 may be aspherical.

The fifth lens 250 may have positive refractive power. An object-side surface and an image-side surface of the fifth lens 250 may have a convex shape in the paraxial region. The fifth lens 250 may be formed of plastic. In detail, the fifth lens 250 may be formed of a plastic material with optical properties (e.g., refractive index and Abbe number) different from the fourth lens 240. The fifth lens 250 may be an aspherical lens. For example, the object-side surface and the image-side surface of the fifth lens 250 may be aspherical.

The sixth lens 260 may have negative refractive power. An object-side surface and an image-side surface of the sixth lens 260 may have a concave shape in the paraxial region. The sixth lens 260 may be formed of plastic. In detail, the sixth lens 260 may be formed of a plastic material with optical properties (e.g., refractive index and Abbe number) different from the fifth lens 250. The sixth lens 260 may be an aspherical lens. For example, the object-side surface and the image-side surface of the sixth lens 260 may be aspherical.

A prism P may be disposed between the first lens 210 and the second lens 220. The first lens 210 disposed on the object side with respect to the prism P may constitute a first lens group LG1, and the second to sixth lenses 220 to 260 disposed on the image side with respect to the prism P may constitute a second lens group LG2. Both the first lens group LG1 and the second lens group LG2 may have positive refractive power.

Table 3 illustrates optical and physical parameters of the optical imaging system 200 according to the second embodiment of the present disclosure.

TABLE 3

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.365 | 1.286 | 1.535 | 55.7 | 3.60 |
| 3 | 15.772 | 1.414 | | | 3.44 |
| 4 | Infinity | 3.000 | 1.717 | 29.5 | 2.70 |
| 5 | Infinity | 3.000 | 1.717 | 29.5 | 3.85 |
| 6 | Infinity | 2.631 | | | 2.70 |
| 7 | 4.477 | 1.793 | 1.535 | 55.7 | 2.65 |
| 8 | −18.402 | 0.280 | | | 2.50 |
| 9 | −13.300 | 0.292 | 1.614 | 25.9 | 1.57 |
| 10 | 3.892 | 0.511 | | | 1.33 |
| 11 | 23.464 | 1.743 | 1.544 | 56.0 | 2.10 |
| 12 | 22.018 | 0.361 | | | 1.63 |
| 13 | 22.487 | 1.468 | 1.660 | 20.4 | 2.10 |
| 14 | −6.776 | 0.146 | | | 2.10 |
| 15 | −95.190 | 1.452 | 1.639 | 23.5 | 2.00 |
| 16 | 8.957 | 5.392 | | | 2.00 |
| 17 | Infinity | 0.210 | 1.518 | 64.2 | 3.95 |
| 18 | Infinity | 3.225 | | | 3.98 |
| Image | Infinity | | | | 4.91 |

Table 4 illustrates aspheric data of the optical imaging system 200 according to the second embodiment of the present disclosure.

TABLE 4

| Surface | 2 | 3 | 7 | 8 | 9 | 10 |
|---|---|---|---|---|---|---|
| K | −4.75E+00 | 1.07E+01 | 8.78E−01 | −4.58E+00 | 4.12E−01 | −1.12E+00 |
| A | 1.25E−03 | 3.56E−04 | −1.51E−03 | 5.21E−03 | −1.47E−04 | −6.20E−03 |
| B | 4.31E−06 | 6.50E−06 | −2.61E−04 | −2.11E−03 | 5.49E−05 | 2.51E−03 |
| C | −1.20E−06 | 4.46E−07 | 1.01E−04 | 8.08E−04 | 1.07E−05 | −1.07E−03 |
| D | 5.12E−07 | −1.93E−07 | −5.48E−05 | −2.29E−04 | 2.02E−06 | 4.23E−04 |
| E | −9.41E−08 | 2.68E−08 | 1.86E−05 | 4.47E−05 | 0.00E+00 | −1.24E−04 |
| F | 1.04E−08 | −1.98E−09 | −4.16E−06 | −5.77E−06 | 0.00E+00 | 2.92E−05 |
| G | −6.68E−10 | 7.34E−11 | 5.67E−07 | 4.34E−07 | 0.00E+00 | −4.73E−06 |
| H | 2.32E−11 | −1.31E−12 | −4.32E−08 | −1.44E−08 | 0.00E+00 | 4.57E−07 |
| J | −3.36E−13 | 9.01E−15 | 1.39E−09 | 3.81E−11 | 0.00E+00 | −2.01E−08 |
| Surface | 11 | 12 | 13 | 14 | 15 | 16 |
| K | 5.21E+01 | 7.61E+01 | −1.13E+01 | −5.10E−01 | 0.00E+00 | 8.68E+00 |
| A | 4.03E−04 | 8.20E−04 | 4.29E−04 | 2.79E−03 | −3.35E−03 | −8.00E−03 |
| B | 4.71E−05 | 4.18E−04 | 1.21E−03 | −2.12E−04 | −1.15E−03 | −3.17E−04 |
| C | 1.57E−05 | 1.91E−05 | −1.23E−04 | −2.02E−04 | −1.98E−04 | −2.18E−05 |
| D | 1.24E−05 | −2.63E−05 | −2.23E−05 | 2.81E−05 | 2.95E−05 | 1.01E−05 |
| E | −6.64E−07 | 0.00E+00 | 5.11E−06 | −3.48E−06 | −1.09E−06 | −1.06E−06 |
| F | 0.00E+00 | 0.00E+00 | −4.09E−07 | 1.01E−06 | 0.00E+00 | 0.00E+00 |
| G | 0.00E+00 | 0.00E+00 | 1.64E−08 | −1.35E−07 | 0.00E+00 | 0.00E+00 |
| H | 0.00E+00 | 0.00E+00 | −3.34E−10 | 7.47E−09 | 0.00E+00 | 0.00E+00 |
| J | 0.00E+00 | 0.00E+00 | 2.74E−12 | −1.48E−10 | 0.00E+00 | 0.00E+00 |

### Third Embodiment

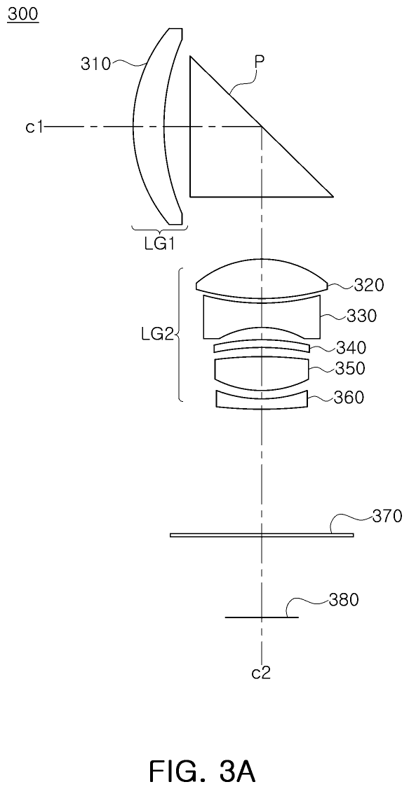

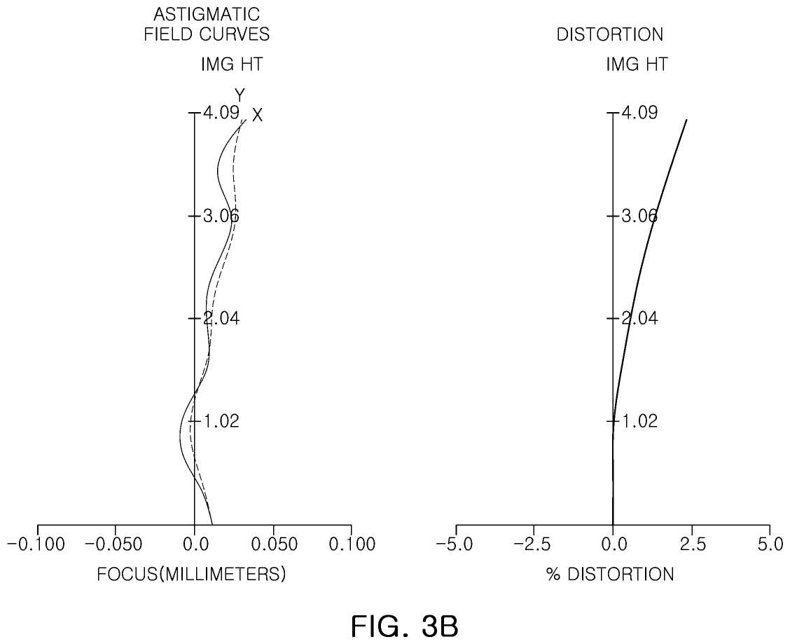

FIG. 3A is a block diagram of an optical imaging system according to a third embodiment of the present disclosure, and FIG. 3B is a graph illustrating aberration characteristics of an optical imaging system according to the third embodiment of the present disclosure.

An optical imaging system 300 according to the third embodiment may include a first lens 310, a second lens 320, a third lens 330, a fourth lens 340, a fifth lens 350, and a sixth lens 360 arranged in order from an object side toward an image side, and may further include an infrared cut-off filter 370 and an image sensor 380 disposed on an image side of the sixth lens 360.

The first lens 310 may have positive refractive power. An object-side surface of the first lens 310 may have a convex shape in the paraxial region, and an image-side surface of the first lens 310 may have a concave shape in the paraxial region, that is, a meniscus shape convex toward the object side. The first lens 310 may be formed of plastic. The first lens 310 may be an aspherical lens. For example, the object-side surface and the image-side surface of the first lens 310 may be aspherical.

The second lens 320 may have positive refractive power. An object-side surface and an image-side surface of the second lens 320 may have a convex shape in the paraxial region. The second lens 320 may be formed of plastic. The second lens 320 may be an aspherical lens. For example, the object-side surface and the image-side surface of the second lens 320 may be aspherical.

The third lens 330 may have negative refractive power. An object-side surface and an image-side surface of the third lens 330 may have a concave shape in the paraxial region. The third lens 330 may be formed of plastic. In detail, the third lens 330 may be formed of a plastic material with optical properties (e.g., refractive index and Abbe number) different from the second lens 320. The third lens 330 may be an aspherical lens. For example, the object-side surface and the image-side surface of the third lens 330 may be aspherical.

The fourth lens 340 may have negative refractive power. An object-side surface of the fourth lens 340 may have a convex shape in the paraxial region, and an image-side surface of the fourth lens 340 may have a concave shape in the paraxial region. The fourth lens 340 may be formed of plastic. In detail, the fourth lens 340 may be formed of a plastic material with optical properties (e.g., refractive index and Abbe number) different from the third lens 330. The fourth lens 340 may be an aspherical lens. For example, the object-side surface and the image-side surface of the fourth lens 340 may be aspherical.

The fifth lens 350 may have positive refractive power. An object-side surface and an image-side surface of the fifth lens 350 may have a convex shape in the paraxial region. The fifth lens 350 may be formed of plastic. In detail, the fifth lens 350 may be formed of a plastic material with optical properties (e.g., refractive index and Abbe number) different from the fourth lens 340. The fifth lens 350 may be an aspherical lens. For example, the object-side surface and the image-side surface of the fifth lens 350 may be aspherical.

The sixth lens 360 may have negative refractive power. An object-side surface and an image-side surface of the sixth lens 360 may have a concave shape in the paraxial region. The sixth lens 360 may be formed of plastic. In detail, the sixth lens 360 may be formed of a plastic material with optical properties (e.g., refractive index and Abbe number) different from the fifth lens 350. The sixth lens 360 may be an aspherical lens. For example, the object-side surface and the image-side surface of the sixth lens 360 may be aspherical.

A prism P may be disposed between the first lens 310 and the second lens 320. The first lens 310 disposed on the object side with respect to the prism P may constitute the first lens group LG1, and the second to sixth lenses 320 to 360 disposed on the image side with respect to the prism P may constitute a second lens group LG2. Both the first lens group LG1 and the second lens group LG2 may have positive refractive power.

Table 5 illustrates optical and physical parameters of the optical imaging system 300 according to the third embodiment of the present disclosure.

TABLE 5

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.284 | 1.250 | 1.535 | 55.7 | 3.85 |
| 3 | 14.058 | 1.160 | | | 3.14 |
| 4 | Infinity | 3.100 | 1.717 | 29.5 | 2.80 |
| 5 | Infinity | 3.100 | 1.717 | 29.5 | 3.96 |
| 6 | Infinity | 2.767 | | | 2.80 |
| 7 | 4.347 | 1.663 | 1.535 | 55.7 | 2.57 |
| 8 | −9.646 | 0.224 | | | 2.43 |
| 9 | −8.216 | 1.110 | 1.614 | 25.9 | 2.41 |
| 10 | 3.670 | 0.533 | | | 1.97 |
| 11 | 20.533 | 0.369 | 1.544 | 56.0 | 1.91 |
| 12 | 18.483 | 0.338 | | | 1.92 |
| 13 | 30.090 | 1.480 | 1.660 | 20.4 | 1.83 |
| 14 | −4.249 | 0.360 | | | 1.83 |
| 15 | −6.105 | 0.505 | 1.639 | 23.5 | 1.80 |
| 16 | 48.055 | 5.392 | | | 1.80 |
| 17 | Infinity | 0.210 | 1.518 | 64.2 | 3.15 |
| 18 | Infinity | 3.580 | | | 3.18 |
| Image | Infinity | | | | 4.10 |

Table 6 illustrates aspheric data of the optical imaging system 300 according to the third embodiment of the present disclosure.

TABLE 6

| Surface | 2 | 3 | 7 | 8 | 9 | 10 |
|---|---|---|---|---|---|---|
| K | −3.68E+00 | 9.16E+00 | 9.89E−01 | 3.71E−02 | 1.02E+00 | −1.03E+00 |
| A | 1.40E−03 | 7.65E−04 | −1.12E−04 | 7.93E−03 | −9.03E−05 | −9.66E−03 |
| B | −4.91E−05 | −1.57E−04 | −1.65E−04 | −2.89E−03 | 3.86E−05 | 4.21E−03 |
| C | 1.18E−05 | 5.72E−05 | −2.00E−04 | 1.09E−03 | 5.01E−06 | −1.35E−03 |
| D | −9.19E−07 | −1.25E−05 | 1.88E−04 | −4.44E−04 | 3.62E−07 | 6.06E−04 |
| E | −5.67E−08 | 1.72E−06 | −8.94E−05 | 1.31E−04 | 0.00E+00 | −2.40E−04 |
| F | 1.89E−08 | −1.49E−07 | 2.33E−05 | −2.37E−05 | 0.00E+00 | 6.67E−05 |
| G | −1.65E−09 | 7.87E−09 | −3.43E−06 | 2.36E−06 | 0.00E+00 | −9.82E−06 |
| H | 6.53E−11 | −2.33E−10 | 2.66E−07 | −1.03E−07 | 0.00E+00 | 5.97E−07 |
| J | −1.00E−12 | 2.96E−12 | −8.35E−09 | 6.65E−10 | 0.00E+00 | −6.50E−09 |
| Surface | 11 | 12 | 13 | 14 | 15 | 16 |
| K | 8.31E+01 | 8.00E+01 | 5.07E+00 | −1.43E+00 | 0.00E+00 | 5.28E+01 |
| A | −3.35E−04 | 1.61E−03 | −9.25E−04 | 3.47E−03 | −3.57E−03 | −8.74E−03 |
| B | −5.11E−05 | 6.71E−04 | 2.12E−03 | 4.98E−05 | −1.20E−03 | −2.54E−04 |
| C | 3.59E−05 | 5.78E−05 | −1.61E−04 | −3.08E−04 | −2.46E−04 | 5.39E−05 |
| D | 2.72E−05 | −2.24E−05 | −5.88E−05 | 5.25E−05 | 3.31E−05 | 2.92E−06 |
| E | 5.61E−06 | 0.00E+00 | 1.24E−05 | −1.15E−05 | 3.64E−06 | 6.38E−08 |
| F | 0.00E+00 | 0.00E+00 | −1.03E−06 | 2.87E−06 | 0.00E+00 | 0.00E+00 |
| G | 0.00E+00 | 0.00E+00 | 4.37E−08 | −3.51E−07 | 0.00E+00 | 0.00E+00 |
| H | 0.00E+00 | 0.00E+00 | −9.48E−10 | 1.93E−08 | 0.00E+00 | 0.00E+00 |
| J | 0.00E+00 | 0.00E+00 | 8.33E−12 | −3.91E−10 | 0.00E+00 | 0.00E+00 |

### Fourth Embodiment

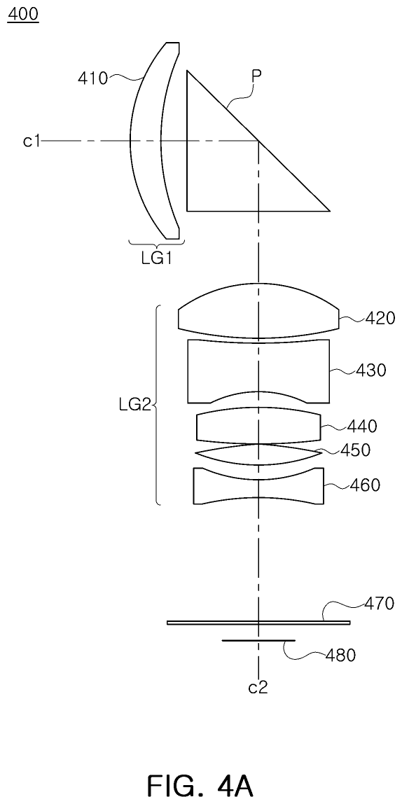

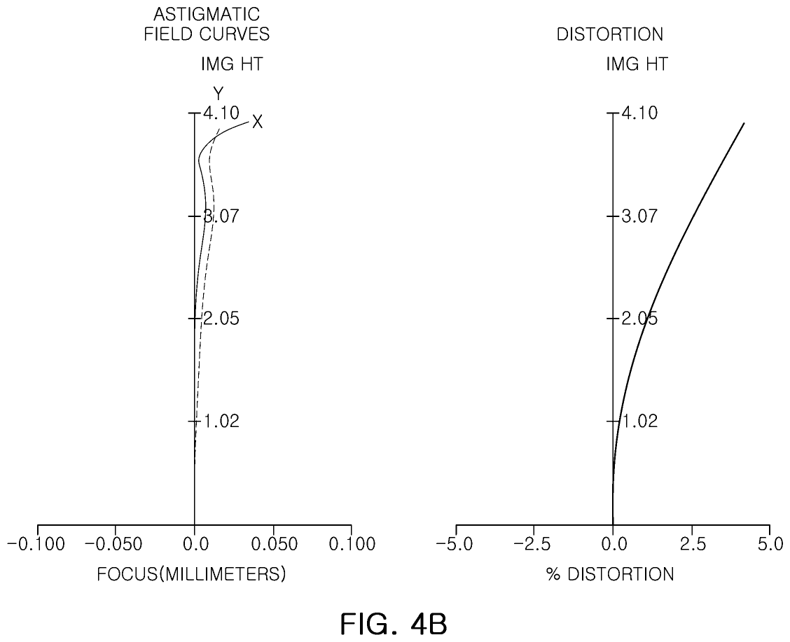

FIG. 4A is a block diagram of an optical imaging system according to a fourth embodiment of the present disclosure, and FIG. 4B is a graph illustrating aberration characteristics of an optical imaging system according to the fourth embodiment of the present disclosure.

An optical imaging system 400 according to the fourth embodiment may include a first lens 410, a second lens 420, a third lens 430, a fourth lens 440, a fifth lens 450, and a sixth lens 460 arranged in order from an object side toward an image side, and may further include an infrared cut-off filter 470 and an image sensor 480 disposed on an image side of the sixth lens 460.

The first lens 410 may have positive refractive power. An object-side surface of the first lens 410 may have a convex shape in the paraxial region, and an image-side surface of the first lens 410 may have a concave shape in the paraxial region, that is, a meniscus shape convex toward the object side. The first lens 410 may be formed of plastic. The first lens 410 may be an aspherical lens. For example, the object-side surface and the image-side surface of the first lens 410 may be aspherical.

The second lens 420 may have positive refractive power. An object-side surface and an image-side surface of the second lens 420 may have a convex shape in the paraxial region. The second lens 420 may be formed of plastic. The second lens 420 may be an aspherical lens. For example, the object-side surface and the image-side surface of the second lens 420 may be aspherical.

The third lens 430 may have negative refractive power. An object-side surface and an image-side surface of the third lens 430 may have a concave shape in the paraxial region. The third lens 430 may be formed of plastic. In detail, the third lens 430 may be formed of a plastic material with optical properties (e.g., refractive index and Abbe number) different from the second lens 420. The third lens 430 may be an aspherical lens. For example, the object-side surface and the image-side surface of the third lens 430 may be aspherical.

The fourth lens 440 may have positive refractive power. An object-side surface and an image-side surface of the fourth lens 440 may have a convex shape in the paraxial region. The fourth lens 440 may be formed of plastic. In detail, the fourth lens 440 may be formed of a plastic material with optical properties (e.g., refractive index and Abbe number) different from the third lens 430. The fourth lens 440 may be an aspherical lens. For example, the object-side surface and the image-side surface of the fourth lens 440 may be aspherical.

The fifth lens 450 may have positive refractive power. An object-side surface and an image-side surface of the fifth lens 450 may have a convex shape in the paraxial region. The fifth lens 450 may be formed of plastic. In detail, the fifth lens 450 may be formed of a plastic material with optical properties (e.g., refractive index and Abbe number) different from the fourth lens 440. The fifth lens 450 may be an aspherical lens. For example, the object-side surface and the image-side surface of the fifth lens 450 may be aspherical.

The sixth lens 460 may have negative refractive power. An object-side surface and an image-side surface of the sixth lens 460 may have a concave shape in the paraxial region. The sixth lens 460 may be formed of plastic. In detail, the sixth lens 460 may be formed of a plastic material with optical properties (e.g., refractive index and Abbe number) different from the fifth lens 450. The sixth lens 460 may be an aspherical lens. For example, the object-side surface and the image-side surface of the sixth lens 460 may be aspherical.

A prism P may be disposed between the first lens 410 and the second lens 420. The first lens 410 disposed on the object side with respect to the prism P may constitute a first lens group LG1, and the second to sixth lenses 420 to 460 disposed on the image side with respect to the prism P may constitute the second lens group LG2. Both the first lens group LG1 and the second lens group LG2 may have positive refractive power.

Table 7 illustrates optical and physical parameters of the optical imaging system 400 according to the fourth embodiment of the present disclosure.

TABLE 7

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.224 | 1.200 | 1.535 | 55.7 | 3.78 |
| 3 | 11.440 | 1.000 | | | 3.57 |
| 4 | Infinity | 3.200 | 1.717 | 29.5 | 2.90 |
| 5 | Infinity | 3.200 | 1.717 | 29.5 | 4.10 |
| 6 | Infinity | 3.100 | | | 2.90 |
| 7 | 5.418 | 2.411 | 1.535 | 55.7 | 3.08 |
| 8 | −12.807 | 0.161 | | | 2.80 |
| 9 | −26.687 | 2.126 | 1.614 | 25.9 | 2.66 |
| 10 | 3.855 | 0.719 | | | 1.96 |
| 11 | 16.536 | 1.538 | 1.544 | 56.0 | 2.13 |
| 12 | −315.218 | 0.100 | | | 2.39 |
| 13 | 19.256 | 0.888 | 1.660 | 20.4 | 2.47 |
| 14 | −6.150 | 0.580 | | | 2.48 |
| 15 | −10.223 | 0.880 | 1.639 | 23.5 | 2.37 |
| 16 | 8.037 | 5.399 | | | 2.55 |
| 17 | Infinity | 0.210 | 1.518 | 64.2 | 3.90 |
| 18 | Infinity | 0.601 | | | 3.94 |
| Image | Infinity | | | | 4.10 |

Table 8 illustrates aspheric data of the optical imaging system 400 according to the fourth embodiment of the present disclosure.

TABLE 8

| Surface | 2 | 3 | 7 | 8 | 9 | 10 |
|---|---|---|---|---|---|---|
| K | −4.70E+00 | 4.90E+00 | 0.00E+00 | 3.71E−02 | 3.69E+01 | −8.15E−01 |
| A | 1.30E−03 | 3.63E−04 | 1.70E−04 | 2.25E−03 | −2.45E−04 | −1.50E−03 |
| B | −1.26E−05 | −1.40E−05 | −1.66E−08 | −2.88E−04 | −9.68E−07 | 4.71E−04 |
| C | 3.56E−06 | 5.97E−06 | 2.19E−07 | 2.64E−07 | 2.50E−06 | 2.84E−04 |
| D | −4.93E−07 | −1.25E−06 | −3.40E−07 | 1.14E−05 | 6.07E−07 | −2.01E−04 |
| E | 4.14E−08 | 1.50E−07 | 0.00E+00 | −4.03E−06 | 0.00E+00 | 8.99E−05 |
| F | −1.42E−09 | −1.06E−08 | 0.00E+00 | 7.60E−07 | 0.00E+00 | −2.37E−05 |
| G | −2.76E−11 | 4.28E−10 | 0.00E+00 | −8.17E−08 | 0.00E+00 | 3.57E−06 |
| H | 3.53E−12 | −9.29E−12 | 0.00E+00 | 4.77E−09 | 0.00E+00 | −2.65E−07 |
| J | −7.46E−14 | 8.97E−14 | 0.00E+00 | −1.18E−10 | 0.00E+00 | 6.19E−09 |
| Surface | 11 | 12 | 13 | 14 | 15 | 16 |
| K | 3.37E+01 | 9.00E+01 | −1.58E+00 | −2.99E+00 | 0.00E+00 | 0.00E+00 |
| A | −1.15E−03 | 1.38E−03 | 3.45E−03 | 3.47E−03 | −2.05E−03 | −5.53E−03 |
| B | 1.85E−04 | 5.35E−05 | 1.89E−04 | −2.59E−04 | −5.15E−04 | 1.87E−04 |
| C | 5.43E−05 | −3.23E−05 | −3.31E−05 | −3.21E−05 | −3.58E−05 | −7.51E−06 |
| D | −8.10E−06 | −5.28E−06 | −1.34E−05 | 9.90E−07 | 3.24E−06 | 7.89E−07 |
| E | 8.04E−08 | 0.00E+00 | 2.59E−06 | −7.89E−07 | 1.25E−07 | 0.00E+00 |
| F | 0.00E+00 | 0.00E+00 | −1.88E−07 | 2.77E−07 | 0.00E+00 | 0.00E+00 |
| G | 0.00E+00 | 0.00E+00 | 6.77E−09 | −2.80E−08 | 0.00E+00 | 0.00E+00 |
| H | 0.00E+00 | 0.00E+00 | −1.21E−10 | 1.16E−09 | 0.00E+00 | 0.00E+00 |
| J | 0.00E+00 | 0.00E+00 | 8.48E−13 | −1.73E−11 | 0.00E+00 | 0.00E+00 |

### Fifth Embodiment

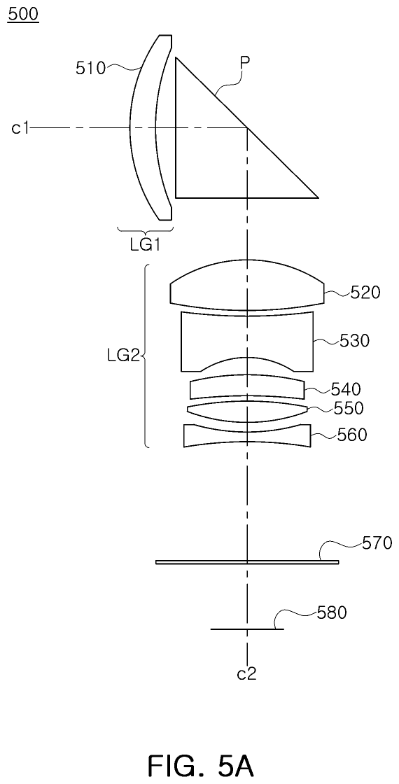

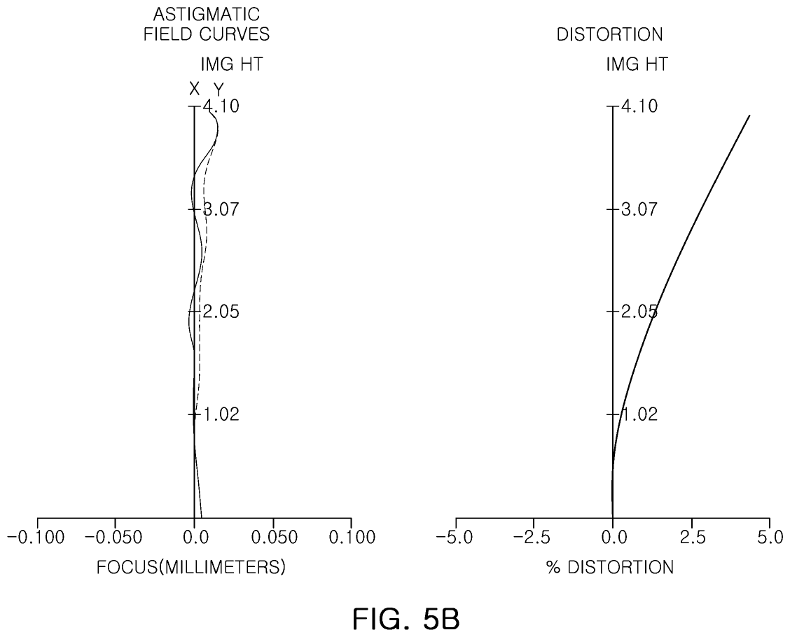

FIG. 5A is a block diagram of an optical imaging system according to a fifth embodiment of the present disclosure, and FIG. 5B is a graph illustrating aberration characteristics of an optical imaging system according to the fifth embodiment of the present disclosure

An optical imaging system 500 according to the fifth embodiment may include a first lens 510, a second lens 520, a third lens 530, a fourth lens 540, a fifth lens 550, and a sixth lens 560 arranged in order from an object side toward an image side, may further include an infrared cut-off filter 570 and an image sensor 580 disposed on an image side of the sixth lens 560.

The first lens 510 may have positive refractive power. An object-side surface of the first lens 510 may have a convex shape in the paraxial region, and an image-side surface of the first lens 510 may have a concave shape in the paraxial region, that is, a meniscus shape convex toward the object side. The first lens 510 may be formed of plastic. The first lens 510 may be formed of an aspherical lens. For example, the object-side surface and the image-side surface of the first lens 510 may be aspherical.

The second lens 520 may have positive refractive power. An object-side surface and an image-side surface of the second lens 520 may have a convex shape in the paraxial region. The second lens 520 may be formed of plastic. The second lens 520 may be an aspherical lens. For example, the object-side surface and the image-side surface of the second lens 520 may be aspherical.

The third lens 530 may have negative refractive power. An object-side surface and an image-side surface of the third lens 530 may have a concave shape in the paraxial region. The third lens 530 may be formed of plastic. In detail, the third lens 530 may be formed of a plastic material with optical properties (e.g., refractive index and Abbe number) different from the second lens 520. The third lens 530 may be an aspherical lens. For example, the object-side surface and the image-side surface of the third lens 530 may be aspherical.

The fourth lens 540 may have positive refractive power. An object-side surface of the fourth lens 540 may have a convex shape in the paraxial region, and an image-side surface of the fourth lens 540 may have a concave shape in the paraxial region. The fourth lens 540 may be formed of plastic. In detail, the fourth lens 540 may be formed of a plastic material with optical properties (e.g., refractive index and Abbe number) different from the third lens 530. The fourth lens 540 may be an aspherical lens. For example, the object-side surface and the image-side surface of the fourth lens 540 may be aspherical.

The fifth lens 550 may have positive refractive power. An object-side surface and an image-side surface of the fifth lens 550 may have a convex shape in the paraxial region. The fifth lens 550 may be formed of plastic. In detail, the fifth lens 550 may be formed of a plastic material with optical properties (e.g., refractive index and Abbe number) different from the fourth lens 540. The fifth lens 550 may be an aspherical lens. For example, the object-side surface and the image-side surface of the fifth lens 550 may be aspherical.

The sixth lens 560 may have negative refractive power. An object-side surface and an image-side surface of the sixth lens 560 may have a concave shape in the paraxial region. The sixth lens 560 may be formed of plastic. In detail, the sixth lens 560 may be formed of a plastic material with optical properties (e.g., refractive index and Abbe number) different from the fifth lens 550. The sixth lens 560 may be an aspherical lens. For example, the object-side surface and the image-side surface of the sixth lens 560 may be aspherical.

A prism P may be disposed between the first lens 510 and the second lens 520. The first lens 510 disposed on the object side with respect to the prism P may constitute a first lens group LG1, and the second to sixth lenses 520 to 560 disposed on the image side with respect to the prism P may constitute a second lens group LG2. Both the first lens group LG1 and the second lens group LG2 may have positive refractive power.

Table 9 illustrates optical and physical parameters of the optical imaging system 500 according to the fifth embodiment of the present disclosure.

TABLE 9

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.249 | 1.100 | 1.535 | 55.7 | 3.60 |
| 3 | 11.503 | 0.900 | | | 3.42 |
| 4 | Infinity | 3.200 | 1.717 | 29.5 | 2.90 |
| 5 | Infinity | 3.200 | 1.717 | 29.5 | 4.10 |
| 6 | Infinity | 3.000 | | | 2.90 |
| 7 | 5.411 | 2.399 | 1.535 | 55.7 | 3.08 |
| 8 | −13.110 | 0.139 | | | 2.77 |
| 9 | −28.256 | 2.025 | 1.614 | 25.9 | 2.64 |
| 10 | 3.853 | 0.810 | | | 1.97 |
| 11 | 16.978 | 0.959 | 1.544 | 56.0 | 2.15 |
| 12 | 22.784 | 0.159 | | | 2.29 |
| 13 | 17.358 | 1.001 | 1.660 | 20.4 | 2.37 |
| 14 | −6.444 | 0.473 | | | 2.39 |
| 15 | −15.854 | 0.505 | 1.639 | 23.5 | 2.31 |
| 16 | 8.414 | 5.399 | | | 2.55 |
| 17 | Infinity | 0.110 | 1.518 | 64.2 | 3.45 |
| 18 | Infinity | 3.147 | | | 3.46 |
| Image | Infinity | | | | 4.10 |

Table 10 illustrates aspheric data of the optical imaging system 500 according to the fifth embodiment of the present disclosure.

TABLE 10

| Surface | 2 | 3 | 7 | 8 | 9 | 10 |
|---|---|---|---|---|---|---|
| K | −4.60E+00 | 5.01E+00 | 0.00E+00 | 3.71E−02 | 3.61E+01 | −7.97E−01 |
| A | 1.30E−03 | 3.67E−04 | 1.59E−04 | 2.37E−03 | −2.36E−04 | −1.58E−03 |
| B | −2.26E−05 | −3.60E−05 | −1.52E−05 | −3.30E−04 | −3.28E−07 | 7.04E−04 |
| C | 6.73E−06 | 1.44E−05 | 4.98E−08 | 2.09E−05 | 2.64E−06 | −2.56E−05 |
| D | −8.72E−07 | −3.04E−06 | −3.72E−07 | 2.54E−06 | 6.32E−07 | 5.99E−05 |
| E | 5.08E−08 | 3.84E−07 | 0.00E+00 | −1.62E−06 | 0.00E+00 | −4.60E−05 |
| F | 1.38E−09 | −2.99E−08 | 0.00E+00 | 3.53E−07 | 0.00E+00 | 1.98E−05 |
| G | −3.59E−10 | 1.40E−09 | 0.00E+00 | −4.01E−08 | 0.00E+00 | −4.73E−06 |
| H | 1.86E−11 | −3.62E−11 | 0.00E+00 | 2.42E−09 | 0.00E+00 | 5.97E−07 |
| J | −3.28E−13 | 4.05E−13 | 0.00E+00 | −6.20E−11 | 0.00E+00 | −3.13E−08 |
| Surface | 11 | 12 | 13 | 14 | 15 | 16 |
| K | 3.22E+01 | 7.23E+00 | −8.47E−01 | −2.93E+00 | 0.00E+00 | 0.00E+00 |
| A | −1.24E−03 | 1.47E−03 | 3.05E−03 | 3.43E−03 | −2.01E−03 | −5.72E−03 |
| B | 1.78E−04 | 6.27E−05 | 3.50E−04 | −1.83E−04 | −4.95E−04 | 1.70E−04 |
| C | 5.35E−05 | −3.15E−05 | −5.93E−05 | −4.76E−05 | −3.47E−05 | −5.43E−06 |
| D | −7.94E−06 | −5.45E−06 | −1.19E−05 | 1.38E−06 | 3.39E−06 | 1.48E−06 |
| E | 2.60E−07 | 0.00E+00 | 2.66E−06 | −8.17E−07 | 2.00E−07 | 0.00E+00 |
| F | 0.00E+00 | 0.00E+00 | −2.02E−07 | 3.04E−07 | 0.00E+00 | 0.00E+00 |
| G | 0.00E+00 | 0.00E+00 | 7.56E−09 | −3.14E−08 | 0.00E+00 | 0.00E+00 |
| H | 0.00E+00 | 0.00E+00 | −1.40E−10 | 1.32E−09 | 0.00E+00 | 0.00E+00 |
| J | 0.00E+00 | 0.00E+00 | 1.02E−12 | −1.99E−11 | 0.00E+00 | 0.00E+00 |

### Six Embodiment

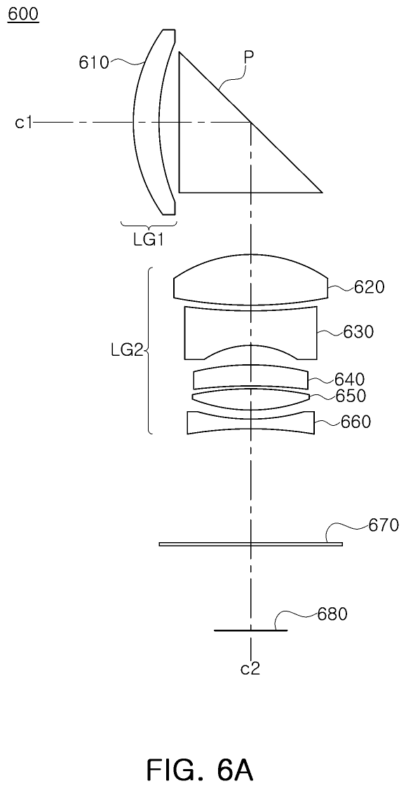

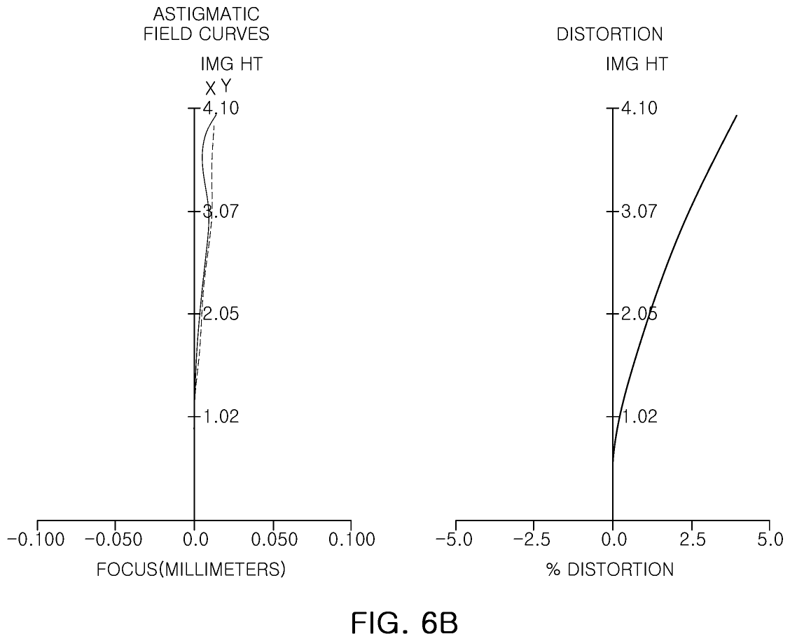

FIG. 6A is a block diagram of an optical imaging system according to a sixth embodiment of the present disclosure, and FIG. 6B is a graph illustrating aberration characteristics of an optical imaging system according to the sixth embodiment of the present disclosure.

An optical imaging system 600 according to the sixth embodiment includes a first lens 610, a second lens 620, a third lens 630, a fourth lens 640, a fifth lens 650, and a sixth lens 660 arranged in order from an object side toward an image side, and may further include an infrared cut-off filter 670 and an image sensor 680 disposed on an image side of the sixth lens 660.

The first lens 610 may have positive refractive power. An object-side surface of the first lens 610 may have a convex shape in the paraxial region, and an image-side surface of the first lens 610 may have a concave shape in the paraxial region, that is, a meniscus shape convex toward the object side. The first lens 610 may be formed of plastic. The first lens 610 may be an aspherical lens. For example, the object-side surface and the image-side surface of the first lens 610 may be aspherical.

The second lens 620 may have positive refractive power. An object-side surface and an image-side surface of the second lens 620 may have a convex shape in the paraxial region. The second lens 620 may be formed of plastic. The second lens 620 may be an aspherical lens. For example, the object-side surface and the image-side surface of the second lens 620 may be aspherical.

The third lens 630 may have negative refractive power. An object-side surface and an image-side surface of the third lens 630 may have a concave shape in the paraxial region. The third lens 630 may be formed of plastic. In detail, the third lens 630 may be formed of a plastic material with optical properties (e.g., refractive index and Abbe number) different from the second lens 620. The third lens 630 may be an aspherical lens. For example, the object-side surface and the image-side surface of the third lens 630 may be aspherical.

The fourth lens 640 may have positive refractive power. An object-side surface of the fourth lens 640 may be convex in the paraxial region, and an image-side surface of the fourth lens 640 may have a concave shape in the paraxial region. The fourth lens 640 may be formed of plastic. In detail, the fourth lens 640 may be formed of a plastic material with optical properties (e.g., refractive index and Abbe number) different from the third lens 630. The fourth lens 640 may be an aspherical lens. For example, the object-side surface and the image-side surface of the fourth lens 640 may be aspherical.

The fifth lens 650 may have positive refractive power. An object-side surface and an image-side surface of the fifth lens 650 may have a convex shape in the paraxial region. The fifth lens 650 may be formed of plastic. In detail, the fifth lens 650 may be formed of a plastic material with optical properties (e.g., refractive index and Abbe number) different from the fourth lens 640. The fifth lens 650 may be an aspherical lens. For example, the object-side surface and the image-side surface of the fifth lens 650 may be aspherical.

The sixth lens 660 may have negative refractive power. An object-side surface and an image-side surface of the sixth lens 660 may have a concave shape in the paraxial region. The sixth lens 660 may be formed of plastic. In detail, the sixth lens 660 may be formed of a plastic material with optical properties (e.g., refractive index and Abbe number) different from the fifth lens 650. The sixth lens 660 may be an aspherical lens. For example, the object-side surface and the image-side surface of the sixth lens 660 may be aspherical.

A prism P may be disposed between the first lens 610 and the second lens 620. The first lens 610 disposed on the object side with respect to the prism P may constitute a first lens group LG1, and the second to sixth lenses 620 to 660 disposed on the image side with respect to the prism P may constitute a second lens group LG2. Both the first lens group LG1 and the second lens group LG2 may have positive refractive power.

Table 11 illustrates optical and physical parameters of the optical imaging system 600 according to the sixth embodiment of the present disclosure.

TABLE 11

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.246 | 1.100 | 1.535 | 55.7 | 3.50 |
| 3 | 11.491 | 0.950 | | | 3.33 |
| 4 | Infinity | 3.200 | 1.717 | 29.5 | 2.90 |
| 5 | Infinity | 3.200 | 1.717 | 29.5 | 4.10 |
| 6 | Infinity | 2.900 | | | 2.90 |
| 7 | 5.415 | 2.371 | 1.535 | 55.7 | 3.08 |
| 8 | −13.033 | 0.116 | | | 2.68 |
| 9 | −27.637 | 1.983 | 1.614 | 25.9 | 2.57 |
| 10 | 3.860 | 0.795 | | | 1.95 |
| 11 | 16.870 | 0.941 | 1.544 | 56.0 | 2.11 |
| 12 | 18.956 | 0.110 | | | 2.24 |
| 13 | 15.398 | 0.971 | 1.660 | 20.4 | 2.30 |
| 14 | −6.494 | 0.420 | | | 2.32 |
| 15 | −17.214 | 0.406 | 1.639 | 23.5 | 2.25 |
| 16 | 8.056 | 5.399 | | | 2.55 |
| 17 | Infinity | 0.210 | 1.518 | 64.2 | 3.31 |
| 18 | Infinity | 4.005 | | | 3.33 |
| Image | Infinity | | | | 4.10 |

Table 12 illustrates aspheric data of the optical imaging system 600 according to the sixth embodiment of the present disclosure.

TABLE 12

| Surface | 2 | 3 | 7 | 8 | 9 | 10 |
|---|---|---|---|---|---|---|
| K | −4.63E+00 | 4.96E+00 | 0.00E+00 | 3.71E−02 | 3.70E+01 | −8.06E−01 |
| A | 1.27E−03 | 3.02E−04 | 1.39E−04 | 2.46E−03 | −2.45E−04 | −1.66E−03 |
| B | −1.57E−05 | −1.37E−05 | −1.61E−05 | −3.61E−04 | −1.06E−06 | 7.15E−04 |
| C | 4.49E−06 | 4.57E−06 | 8.49E−08 | 2.91E−05 | 2.54E−06 | 1.17E−05 |
| D | −5.16E−07 | −5.51E−07 | −3.67E−07 | −6.90E−07 | 6.17E−07 | 2.53E−05 |
| E | 3.00E−08 | 1.71E−08 | 0.00E+00 | −6.29E−07 | 0.00E+00 | −2.83E−05 |
| F | 2.43E−10 | 2.50E−09 | 0.00E+00 | 1.74E−07 | 0.00E+00 | 1.41E−05 |
| G | −1.31E−10 | −2.65E−10 | 0.00E+00 | −2.20E−08 | 0.00E+00 | −3.63E−06 |
| H | 6.87E−12 | 9.33E−12 | 0.00E+00 | 1.48E−09 | 0.00E+00 | 4.81E−07 |
| J | −1.23E−13 | −1.09E−13 | 0.00E+00 | −4.28E−11 | 0.00E+00 | −2.61E−08 |
| Surface | 11 | 12 | 13 | 14 | 15 | 16 |
| K | 3.27E+01 | 5.66E+00 | −3.91E−01 | −2.90E+00 | 0.00E+00 | 0.00E+00 |
| A | −1.21E−03 | 1.43E−03 | 2.74E−03 | 3.29E−03 | −1.97E−03 | −5.72E−03 |
| B | 1.82E−04 | 5.78E−05 | 4.08E−04 | −1.83E−04 | −4.99E−04 | 1.85E−04 |
| C | 5.43E−05 | −3.22E−05 | −5.30E−05 | −3.82E−05 | −3.52E−05 | −4.35E−06 |
| D | −7.85E−06 | −5.50E−06 | −1.43E−05 | −9.92E−07 | 3.43E−06 | 1.73E−06 |
| E | 2.39E−07 | 0.00E+00 | 2.92E−06 | −4.36E−07 | 2.02E−07 | 0.00E+00 |
| F | 0.00E+00 | 0.00E+00 | −2.16E−07 | 2.61E−07 | 0.00E+00 | 0.00E+00 |
| G | 0.00E+00 | 0.00E+00 | 7.99E−09 | −2.84E−08 | 0.00E+00 | 0.00E+00 |
| H | 0.00E+00 | 0.00E+00 | −1.47E−10 | 1.20E−09 | 0.00E+00 | 0.00E+00 |
| J | 0.00E+00 | 0.00E+00 | 1.07E−12 | −1.82E−11 | 0.00E+00 | 0.00E+00 |

### Seventh Embodiment

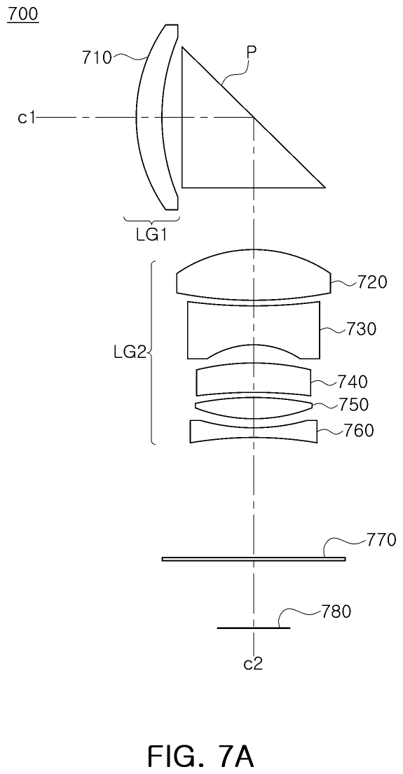

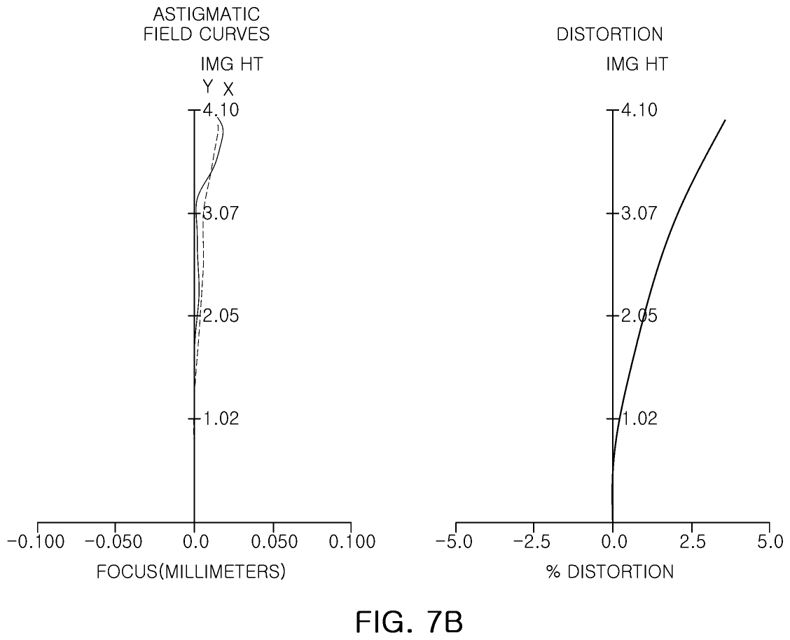

FIG. 7A is a block diagram of an optical imaging system according to a seventh embodiment of the present disclosure, and FIG. 7B is a graph illustrating aberration characteristics of an optical imaging system according to the seventh embodiment of the present disclosure.

An optical imaging system 700 according to the seventh embodiment may include a first lens 710, a second lens 720, a third lens 730, a fourth lens 740, a fifth lens 750, and a sixth lens 760 arranged in order from an object side toward an image side, and may further include an infrared cut-off filter 770 and an image sensor 780 disposed on an image side of the sixth lens 760.

The first lens 710 may have positive refractive power. An object-side surface of the first lens 710 may have a convex shape in the paraxial region, and an image-side surface of the first lens 710 may have a concave shape in the paraxial region, that is, a meniscus shape convex toward the object side. The first lens 710 may be formed of plastic. The first lens 710 may be an aspherical lens. For example, the object-side surface and the image-side surface of the first lens 710 may be aspherical.

The second lens 720 may have positive refractive power. An object-side surface and an image-side surface of the second lens 720 may have a convex shape in the paraxial region. The second lens 720 may be formed of plastic. The second lens 720 may be an aspherical lens. For example, the object-side surface and the image-side surface of the second lens 720 may be aspherical.

The third lens 730 may have negative refractive power. An object-side surface and an image-side surface of the third lens 730 may have a concave shape in the paraxial region. The third lens 730 may be formed of plastic. In detail, the third lens 730 may be formed of a plastic material with optical properties (e.g., refractive index and Abbe number) different from the second lens 720. The third lens 730 may be an aspherical lens. For example, the object-side surface and the image-side surface of the third lens 730 may be aspherical.

The fourth lens 740 may have positive refractive power. An object-side surface of the fourth lens 740 may be convex in the paraxial region, and an image-side surface of the fourth lens 740 may be concave in the paraxial region. The fourth lens 740 may be formed of plastic. In detail, the fourth lens 740 may be formed of a plastic material with optical properties (e.g., refractive index and Abbe number) different from the third lens 730. The fourth lens 740 may be an aspherical lens. For example, the object-side surface and the image-side surface of the fourth lens 740 may be aspherical.

The fifth lens 750 may have positive refractive power. An object-side surface and an image-side surface of the fifth lens 750 may have a convex shape in the paraxial region. The fifth lens 750 may be formed of plastic. In detail, the fifth lens 750 may be formed of a plastic material with optical properties (e.g., refractive index and Abbe number) different from the fourth lens 740. The fifth lens 750 may be an aspherical lens. For example, the object-side surface and the image-side surface of the fifth lens 750 may be aspherical.

The sixth lens 760 may have negative refractive power. An object-side surface and an image-side surface of the sixth lens 760 may have a concave shape in the paraxial region. The sixth lens 760 may be formed of plastic. In detail, the sixth lens 760 may be formed of a plastic material with optical properties (e.g., refractive index and Abbe number) different from the fifth lens 750. The sixth lens 760 may be an aspherical lens. For example, the object-side surface and the image-side surface of the sixth lens 760 may be aspherical.

A prism P may be disposed between the first lens 710 and the second lens 720. The first lens 710 disposed on the object side with respect to the prism P may constitute a first lens group LG1, and the second to sixth lenses 720 to 760 disposed on the image side with respect to the prism P may constitute a second lens group LG2. Both the first lens group LG1 and the second lens group LG2 may have positive refractive power.

Table 13 illustrates optical and physical parameters of the optical imaging system 700 according to the seventh embodiment of the present disclosure.

TABLE 13

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.221 | 1.200 | 1.535 | 55.7 | 3.65 |
| 3 | 11.471 | 1.000 | | | 3.45 |
| 4 | Infinity | 3.200 | 1.717 | 29.5 | 2.90 |
| 5 | Infinity | 3.200 | 1.717 | 29.5 | 4.10 |
| 6 | Infinity | 2.900 | | | 2.90 |
| 7 | 5.420 | 2.437 | 1.535 | 55.7 | 3.08 |
| 8 | −12.934 | 0.172 | | | 2.79 |
| 9 | −27.358 | 1.794 | 1.614 | 25.9 | 2.64 |
| 10 | 3.854 | 0.775 | | | 2.02 |
| 11 | 16.727 | 1.343 | 1.544 | 56.0 | 2.18 |
| 12 | 29.952 | 0.100 | | | 2.38 |
| 13 | 16.367 | 0.923 | 1.660 | 20.4 | 2.44 |
| 14 | −6.261 | 0.470 | | | 2.45 |
| 15 | −11.847 | 0.578 | 1.639 | 23.5 | 2.35 |
| 16 | 8.581 | 5.399 | | | 2.55 |
| 17 | Infinity | 0.110 | 1.518 | 64.2 | 3.48 |
| 18 | Infinity | 3.033 | | | 3.50 |
| Image | Infinity | | | | 4.10 |

Table 14 illustrates aspheric data of the optical imaging system 700 according to the seventh embodiment of the present disclosure.

TABLE 14

| Surface | 2 | 3 | 7 | 8 | 9 | 10 |
|---|---|---|---|---|---|---|
| K | −4.68E+00 | 4.94E+00 | 0.00E+00 | 3.71E−02 | 3.63E+01 | −8.05E−01 |
| A | 1.31E−03 | 3.78E−04 | 1.58E−04 | 2.32E−03 | −2.36E−04 | −1.39E−03 |
| B | −1.85E−05 | −1.87E−05 | −1.44E−05 | −3.15E−04 | 5.43E−08 | 6.59E−04 |
| C | 5.89E−06 | 7.72E−06 | 2.88E−07 | 8.17E−06 | 2.56E−06 | −4.56E−05 |
| D | −1.00E−06 | −1.60E−06 | −3.51E−07 | 7.63E−06 | 6.03E−07 | 1.04E−04 |
| E | 1.08E−07 | 1.91E−07 | 0.00E+00 | −2.60E−06 | 0.00E+00 | −7.78E−05 |
| F | −6.77E−09 | −1.35E−08 | 0.00E+00 | 4.43E−07 | 0.00E+00 | 3.20E−05 |
| G | 2.24E−10 | 5.52E−10 | 0.00E+00 | −4.22E−08 | 0.00E+00 | −7.22E−06 |
| H | −2.75E−12 | −1.19E−11 | 0.00E+00 | 2.16E−09 | 0.00E+00 | 8.63E−07 |
| J | −1.21E−14 | 1.12E−13 | 0.00E+00 | −4.71E−11 | 0.00E+00 | −4.25E−08 |
| Surface | 11 | 12 | 13 | 14 | 15 | 16 |
| K | 3.28E+01 | 2.61E+00 | −7.45E−01 | −2.91E+00 | 0.00E+00 | 0.00E+00 |
| A | −1.20E−03 | 1.43E−03 | 3.00E−03 | 3.32E−03 | −1.99E−03 | −5.72E−03 |
| B | 1.79E−04 | 6.45E−05 | 2.91E−04 | −2.27E−04 | −5.09E−04 | 1.82E−04 |
| C | 5.39E−05 | −3.10E−05 | −3.49E−05 | −2.65E−05 | −3.66E−05 | −6.12E−06 |
| D | −7.97E−06 | −5.31E−06 | −1.52E−05 | −2.78E−06 | 3.10E−06 | 1.21E−06 |
| E | 1.77E−07 | 0.00E+00 | 2.86E−06 | −9.79E−08 | 1.57E−07 | 0.00E+00 |
| F | 0.00E+00 | 0.00E+00 | −2.06E−07 | 2.10E−07 | 0.00E+00 | 0.00E+00 |
| G | 0.00E+00 | 0.00E+00 | 7.48E−09 | −2.43E−08 | 0.00E+00 | 0.00E+00 |
| H | 0.00E+00 | 0.00E+00 | −1.35E−10 | 1.05E−09 | 0.00E+00 | 0.00E+00 |
| J | 0.00E+00 | 0.00E+00 | 9.69E−13 | −1.59E−11 | 0.00E+00 | 0.00E+00 |

### Eighth Embodiment

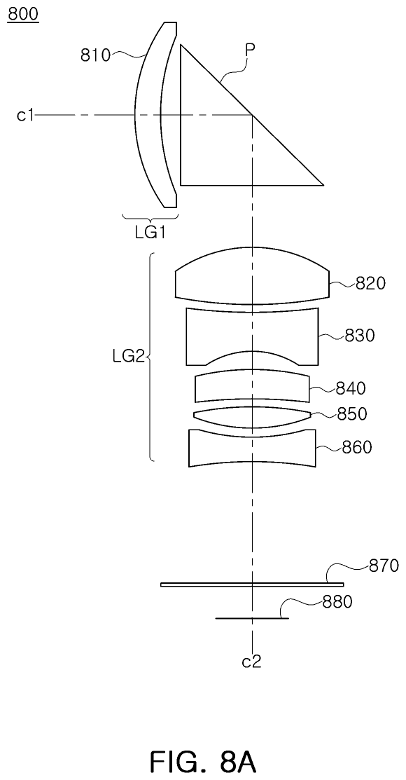

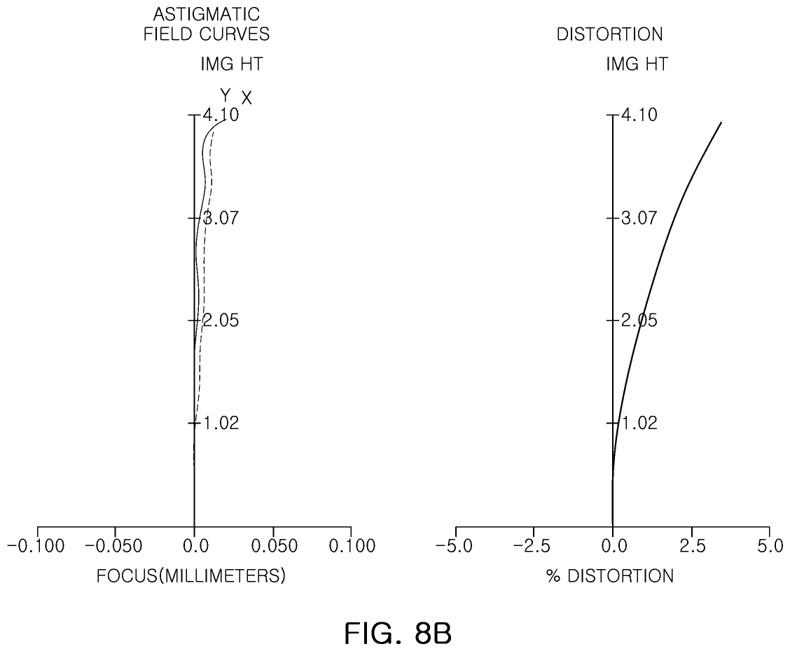

FIG. 8A is a block diagram of an optical imaging system according to an eighth embodiment of the present disclosure, and FIG. 8B is a graph illustrating aberration characteristics of an optical imaging system according to then eighth embodiment of the present disclosure.

An optical imaging system 800 according to the eighth embodiment may include a first lens 810, a second lens 820, a third lens 830, a fourth lens 840, a fifth lens 850, and a sixth lens 860 arranged in order from an object side toward an image side, and may further include an infrared cut-off filter 870 and an image sensor 880 disposed on an image side of the sixth lens 860.

The first lens 810 may have positive refractive power. An object-side surface of the first lens 810 may have a convex shape in the paraxial region, and an image-side surface of the first lens 810 may have a concave shape in the paraxial region, that is, a meniscus shape convex toward the object side. The first lens 810 may be formed of plastic. The first lens 810 may be an aspherical lens. For example, the object-side surface and the image-side surface of the first lens 810 may be aspherical.

The second lens 820 may have positive refractive power. The object-side surface and the image-side surface of the second lens 820 may have a convex shape in the paraxial region. The second lens 820 may be formed of plastic. The second lens 820 may be an aspherical lens. For example, the object-side surface and the image-side surface of the second lens 820 may be aspherical.

The third lens 830 may have negative refractive power. An object-side surface and an image-side surface of the third lens 830 may have a concave shape in the paraxial region. The third lens 830 may be formed of plastic. In detail, the third lens 830 may be formed of a plastic material with optical properties (e.g., refractive index and Abbe number) different from the second lens 820. The third lens 830 may be an aspherical lens. For example, the object-side surface and the image-side surface of the third lens 830 may be aspherical.

The fourth lens 840 may have positive refractive power. An object-side surface of the fourth lens 840 may have a convex shape in the paraxial region, and an image-side surface of the fourth lens 840 may have a concave shape in the paraxial region. The fourth lens 840 may be formed of plastic. In detail, the fourth lens 840 may be formed of a plastic material with optical properties (e.g., refractive index and Abbe number) different from the third lens 830. The fourth lens 840 may be an aspherical lens. For example, the object-side surface and the image-side surface of the fourth lens 840 may be aspherical.

The fifth lens 850 may have positive refractive power. An object-side surface and an image-side surface of the fifth lens 850 may have a convex shape in the paraxial region. The fifth lens 850 may be formed of plastic. In detail, the fifth lens 850 may be formed of a plastic material with optical properties (e.g., refractive index and Abbe number) different from the fourth lens 840. The fifth lens 850 may be an aspherical lens. For example, the object-side surface and the image-side surface of the fifth lens 850 may be aspherical.

The sixth lens 860 may have negative refractive power. An object-side surface and an image-side surface of the sixth lens 860 may have a concave shape in the paraxial region. The sixth lens 860 may be formed of plastic. In detail, the sixth lens 860 may be formed of a plastic material with optical properties (e.g., refractive index and Abbe number) different from the fifth lens 850. The sixth lens 860 may be an aspherical lens. For example, the object-side surface and the image-side surface of the sixth lens 860 may be aspherical.

A prism P may be disposed between the first lens 810 and the second lens 820. The first lens 810 disposed on the object side with respect to the prism P may constitute a first lens group LG1, and the second to sixth lenses 820 to 860 disposed on the image side with respect to the prism P may constitute a second lens group LG2. Both the first lens group LG1 and the second lens group LG2 may have positive refractive power.

Table 15 illustrates optical and physical parameters of the optical imaging system 800 according to the eighth embodiment of the present disclosure.

TABLE 15

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.215 | 1.200 | 1.535 | 55.7 | 3.60 |
| 3 | 11.326 | 1.000 | | | 3.41 |
| 4 | Infinity | 3.200 | 1.717 | 29.5 | 2.90 |
| 5 | Infinity | 3.200 | 1.717 | 29.5 | 4.10 |
| 6 | Infinity | 2.800 | | | 2.90 |
| 7 | 5.438 | 2.571 | 1.535 | 55.7 | 3.08 |
| 8 | −12.618 | 0.236 | | | 2.75 |
| 9 | −25.614 | 1.714 | 1.614 | 25.9 | 2.57 |
| 10 | 3.871 | 0.755 | | | 1.99 |
| 11 | 16.351 | 1.572 | 1.544 | 56.0 | 2.16 |
| 12 | 1010.435 | 0.100 | | | 2.42 |
| 13 | 17.896 | 0.959 | 1.660 | 20.4 | 2.49 |
| 14 | −5.993 | 0.463 | | | 2.50 |
| 15 | −9.764 | 0.922 | 1.639 | 23.5 | 2.39 |
| 16 | 7.871 | 5.399 | | | 2.55 |
| 17 | Infinity | 0.210 | 1.518 | 64.2 | 3.74 |
| 18 | Infinity | 1.401 | | | 3.77 |
| Image | Infinity | | | | 4.10 |

Table 16 illustrates aspheric data of the optical imaging system 800 according to the eighth embodiment of the present disclosure.

TABLE 16

| Surface | 2 | 3 | 7 | 8 | 9 | 10 |
|---|---|---|---|---|---|---|
| K | −4.71E+00 | 4.81E+00 | 0.00E+00 | 3.71E−02 | 3.74E+01 | −8.27E−01 |
| A | 1.30E−03 | 3.64E−04 | 1.52E−04 | 2.44E−03 | −2.55E−04 | −1.56E−03 |
| B | −1.17E−05 | −4.42E−06 | −1.64E−05 | −3.83E−04 | −6.96E−07 | 8.19E−04 |
| C | 3.84E−06 | 2.26E−06 | 5.14E−07 | 4.59E−05 | 2.48E−06 | −1.63E−04 |
| D | −7.22E−07 | −4.81E−07 | −3.09E−07 | −7.41E−06 | 5.90E−07 | 1.72E−04 |
| E | 9.28E−08 | 5.17E−08 | 0.00E+00 | 1.30E−06 | 0.00E+00 | −1.04E−04 |
| F | −7.38E−09 | −3.09E−09 | 0.00E+00 | −1.96E−07 | 0.00E+00 | 3.78E−05 |
| G | 3.52E−10 | 9.07E−11 | 0.00E+00 | 2.14E−08 | 0.00E+00 | −8.00E−06 |
| H | −9.12E−12 | −8.67E−13 | 0.00E+00 | −1.34E−09 | 0.00E+00 | 9.15E−07 |
| J | 9.83E−14 | −8.38E−16 | 0.00E+00 | 3.48E−11 | 0.00E+00 | −4.35E−08 |
| Surface | 11 | 12 | 13 | 14 | 15 | 16 |
| K | 3.43E+01 | −9.00E+01 | −8.87E−01 | −2.95E+00 | 0.00E+00 | 0.00E+00 |
| A | −1.07E−03 | 1.32E−03 | 3.08E−03 | 3.14E−03 | −1.97E−03 | −5.52E−03 |
| B | 1.88E−04 | 4.96E−05 | 3.16E−04 | −1.92E−04 | −5.15E−04 | 2.15E−04 |
| C | 5.51E−05 | −3.31E−05 | −7.33E−05 | −5.68E−05 | −3.41E−05 | −7.11E−06 |
| D | −8.37E−06 | −5.22E−06 | −3.72E−06 | 7.10E−06 | 3.42E−06 | 6.62E−07 |
| E | −2.04E−07 | 0.00E+00 | 1.33E−06 | −1.43E−06 | 1.00E−07 | 0.00E+00 |
| F | 0.00E+00 | 0.00E+00 | −9.92E−08 | 3.00E−07 | 0.00E+00 | 0.00E+00 |
| G | 0.00E+00 | 0.00E+00 | 3.34E−09 | −2.75E−08 | 0.00E+00 | 0.00E+00 |
| H | 0.00E+00 | 0.00E+00 | −5.19E−11 | 1.10E−09 | 0.00E+00 | 0.00E+00 |
| J | 0.00E+00 | 0.00E+00 | 2.84E−13 | −1.62E−11 | 0.00E+00 | 0.00E+00 |

### Ninth Embodiment

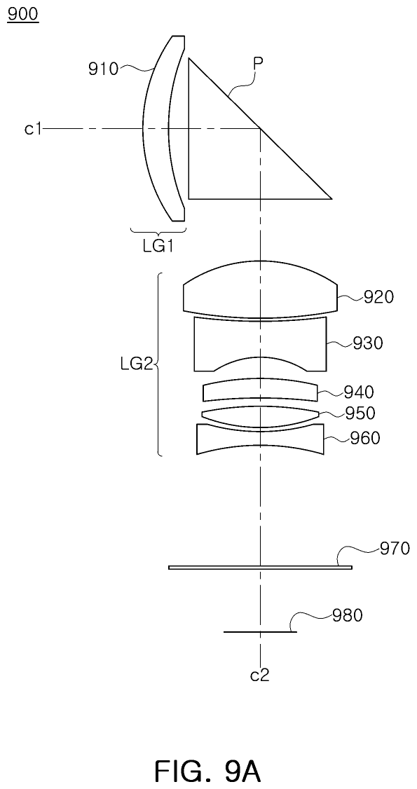

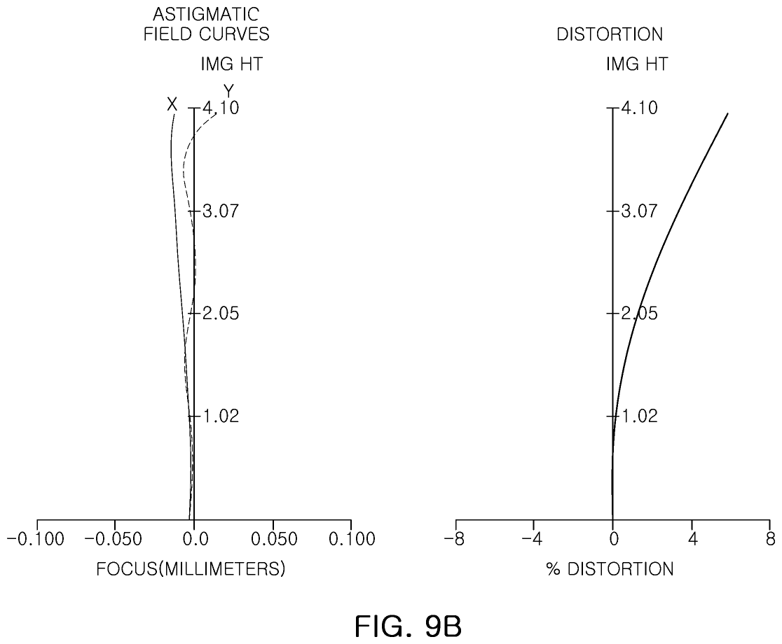

FIG. 9A is a block diagram of an optical imaging system according to a ninth embodiment of the present disclosure, and FIG. 9B is a graph illustrating aberration characteristics of an optical imaging system according to the ninth embodiment of the present disclosure.

An optical imaging system 900 according to the ninth embodiment may include a first lens 910, a second lens 920, a third lens 930, a fourth lens 940, a fifth lens 950, and a sixth lens 960 arranged in order from an object side toward an image side, and may further include an infrared cut-off filter 970 and an image sensor 980 disposed on an image side of the sixth lens 960.

The first lens 910 may have positive refractive power. An object-side surface of the first lens 910 may have a convex shape in the paraxial region, and an image-side surface of the first lens 910 may have a concave shape in the paraxial region, that is, a meniscus shape convex toward the object side. The first lens 910 may be formed of plastic. The first lens 910 may be an aspherical lens. For example, the object-side surface and the image-side surface of the first lens 910 may be aspherical.

The second lens 920 may have positive refractive power. An object-side surface and an image-side surface of the second lens 920 may have a convex shape in the paraxial region. The second lens 920 may be formed of plastic. The second lens 920 may be an aspherical lens. For example, the object-side surface and the image-side surface of the second lens 920 may be aspherical.

The third lens 930 may have negative refractive power. An object-side surface and an image-side surface of the third lens 930 may have a concave shape in the paraxial region. The third lens 930 may be formed of plastic. In detail, the third lens 930 may be formed of a plastic material with optical properties (e.g., refractive index and Abbe number) different from the second lens 920. The third lens 930 may be an aspherical lens. For example, the object-side surface and the image-side surface of the third lens 930 may be aspherical.

The fourth lens 940 may have positive refractive power. An object-side surface of the fourth lens 940 may be convex in the paraxial region, and an image-side surface of the fourth lens 940 may be concave in the paraxial region. The fourth lens 940 may be formed of plastic. In detail, the fourth lens 940 may be formed of a plastic material with optical properties (e.g., refractive index and Abbe number) different from the third lens 930. The fourth lens 940 may be an aspherical lens. For example, the object-side surface and the image-side surface of the fourth lens 940 may be aspherical.

The fifth lens 950 may have positive refractive power. An object-side surface and an image-side surface of the fifth lens 950 may have a convex shape in the paraxial region. The fifth lens 950 may be formed of plastic. In detail, the fifth lens 950 may be formed of a plastic material with optical properties (e.g., refractive index and Abbe number) different from the fourth lens 940. The fifth lens 950 may be an aspherical lens. For example, the object-side surface and the image-side surface of the fifth lens 950 may be aspherical.

The sixth lens 960 may have negative refractive power. The object-side surface and the image-side surface of the sixth lens 960 may have a concave shape in the paraxial region. The sixth lens 960 may be formed of plastic. In detail, the sixth lens 960 may be formed of a plastic material with optical properties (e.g., refractive index and Abbe number) different from the fifth lens 950. The sixth lens 960 may be an aspherical lens. For example, the object-side surface and the image-side surface of the sixth lens 960 may be aspherical.

A prism P may be disposed between the first lens 910 and the second lens 920. The first lens 910 disposed on the object side with respect to the prism P may constitute a first lens group LG1, and the second to sixth lenses 920 to 960 disposed on the image side with respect to the prism P may constitute a second lens group LG2. Both the first lens group LG1 and the second lens group LG2 may have positive refractive power.

Table 17 illustrates optical and physical parameters of the optical imaging system 900 according to the ninth embodiment of the present disclosure.

TABLE 17

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.205 | 1.100 | 1.535 | 55.7 | 3.70 |
| 3 | 12.353 | 0.900 | | | 3.52 |
| 4 | Infinity | 3.200 | 1.717 | 29.5 | 2.90 |
| 5 | Infinity | 3.200 | 1.717 | 29.5 | 4.10 |
| 6 | Infinity | 2.800 | | | 2.90 |
| 7 | 5.447 | 2.644 | 1.535 | 55.7 | 3.08 |
| 8 | −12.603 | 0.100 | | | 2.66 |
| 9 | −24.526 | 1.719 | 1.614 | 25.9 | 2.56 |
| 10 | 3.863 | 0.811 | | | 1.98 |
| 11 | 15.888 | 1.014 | 1.544 | 56.0 | 2.18 |
| 12 | 23.049 | 0.274 | | | 2.31 |
| 13 | 13.965 | 0.923 | 1.660 | 20.4 | 2.42 |
| 14 | −6.265 | 0.223 | | | 2.42 |
| 15 | −23.663 | 0.738 | 1.639 | 23.5 | 2.33 |
| 16 | 5.992 | 5.399 | | | 2.55 |
| 17 | Infinity | 0.210 | 1.518 | 64.2 | 3.46 |
| 18 | Infinity | 2.803 | | | 3.49 |
| Image | Infinity | | | | 4.10 |

Table 18 illustrates aspheric data of the optical imaging system 900 according to the ninth embodiment of the present disclosure.

TABLE 18

| Surface | 2 | 3 | 7 | 8 | 9 | 10 |
|---|---|---|---|---|---|---|
| K | −4.19E+00 | 5.95E+00 | 0.00E+00 | 3.71E−02 | 4.03E+01 | −7.95E−01 |
| A | 1.30E−03 | 4.26E−04 | 8.08E−05 | 2.80E−03 | −3.07E−04 | −1.72E−03 |
| B | −3.43E−05 | −6.17E−05 | −2.30E−05 | −5.06E−04 | −2.12E−06 | 8.58E−04 |
| C | 1.47E−05 | 3.02E−05 | 4.57E−07 | 5.23E−05 | 3.10E−06 | −2.52E−05 |
| D | −3.01E−06 | −7.78E−06 | −3.59E−07 | 4.54E−07 | 7.79E−07 | 3.81E−05 |
| E | 3.87E−07 | 1.23E−06 | 0.00E+00 | −2.62E−06 | 0.00E+00 | −3.42E−05 |
| F | −2.98E−08 | −1.20E−07 | 0.00E+00 | 7.29E−07 | 0.00E+00 | 1.61E−05 |
| G | 1.32E−09 | 7.01E−09 | 0.00E+00 | −9.70E−08 | 0.00E+00 | −4.06E−06 |
| H | −2.95E−11 | −2.24E−10 | 0.00E+00 | 6.56E−09 | 0.00E+00 | 5.20E−07 |
| J | 2.30E−13 | 2.99E−12 | 0.00E+00 | −1.81E−10 | 0.00E+00 | −2.68E−08 |
| Surface | 11 | 12 | 13 | 14 | 15 | 16 |
| K | 3.52E+01 | −4.14E+00 | 4.35E+00 | −2.79E+00 | 0.00E+00 | 0.00E+00 |
| A | −8.44E−04 | 1.16E−03 | 2.76E−03 | 3.36E−03 | −2.27E−03 | −5.18E−03 |
| B | 2.24E−04 | 3.68E−05 | 5.60E−04 | −1.38E−04 | −5.93E−04 | 2.60E−04 |
| C | 6.27E−05 | −3.67E−05 | −1.28E−04 | −1.04E−04 | −3.87E−05 | −1.14E−05 |
| D | −7.90E−06 | −4.97E−06 | 3.34E−06 | 2.02E−05 | 4.38E−06 | 1.37E−06 |
| E | −7.17E−07 | 0.00E+00 | 7.86E−07 | −4.21E−06 | 2.19E−07 | 0.00E+00 |
| F | 0.00E+00 | 0.00E+00 | −7.34E−08 | 6.74E−07 | 0.00E+00 | 0.00E+00 |
| G | 0.00E+00 | 0.00E+00 | 2.63E−09 | −5.51E−08 | 0.00E+00 | 0.00E+00 |
| H | 0.00E+00 | 0.00E+00 | −4.15E−11 | 2.12E−09 | 0.00E+00 | 0.00E+00 |
| J | 0.00E+00 | 0.00E+00 | 2.22E−13 | −3.10E−11 | 0.00E+00 | 0.00E+00 |

### Tenth Embodiment

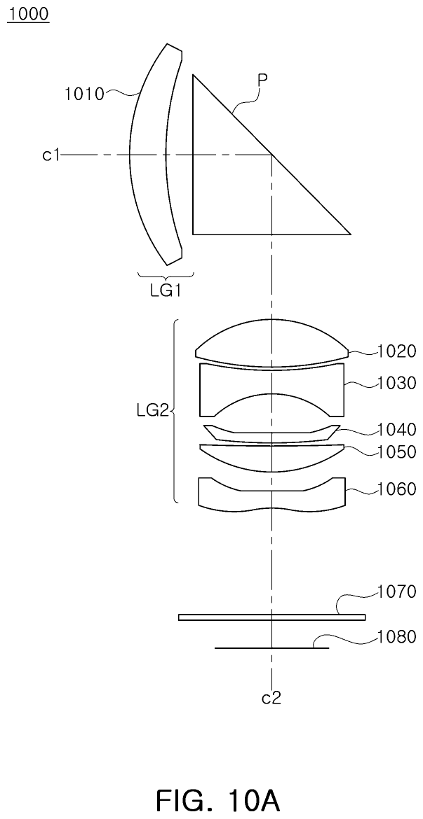

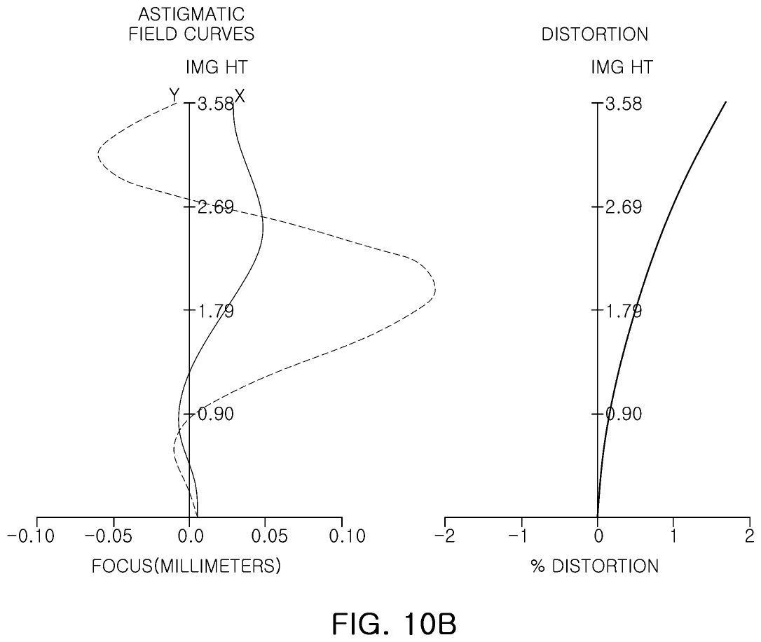

FIG. 10A is a block diagram of an optical imaging system according to a tenth embodiment of the present disclosure, and FIG. 10B is a graph illustrating aberration characteristics of an optical imaging system according to the tenth embodiment of the present disclosure.

An optical imaging system 1000 according to the tenth embodiment may include a first lens 1010, a second lens 1020, a third lens 1030, a fourth lens 1040, a fifth lens 1050, and a sixth lens 1060 arranged in order from an object side toward an image side, and may further include an infrared cut-off filter 1070 and an image sensor 1080 disposed on an image side of the sixth lens 1060.

The first lens 1010 may have positive refractive power. An object-side surface of the first lens 1010 may have a convex shape in the paraxial region, and an image-side surface of the first lens 1010 may have a concave shape in the paraxial region, that is, a meniscus shape convex toward the object side. The first lens 1010 may be formed of plastic. The first lens 1010 may be an aspherical lens. For example, the object-side surface and the image-side surface of the first lens 1010 may be aspherical.

The second lens 1020 may have positive refractive power. An object-side surface and an image-side surface of the second lens 1020 may have a convex shape in the paraxial region. The second lens 1020 may be formed of plastic. The second lens 1020 may be an aspherical lens. For example, the object-side surface and the image-side surface of the second lens 1020 may be aspherical.

The third lens 1030 may have negative refractive power. An object-side surface and an image-side surface of the third lens 1030 may have a concave shape in the paraxial region. The third lens 1030 may be formed of plastic. In detail, the third lens 1030 may be formed of a plastic material with optical properties (e.g., refractive index and Abbe number) different from the second lens 1020. The third lens 1030 may be an aspherical lens. For example, the object-side surface and the image-side surface of the third lens 1030 may be aspherical.

The fourth lens 1040 may have positive refractive power. An object-side surface of the fourth lens 1040 may have a concave shape in the paraxial region, and an image-side surface of the fourth lens 1040 may have a convex shape in the paraxial region. The fourth lens 1040 may be formed of plastic. In detail, the fourth lens 1040 may be formed of a plastic material with optical properties (e.g., refractive index and Abbe number) different from the third lens 1030. The fourth lens 1040 may be an aspherical lens. For example, the object-side surface and the image-side surface of the fourth lens 1040 may be aspherical.

The fifth lens 1050 may have positive refractive power. An object-side surface of the fifth lens 1050 may have a concave shape in the paraxial region, and an image-side surface of the fifth lens 1050 may have a convex shape in the paraxial region. The fifth lens 1050 may be formed of plastic. In detail, the fifth lens 1050 may be formed of a plastic material with optical properties (e.g., refractive index and Abbe number) different from the fourth lens 1040. The fifth lens 1050 may be an aspherical lens. For example, the object-side surface and the image-side surface of the fifth lens 1050 may be aspherical.

The sixth lens 1060 may have negative refractive power. An object-side surface and an image-side surface of the sixth lens 1060 may have a concave shape in the paraxial region. The sixth lens 1060 may be formed of plastic. In detail, the sixth lens 1060 may be formed of a plastic material with optical properties (e.g., refractive index and Abbe number) different from the fifth lens 1050. The sixth lens 1060 may be an aspherical lens. For example, the object-side surface and the image-side surface of the sixth lens 1060 may be aspherical.

A prism P may be disposed between the first lens 1010 and the second lens 1020. The first lens 1010 disposed on the object side with respect to the prism P may constitute a first lens group LG1, and the second to sixth lenses 1020 to 1060 disposed on the image side with respect to the prism P may constitute a second lens group LG2. Both the first lens group LG1 and the second lens group LG2 may have positive refractive power.

Table 19 illustrates optical and physical parameters of the optical imaging system 1000 according to the tenth embodiment of the present disclosure.

TABLE 19

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.186 | 1.300 | 1.536 | 55.7 | 4.00 |
| 3 | 14.092 | 1.150 | | | 3.76 |
| 4 | Infinity | 3.200 | 1.931 | 20.9 | 2.90 |
| 5 | Infinity | 3.200 | 1.931 | 20.9 | 4.24 |
| 6 | Infinity | 3.300 | | | 2.90 |
| 7 | 4.105 | 1.959 | 1.536 | 55.7 | 2.80 |
| 8 | −11.231 | 0.101 | | | 2.70 |
| 9 | −11.368 | 0.950 | 1.619 | 25.9 | 2.66 |
| 10 | 4.088 | 1.535 | | | 2.40 |
| 11 | −47.723 | 0.400 | 1.546 | 56.3 | 2.38 |
| 12 | −28.349 | 0.107 | | | 2.52 |
| 13 | −18.190 | 1.070 | 1.667 | 20.4 | 2.59 |
| 14 | −4.121 | 0.740 | | | 2.63 |
| 15 | −37.392 | 0.660 | 1.644 | 23.5 | 2.47 |
| 16 | 6.837 | 4.233 | | | 2.70 |
| 17 | Infinity | 0.210 | 1.518 | 64.2 | 3.37 |
| 18 | Infinity | 1.145 | | | 3.39 |
| Image | Infinity | | | | 3.59 |

Table 20 illustrates aspheric data of the optical imaging system 1000 according to the tenth embodiment of the present disclosure.

TABLE 20

| Surface | 2 | 3 | 7 | 8 | 9 | 10 |
|---|---|---|---|---|---|---|
| K | −9.02E+00 | 4.77E+00 | 8.01E−01 | −4.46E−02 | 3.49E+00 | −9.43E−01 |
| A | 2.68E−03 | 1.46E−03 | −8.52E−04 | 6.19E−03 | −3.54E−04 | −4.70E−03 |
| B | −4.97E−04 | −6.71E−04 | 4.53E−04 | −1.42E−03 | 1.95E−04 | 1.78E−03 |
| C | 1.25E−04 | 2.10E−04 | −6.78E−04 | 3.00E−04 | 2.31E−05 | −6.48E−04 |
| D | −2.04E−05 | −4.07E−05 | 3.86E−04 | −8.00E−05 | −2.31E−03 | 8.27E−04 |
| E | 2.19E−06 | 5.17E−06 | −1.30E−04 | 2.25E−05 | 0.00E+00 | −5.45E−04 |
| F | −1.52E−07 | −4.32E−07 | 2.67E−05 | −4.82E−06 | 0.00E+00 | 2.00E−04 |
| G | 6.70E−09 | 2.31E−08 | −3.31E−06 | 6.57E−07 | 0.00E+00 | −4.18E−05 |
| H | −1.70E−10 | −7.16E−10 | 2.28E−07 | −5.02E−08 | 0.00E+00 | 4.63E−06 |
| J | 1.90E−12 | 9.78E−12 | −6.75E−09 | 1.60E−09 | 0.00E+00 | −2.11E−07 |
| Surface | 11 | 12 | 13 | 14 | 15 | 16 |
| K | −9.90E+01 | 8.17E+01 | −6.88E+01 | −1.87E+00 | −1.53E−05 | −1.47E+00 |
| A | −3.13E−03 | 4.21E−03 | 5.80E−03 | 6.37E−03 | −6.31E−03 | −1.57E−02 |
| B | 1.26E−05 | −7.47E−05 | 1.85E−03 | 2.41E−03 | −8.32E−04 | 1.44E−03 |
| C | 1.97E−04 | −1.56E−04 | −1.86E−03 | −3.26E−03 | 3.33E−03 | 5.02E−04 |
| D | −5.08E−05 | −1.44E−05 | 4.92E−04 | 1.31E−03 | −6.61E−03 | −1.41E−03 |
| E | −3.82E−06 | 1.14E−06 | −6.48E−05 | −3.02E−04 | 5.19E−03 | 9.74E−04 |
| F | 5.34E−07 | 2.00E−07 | 4.86E−06 | 4.34E−05 | −1.93E−03 | −2.71E−04 |
| G | 6.98E−09 | −1.81E−08 | −2.13E−07 | −3.76E−06 | 1.11E−04 | −1.95E−05 |
| H | 1.09E−09 | 2.06E−11 | 5.14E−09 | 1.77E−07 | 2.24E−04 | 4.09E−05 |
| J | 2.67E−13 | −5.40E−11 | −5.29E−11 | −3.47E−09 | −1.14E−04 | −1.51E−05 |

### Eleventh Embodiment

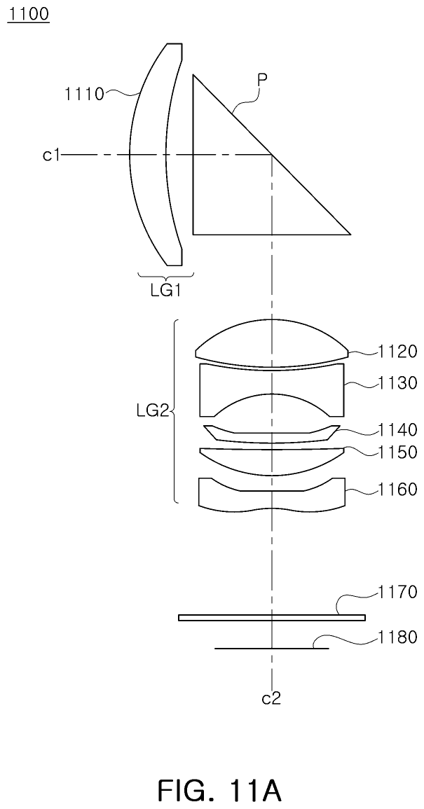

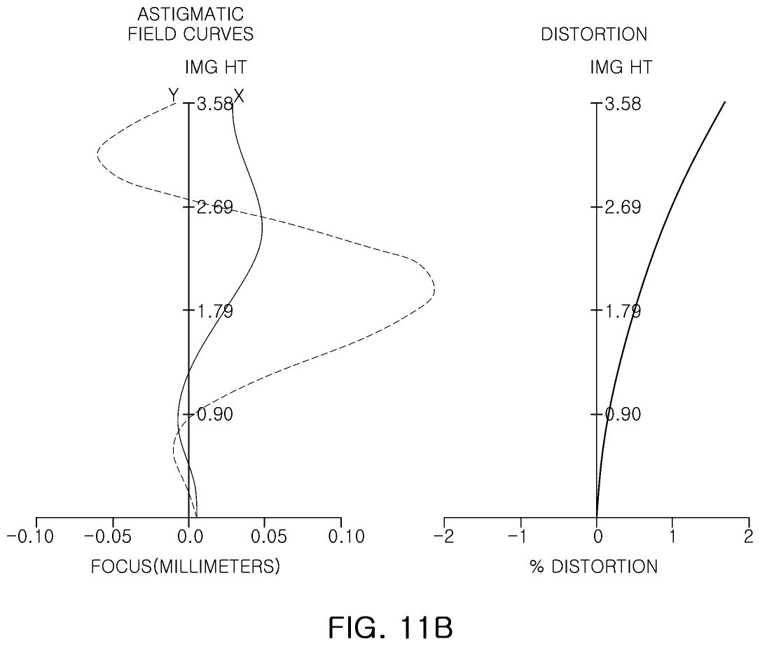

FIG. 11A is a block diagram of an optical imaging system according to an eleventh embodiment of the present disclosure, and FIG. 11B is a graph illustrating aberration characteristics of an optical imaging system according to the eleventh embodiment of the present disclosure.

An optical imaging system 1100 according to the eleventh embodiment may include a first lens 1110, a second lens 1120, a third lens 1130, a fourth lens 1140, a fifth lens 1150, and a sixth lens 1160 arranged in order from an object side toward an image side, and may further include an infrared cut-off filter 1170 and an image sensor 1180 disposed on an image side of the sixth lens 1160.

The first lens 1110 may have positive refractive power. An object-side surface of the first lens 1110 may have a convex shape in the paraxial region, and an image-side surface of the first lens 1110 may have a concave shape in the paraxial region, that is, a meniscus shape convex toward the object side. The first lens 1110 may be formed of plastic. The first lens 1110 may be an aspherical lens. For example, the object-side surface and the image-side surface of the first lens 1110 may be aspherical.

The second lens 1120 may have positive refractive power. An object-side surface and an image-side surface of the second lens 1120 may have a convex shape in the paraxial region. The second lens 1120 may be formed of plastic. The second lens 1120 may be an aspherical lens. For example, the object-side surface and the image-side surface of the second lens 1120 may be aspherical.

The third lens 1130 may have negative refractive power. An object-side surface and an image-side surface of the third lens 1130 may have a concave shape in the paraxial region. The third lens 1130 may be formed of plastic. In detail, the third lens 1130 may be formed of a plastic material with optical properties (e.g., refractive index and Abbe number) different from the second lens 1120. The third lens 1130 may be an aspherical lens. For example, the object-side surface and the image-side surface of the third lens 1130 may be aspherical.

The fourth lens 1140 may have positive refractive power. An object-side surface of the fourth lens 1140 may have a concave shape in the paraxial region, and an image-side surface of the fourth lens 1140 may have a convex shape in the paraxial region. The fourth lens 1140 may be formed of plastic. In detail, the fourth lens 1140 may be formed of a plastic material with optical properties (e.g., refractive index and Abbe number) different from the third lens 1130. The fourth lens 1140 may be an aspherical lens. For example, the object-side surface and the image-side surface of the fourth lens 1140 may be aspherical.

The fifth lens 1150 may have positive refractive power. The object-side surface of the fifth lens 1150 may be concave in the paraxial region, and the image-side surface of the fifth lens 1150 may be convex in the paraxial region. The fifth lens 1150 may be formed of plastic. In detail, fifth lens 1150 may be formed of a plastic material with optical properties (e.g., refractive index and Abbe number) different from the fourth lens 1140. The fifth lens 1150 may be an aspherical lens. For example, the object-side surface and the image-side surface of the fifth lens 1150 may be aspherical.

The sixth lens 1160 may have negative refractive power. An object-side surface and an image-side surface of the sixth lens 1160 may have a concave shape in the paraxial region. The sixth lens 1160 may be formed of plastic. In detail, the sixth lens 1160 may be formed of a plastic material with optical properties (e.g., refractive index and Abbe number) different from the fifth lens 1150. The sixth lens 1160 may be an aspherical lens. For example, the object-side surface and the image-side surface of the sixth lens 1160 may be aspherical.

A prism P may be disposed between the first lens 1110 and the second lens 1120. The first lens 1110 disposed on the object side with respect to the prism P may constitute a first lens group LG1, and the second to sixth lenses 1120 to 1160 disposed on the image side with respect to the prism P may constitute a second lens group LG2. Both the first lens group LG1 and the second lens group LG2 may have positive refractive power.

Table 21 illustrates optical and physical parameters of the optical imaging system 1100 according to the eleventh embodiment of the present disclosure.

TABLE 21

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.196 | 1.300 | 1.536 | 55.7 | 4.04 |
| 3 | 14.126 | 1.150 | | | 3.53 |
| 4 | Infinity | 3.200 | 1.931 | 20.9 | 2.90 |
| 5 | Infinity | 3.200 | 1.931 | 20.9 | 4.24 |
| 6 | Infinity | 3.300 | | | 2.90 |
| 7 | 4.101 | 1.926 | 1.536 | 55.7 | 2.80 |
| 8 | −11.592 | 0.148 | | | 2.71 |
| 9 | −11.579 | 0.943 | 1.619 | 25.9 | 2.66 |
| 10 | 4.015 | 1.526 | | | 2.40 |
| 11 | −60.135 | 0.400 | 1.546 | 56.3 | 2.37 |
| 12 | −26.286 | 0.218 | | | 2.53 |
| 13 | −18.743 | 1.062 | 1.667 | 20.4 | 2.62 |
| 14 | −4.196 | 0.670 | | | 2.65 |
| 15 | −42.827 | 0.653 | 1.644 | 23.5 | 2.47 |
| 16 | 6.806 | 4.300 | | | 2.70 |
| 17 | Infinity | 0.210 | 1.518 | 64.2 | 3.37 |
| 18 | Infinity | 1.045 | | | 3.39 |
| Image | Infinity | | | | 3.59 |

Table 22 illustrates aspheric data of the optical imaging system 1100 according to the eleventh embodiment of the present disclosure.

TABLE 22

| Surface | 2 | 3 | 7 | 8 | 9 | 10 |
|---|---|---|---|---|---|---|
| K | −9.05E+00 | 4.80E+00 | 8.19E−01 | −8.51E−011 | 3.05E+00 | −9.81E−01 |
| A | 2.39E−03 | 1.03E−03 | −9.18E−04 | 6.59E−03 | −3.07E−04 | −5.16E−03 |
| B | −3.08E−04 | −3.41E−04 | 5.48E−04 | −1.57E−03 | 2.03E−04 | 1.09E−03 |
| C | 6.31E−05 | 8.24E−05 | −7.70E−04 | 3.50E−04 | 2.36E−05 | 4.78E−04 |
| D | −8.25E−06 | −1.09E−05 | 4.37E−04 | −1.01E−04 | −2.29E−06 | 7.95E−05 |
| E | 6.60E−07 | 7.78E−07 | −1.47E−04 | 3.05E−05 | 0.00E+00 | −2.53E−04 |
| F | −3.00E−08 | −2.20E−08 | 3.02E−05 | −6.65E−06 | 0.00E+00 | 1.31E−04 |
| G | 6.45E−10 | −4.77E−10 | −3.75E−06 | 9.00E−07 | 0.00E+00 | −3.24E−05 |
| H | −1.37E−12 | 4.32E−11 | 2.58E−07 | −6.78E−08 | 0.00E+00 | 3.99E−06 |
| J | −1.16E−13 | −6.86E−13 | −7.64E−09 | 2.13E−09 | 0.00E+00 | −1.96E−07 |
| Surface | 11 | 12 | 13 | 14 | 15 | 16 |
| K | −9.55E+01 | 8.74E+01 | −7.38E+01 | −1.86E+00 | −9.72E−13 | −1.49E+00 |
| A | −3.61E−03 | 4.28E−03 | 5.98E−03 | 6.59E−03 | −4.61E−03 | −1.37E−02 |
| B | −3.15E−05 | −9.12E−05 | 1.12E−03 | 1.69E−03 | −3.82E−03 | −1.19E−03 |
| C | 1.95E−04 | −1.61E−04 | −1.24E−03 | −2.73E−03 | 5.50E−03 | 4.99E−04 |
| D | −5.14E−05 | −1.53E−05 | 2.98E−04 | 1.16E−03 | −9.18E−03 | 1.21E−03 |
| E | −3.97E−06 | 1.04E−06 | −3.38E−05 | −2.82E−04 | 9.05E−03 | −1.92E−03 |
| F | 4.98E−07 | 1.89E−07 | 2.10E−06 | 4.23E−05 | −5.62E−03 | 1.46E−03 |
| G | 3.67E−10 | −1.86E−08 | −7.26E−08 | −3.79E−06 | 2.33E−03 | −6.96E−04 |
| H | 1.92E−10 | 5.58E−11 | 1.30E−09 | 1.83E−07 | −6.62E−04 | 2.25E−04 |
| J | −2.47E−17 | −4.45E−11 | −9.42E−12 | −3.66E−09 | 1.30E−04 | −5.04E−05 |

### Twelfth Embodiment

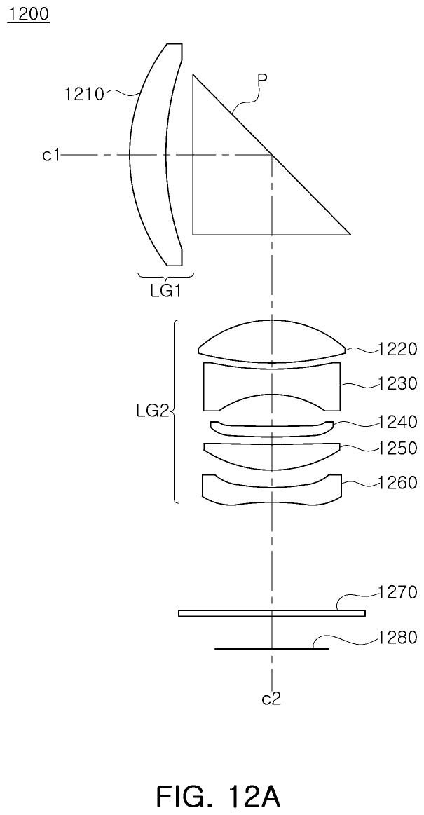

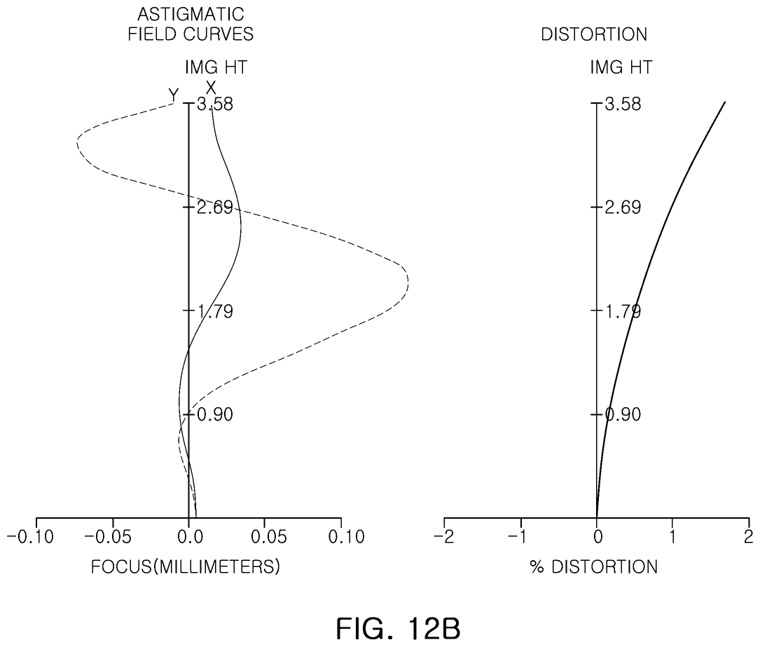

FIG. 12A is a block diagram of an optical imaging system according to a twelfth embodiment of the present disclosure, and FIG. 12B is a graph illustrating aberration characteristics of an optical imaging system according to the twelfth embodiment of the present disclosure.

An optical imaging system 1200 according to the twelfth embodiment may include a first lens 1210, a second lens 1220, a third lens 1230, a fourth lens 1240, a fifth lens 1250 and a sixth lens 1260 arranged in order from an object side toward an image side, and may further include an infrared cut-off filter 1270 and an image sensor 1280 disposed on an image side of the sixth lens 1260.

The first lens 1210 may have positive refractive power. An object-side surface of the first lens 1210 may have a convex shape in the paraxial region, and an image-side surface of the first lens 1210 may have a concave shape in the paraxial region, that is, a meniscus shape convex toward the object side. The first lens 1210 may be formed of plastic. The first lens 1210 may be an aspherical lens. For example, the object-side surface and the image-side surface of the first lens 1210 may be aspherical.

The second lens 1220 may have positive refractive power. An object-side surface and an image-side surface of the second lens 1220 may have a convex shape in the paraxial region. The second lens 1220 may be formed of plastic. The second lens 1220 may be an aspherical lens. For example, the object-side surface and the image-side surface of the second lens 1220 may be aspherical.

The third lens 1230 may have negative refractive power. An object-side surface and an image-side surface of the third lens 1230 may have a concave shape in the paraxial region. The third lens 1230 may be formed of plastic. In detail, the third lens 1230 may be formed of a plastic material with optical properties (e.g., refractive index and Abbe number) different from the second lens 1220. The third lens 1230 may be an aspherical lens. For example, the object-side surface and the image-side surface of the third lens 1230 may be aspherical.

The fourth lens 1240 may have positive refractive power. An object-side surface of the fourth lens 1240 may have a concave shape in the paraxial region, and the image-side surface of the fourth lens 1240 may have a convex shape in the paraxial region. The fourth lens 1240 may be formed of plastic. In detail, the fourth lens 1240 may be formed of a plastic material with optical properties (e.g., refractive index and Abbe number) different from the third lens 1230. The fourth lens 1240 may be an aspherical lens. For example, the object-side surface and the image-side surface of the fourth lens 1240 may be aspherical.

The fifth lens 1250 may have positive refractive power. An object-side surface of the fifth lens 1250 may have a concave shape in the paraxial region, and an image-side surface of the fifth lens 1250 may have a convex shape in the paraxial region. The fifth lens 1250 may be formed of plastic. In detail, the fifth lens 1250 may be formed of a plastic material with optical properties (e.g., refractive index and Abbe number) different from the fourth lens 1240. The fifth lens 1250 may be an aspherical lens. For example, the object-side surface and the image-side surface of the fifth lens 1250 may be aspherical.

The sixth lens 1260 may have negative refractive power. The object-side surface and the image-side surface of the sixth lens 1260 may have a concave shape in the paraxial region. The sixth lens 1260 may be formed of plastic. In detail, the sixth lens 1260 may be formed of a plastic material with optical properties (e.g., refractive index and Abbe number) different from the fifth lens 1250. The sixth lens 1260 may be an aspherical lens. For example, the object-side surface and the image-side surface of the sixth lens 1260 may be aspherical.

A prism P may be disposed between the first lens 1210 and the second lens 1220. The first lens 1210 disposed on the object side based on the prism P may constitute a first lens group LG1, and the second to sixth lenses 1220 to 1260 disposed on the image side based on the prism P may constitute a second lens group LG2. Both the first lens group LG1 and the second lens group LG2 may have positive refractive power.

Table 23 illustrates optical and physical parameters of the optical imaging system 1200 according to the twelfth embodiment of the present disclosure.

TABLE 23

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.031 | 1.300 | 1.536 | 55.7 | 4.04 |
| 3 | 13.700 | 1.150 | | | 3.79 |
| 4 | Infinity | 3.200 | 1.931 | 20.9 | 2.90 |
| 5 | Infinity | 3.200 | 1.931 | 20.9 | 4.24 |
| 6 | Infinity | 3.300 | | | 2.90 |
| 7 | 4.063 | 1.772 | 1.536 | 55.7 | 2.72 |
| 8 | −12.725 | 0.183 | | | 2.62 |
| 9 | −11.760 | 1.004 | 1.619 | 25.9 | 2.56 |
| 10 | 3.852 | 1.301 | | | 2.16 |
| 11 | −363.164 | 0.400 | 1.546 | 56.3 | 2.26 |
| 12 | −25.189 | 0.312 | | | 2.39 |
| 13 | −21.183 | 1.036 | 1.667 | 20.4 | 2.48 |
| 14 | −4.177 | 0.637 | | | 2.52 |
| 15 | −20.603 | 0.618 | 1.644 | 23.5 | 2.36 |
| 16 | 7.933 | 4.300 | | | 2.58 |
| 17 | Infinity | 0.210 | 1.518 | 64.2 | 3.32 |
| 18 | Infinity | 1.327 | | | 3.34 |
| Image | Infinity | | | | 3.59 |

Table 24 illustrates aspheric data of the optical imaging system 1200 according to the twelfth embodiment of the present disclosure.

TABLE 24

| Surface | 2 | 3 | 7 | 8 | 9 | 10 |
|---|---|---|---|---|---|---|
| K | −8.93E+00 | 4.56E+00 | 8.60E−01 | −1.16E+00 | 3.28E+00 | −1.03E+00 |
| A | 2.22E−03 | 7.58E−04 | −8.32E−04 | 6.88E−03 | −3.34E−04 | −6.58E−03 |
| B | −1.60E−04 | −1.39E−04 | 5.38E−04 | −1.74E−03 | 2.05E−04 | 2.15E−03 |
| C | 7.74E−06 | −5.02E−06 | −8.26E−04 | 4.56E−04 | 2.36E−05 | 8.56E−05 |
| D | 3.66E−06 | 1.14E−05 | 4.90E−04 | −1.51E−04 | −2.42E−06 | 8.93E−06 |
| E | −8.91E−07 | −2.70E−06 | −1.72E−04 | 4.60E−05 | 0.00E+00 | −9.91E−05 |
| F | 9.41E−08 | 3.12E−07 | 3.68E−05 | −9.91E−06 | 0.00E+00 | 6.20E−05 |
| G | −5.32E−09 | −1.98E−08 | −4.75E−06 | 1.34E−06 | 0.00E+00 | −1.75E−05 |
| H | 1.57E−10 | 6.61E−10 | 3.43E−07 | −1.02E−07 | 0.00E+00 | 2.41E−06 |
| J | −1.89E−12 | −9.09E−12 | −1.07E−08 | 3.26E−09 | 0.00E+00 | −1.30E−07 |
| Surface | 11 | 12 | 13 | 14 | 15 | 16 |
| K | −4.12E+01 | 9.54E+01 | −8.96E+01 | −1.78E+00 | 0.00E+00 | −1.12E+00 |
| A | −3.87E−03 | 4.56E−03 | 4.91E−03 | 5.87E−03 | −6.52E−03 | −1.52E−02 |
| B | −1.01E−05 | −1.04E−04 | 1.75E−03 | 1.13E−03 | −1.38E−03 | 8.01E−04 |
| C | 1.98E−04 | −1.67E−04 | −1.19E−03 | −1.68E−03 | 5.59E−05 | −3.32E−05 |
| D | −5.19E−05 | −1.60E−05 | 2.19E−04 | 6.50E−04 | 1.49E−05 | 1.82E−06 |
| E | −4.29E−06 | 8.98E−07 | −1.52E−05 | −1.57E−04 | −1.36E−06 | −8.00E−08 |
| F | 4.17E−07 | 1.73E−07 | 4.63E−09 | 2.49E−05 | 0.00E+00 | 0.00E+00 |
| G | 1.02E−16 | −1.96E−08 | 5.37E−08 | −2.38E−06 | 0.00E+00 | 0.00E+00 |
| H | 1.46E−18 | −1.45E−18 | −2.62E−09 | 1.23E−07 | 0.00E+00 | 0.00E+00 |
| J | 3.14E−20 | −1.90E−20 | 4.01E−11 | −2.58E−09 | 0.00E+00 | 0.00E+00 |

### Thirteenth Embodiment

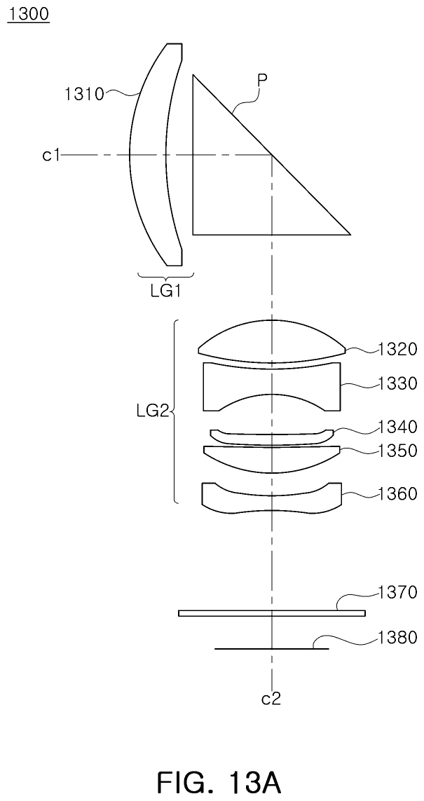

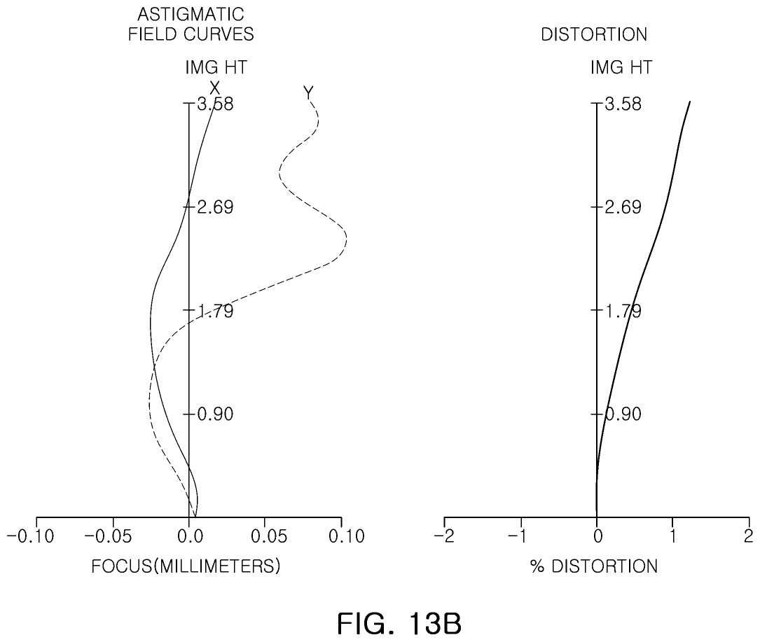

FIG. 13A is a block diagram of an optical imaging system according to a thirteenth embodiment of the present disclosure, and FIG. 13B is a graph illustrating aberration characteristics of an optical imaging system according to the thirteenth embodiment of the present disclosure.

An imaging optical system 1300 according to the thirteenth embodiment may include a first lens 1310, a second lens 1320, a third lens 1330, a fourth lens 1340, a fifth lens 1350 and a sixth lens 1360 arranged in order from an object side toward an image side, and may further include an infrared cut-off filter 1370 and an image sensor 1380 disposed on an image side of the sixth lens 1360.

The first lens 1310 may have positive refractive power. An object-side surface of the first lens 1310 may have a convex shape in the paraxial region, and an image-side surface of the first lens 1310 may have a concave shape in the paraxial region, that is, a meniscus shape convex toward the object side. The first lens 1310 may be formed of plastic. The first lens 1310 may be an aspherical lens. For example, the object-side surface and the image-side surface of the first lens 1310 may be aspherical.

The second lens 1320 may have positive refractive power. An object-side surface and an image-side surface of the second lens 1320 may have a convex shape in the paraxial region. The second lens 1320 may be formed of plastic. The second lens 1320 may be an aspherical lens. For example, the object-side surface and the image-side surface of the second lens 1320 may be aspherical.

The third lens 1330 may have negative refractive power. An object-side surface and an image-side surface of the third lens 1330 may have a concave shape in the paraxial region. The third lens 1330 may be formed of plastic. In detail, the third lens 1330 may be formed of a plastic material with optical properties (e.g., refractive index and Abbe number) different from the second lens 1320. The third lens 1330 may be an aspherical lens. For example, the object-side surface and the image-side surface of the third lens 1330 may be aspherical.

The fourth lens 1340 may have positive refractive power. An object-side surface of the fourth lens 1340 may be concave in the paraxial region, and an image-side surface of the fourth lens 1340 may be convex in the paraxial region. The fourth lens 1340 may be formed of plastic. In detail, the fourth lens 1340 may be formed of a plastic material with optical properties (e.g., refractive index and Abbe number) different from the third lens 1330. The fourth lens 1340 may be an aspherical lens. For example, the object-side surface and the image-side surface of the fourth lens 1340 may be aspherical.

The fifth lens 1350 may have positive refractive power. An object-side surface of the fifth lens 1350 may have a concave shape in the paraxial region, and the image-side surface of the fifth lens 1350 may have a convex shape in the paraxial region. The fifth lens 1350 may be formed of plastic. In detail, the fifth lens 1350 may be formed of a plastic material with optical properties (e.g., refractive index and Abbe number) different from the fourth lens 1340. The fifth lens 1350 may be an aspherical lens. For example, the object-side surface and the image-side surface of the fifth lens 1350 may be aspherical.

The sixth lens 1360 may have negative refractive power. An object-side surface and an image-side surface of the sixth lens 1360 may have a concave shape in the paraxial region. The sixth lens 1360 may be formed of plastic. In detail, the sixth lens 1360 may be formed of a plastic material with optical properties (e.g., refractive index and Abbe number) different from the fifth lens 1350. The sixth lens 1360 may be an aspherical lens. For example, the object-side surface and the image-side surface of the sixth lens 1360 may be aspherical.

A prism P may be disposed between the first lens 1310 and the second lens 1320. The first lens 1310 disposed on the object side with respect to the prism P may constitute a first lens group LG1, and the second to sixth lenses 1320 to 1360 disposed on the image side with respect to the prism P may constitute a second lens group LG2. Both the first lens group LG1 and the second lens group LG2 may have positive refractive power.

Table 25 illustrates optical and physical parameters of the optical imaging system 1300 according to the thirteenth embodiment of the present disclosure.

TABLE 25

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 9.041 | 1.300 | 1.536 | 55.7 | 3.86 |
| 3 | 13.746 | 1.150 | | | 3.57 |
| 4 | Infinity | 3.200 | 1.931 | 20.9 | 2.90 |
| 5 | Infinity | 3.200 | 1.931 | 20.9 | 4.24 |
| 6 | Infinity | 3.300 | | | 2.90 |
| 7 | 4.109 | 1.981 | 1.536 | 55.7 | 2.83 |
| 8 | −11.432 | 0.100 | | | 2.74 |
| 9 | −11.616 | 0.896 | 1.619 | 25.9 | 2.70 |
| 10 | 4.165 | 1.681 | | | 2.40 |
| 11 | −41.234 | 0.400 | 1.546 | 56.3 | 2.44 |
| 12 | −26.956 | 0.108 | | | 2.59 |
| 13 | −17.051 | 1.065 | 1.667 | 20.4 | 2.65 |
| 14 | −4.103 | 0.753 | | | 2.69 |
| 15 | −44.177 | 0.660 | 1.644 | 23.5 | 2.47 |
| 16 | 6.624 | 4.234 | | | 2.70 |
| 17 | Infinity | 0.210 | 1.518 | 64.2 | 3.40 |
| 18 | Infinity | 1.011 | | | 3.42 |
| Image | Infinity | | | | 3.60 |

Table 26 illustrates aspheric data of the optical imaging system 1300 according to the thirteenth embodiment of the present disclosure.

TABLE 26

| Surface | 2 | 3 | 7 | 8 | 9 | 10 |
|---|---|---|---|---|---|---|
| K | −8.63E+00 | 5.01E+00 | 7.95E−01 | −3.37E−02 | 3.42E+00 | −9.31E−01 |
| A | 2.51E−03 | 1.19E−03 | −8.82E−04 | 6.01E−03 | −3.43E−04 | −3.76E−03 |
| B | −4.07E−04 | −5.35E−04 | 4.10E−04 | −1.25E−03 | 1.95E−04 | 3.08E−04 |
| C | 1.07E−04 | 1.84E−04 | −6.22E−04 | 2.16E−04 | 2.30E−05 | 8.60E−04 |
| D | −1.89E−05 | −4.00E−05 | 3.57E−04 | −4.93E−05 | −2.32E−06 | −1.74E−04 |
| E | 2.22E−06 | 5.84E−06 | −1.21E−04 | 1.40E−05 | 0.00E+00 | −1.17E−04 |
| F | −1.72E−07 | −5.65E−07 | 2.49E−05 | −3.17E−06 | 0.00E+00 | 8.35E−05 |
| G | 8.56E−09 | 3.48E−08 | −3.09E−06 | 4.54E−07 | 0.00E+00 | −2.22E−05 |
| H | −2.46E−10 | −1.23E−09 | 2.12E−07 | −3.65E−08 | 0.00E+00 | 2.78E−06 |
| J | 3.13E−12 | 1.88E−11 | −6.26E−09 | 1.21E−09 | 0.00E+00 | −1.37E−07 |
| Surface | 11 | 12 | 13 | 14 | 15 | 16 |
| K | −9.90E+01 | 7.90E+01 | −6.21E+01 | −1.89E+00 | −1.53E−05 | −1.74E+00 |
| A | −2.97E−03 | 4.06E−03 | 6.51E−03 | 8.11E−03 | −2.71E−03 | −1.34E−02 |
| B | −6.88E−06 | −6.93E−05 | 9.63E−04 | 8.17E−04 | −6.44E−03 | −1.59E−03 |
| C | 1.93E−04 | −1.55E−04 | −1.53E−03 | −2.56E−03 | 9.81E−03 | 1.69E−03 |
| D | −5.10E−05 | −1.42E−05 | 4.29E−04 | 1.11E−03 | −1.47E−02 | −1.03E−03 |
| E | −3.83E−06 | 1.17E−06 | −5.74E−05 | −2.61E−04 | 1.37E−02 | 3.36E−04 |
| F | 5.49E−07 | 2.06E−07 | 4.35E−06 | 3.74E−05 | −.23E−03 | 3.68E−05 |
| G | 1.01E−08 | −1.88E−08 | −1.91E−07 | −3.21E−06 | 3.37E−03 | −8.96E−05 |
| H | 8.85E−10 | −8.30E−11 | 4.62E−09 | 1.49E−07 | −9.62E−04 | 4.38E−05 |
| J | 2.62E−13 | −4.18E−12 | −4.74E−11 | −2.86E−09 | 1.92E−04 | −1.23E−05 |

### Fourteenth Embodiment

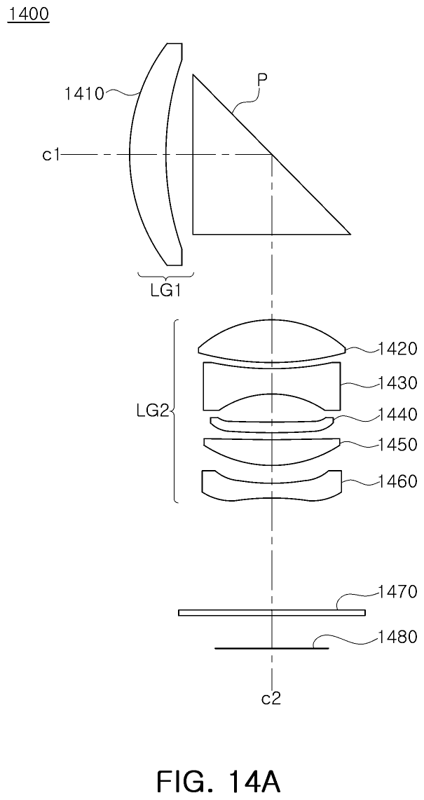

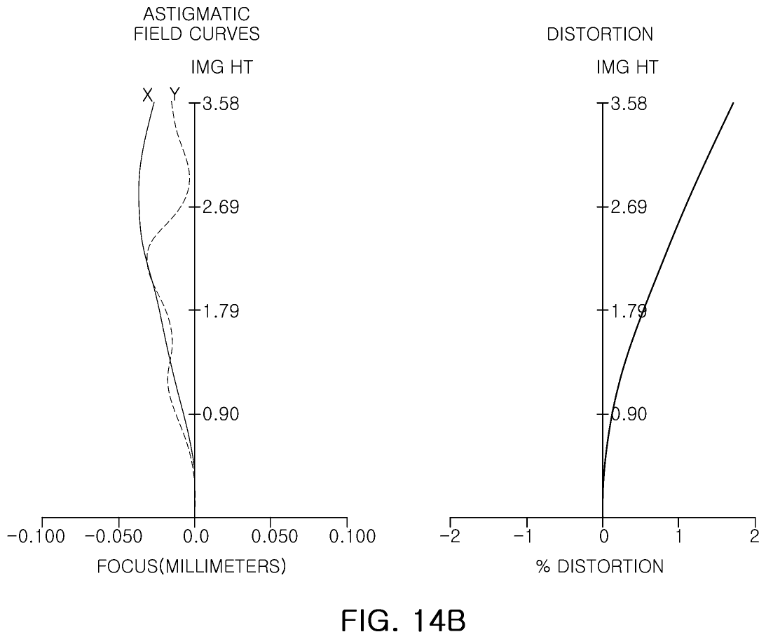

FIG. 14A is a block diagram of an optical imaging system according to a fourteenth embodiment of the present disclosure, and FIG. 14B is a graph illustrating aberration characteristics of an optical imaging system according to the fourteenth embodiment of the present disclosure.

An imaging optical system 1400 according to the fourteenth embodiment may include a first lens 1410, a second lens 1420, a third lens 1430, a fourth lens 1440, a fifth lens 1450, and a sixth lens 1460 arranged in order from an object side toward an image side, and may further include an infrared cut-off filter 1470 and an image sensor 1480 disposed on an image side of the sixth lens 1460.

The first lens 1410 may have positive refractive power. An object-side surface of the first lens 1410 may have a convex shape in the paraxial region, and an image-side surface of the first lens 1410 may have a concave shape in the paraxial region, that is, a meniscus shape convex toward the object side. The first lens 1410 may be formed of plastic. The first lens 1410 may be an aspherical lens. For example, the object-side surface and the image-side surface of the first lens 1410 may be aspherical.

The second lens 1420 may have positive refractive power. An object-side surface and an image-side surface of the second lens 1420 may have a convex shape in the paraxial region. The second lens 1420 may be formed of plastic. The second lens 1420 may be an aspherical lens. For example, the object-side surface and the image-side surface of the second lens 1420 may be aspherical.

The third lens 1430 may have negative refractive power. An object-side surface and an image-side surface of the third lens 1430 may have a concave shape in the paraxial region. The third lens 1430 may be formed of plastic. In detail, the third lens 1430 may be formed of a plastic material with optical properties (e.g., refractive index and Abbe number) different from the second lens 1420. The third lens 1430 may be an aspherical lens. For example, the object-side surface and the image-side surface of the third lens 1430 may be aspherical.

The fourth lens 1440 may have negative refractive power. An object-side surface of the fourth lens 1440 may have a concave shape in the paraxial region, and an image-side surface of the fourth lens 1440 may have a convex shape in the paraxial region. The fourth lens 1440 may be formed of plastic. In detail, the fourth lens 1440 may be formed of a plastic material with optical properties (e.g., refractive index and Abbe number) different from the third lens 1430. The fourth lens 1440 may be an aspherical lens. For example, the object-side surface and the image-side surface of the fourth lens 1440 may be aspherical.

The fifth lens 1450 may have positive refractive power. An object-side surface and an image-side surface of the fifth lens 1450 may have a convex shape in the paraxial region. The fifth lens 1450 may be formed of plastic. In detail, the fifth lens 1450 may be formed of a plastic material with optical properties (e.g., refractive index and Abbe number) different from the fourth lens 1440. The fifth lens 1450 may be an aspherical lens. For example, the object-side surface and the image-side surface of the fifth lens 1450 may be aspherical.

The sixth lens 1460 may have negative refractive power. An object-side surface and an image-side surface of the sixth lens 1460 may have a concave shape in the paraxial region. The sixth lens 1460 may be formed of plastic. In detail, the sixth lens 1460 may be formed of a plastic material with optical properties (e.g., refractive index and Abbe number) different from the fifth lens 1450. The sixth lens 1460 may be an aspherical lens. For example, the object-side surface and the image-side surface of the sixth lens 1460 may be aspherical.

A prism P may be disposed between the first lens 1410 and the second lens 1420. The first lens 1410 disposed on the object side with respect to the prism P may constitute a first lens group LG1, and the second to sixth lenses 1420 to 1460 disposed on the image side with respect to the prism P may constitute a second lens group LG2. Both the first lens group LG1 and the second lens group LG2 may have positive refractive power.

Table 27 illustrates optical and physical parameters of the optical imaging system 1400 according to the fourteenth embodiment of the present disclosure.

TABLE 27

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 8.496 | 1.300 | 1.5356 | 55.7 | 4.04 |
| 3 | 12.406 | 1.150 | | | 3.79 |
| 4 | Infinity | 3.200 | 1.931 | 20.9 | 2.90 |
| 5 | Infinity | 3.200 | 1.931 | 20.9 | 4.24 |
| 6 | Infinity | 3.300 | | | 2.90 |
| 7 | 4.053 | 1.851 | 1.536 | 55.7 | 2.72 |
| 8 | −7.029 | 0.102 | | | 2.62 |
| 9 | −7.074 | 1.094 | 1.619 | 25.9 | 2.56 |
| 10 | 3.703 | 0.898 | | | 2.16 |
| 11 | −15.212 | 0.400 | 1.546 | 56.3 | 2.26 |
| 12 | −17.684 | 0.100 | | | 2.39 |
| 13 | 324.547 | 1.199 | 1.667 | 20.4 | 2.48 |
| 14 | −4.011 | 0.562 | | | 2.52 |
| 15 | −10.923 | 0.694 | 1.644 | 23.5 | 2.36 |
| 16 | 10.490 | 4.300 | | | 2.58 |
| 17 | Infinity | 0.110 | 1.518 | 64.2 | 3.40 |
| 18 | Infinity | 1.711 | | | 3.42 |
| Image | Infinity | | | | 3.60 |

Table 28 illustrates aspheric data of the optical imaging system 1400 according to the fourteenth embodiment of the present disclosure.

TABLE 28

| Surface | 2 | 3 | 7 | 8 | 9 | 10 |
|---|---|---|---|---|---|---|
| K | −7.86E+00 | 4.94E+00 | 1.05E+00 | 6.25E−01 | 2.42E+00 | −1.66E+00 |
| A | 2.06E−03 | 3.54E−04 | −5.96E−04 | 9.83E−03 | −2.03E−04 | −9.40E−03 |
| B | −6.50E−05 | −3.77E−05 | −4.46E−04 | −4.10E−03 | 1.67E−04 | 2.62E−03 |
| C | 3.88E−06 | 1.76E−05 | 3.80E−06 | 1.61E−03 | 2.64E−05 | 2.18E−03 |
| D | 1.30E−06 | −2.53E−06 | 7.66E−05 | −5.68E−04 | 1.46E−06 | −2.94E−03 |
| E | −4.13E−07 | −4.14E−09 | −5.21E−05 | 1.57E−04 | 0.00E+00 | 1.78E−03 |
| F | 5.62E−08 | 5.09E−08 | 1.63E−05 | −3.11E−05 | 0.00E+00 | −6.25E−04 |
| G | −4.05E−09 | −6.67E−09 | −2.87E−06 | 4.08E−06 | 0.00E+00 | 1.30E−04 |
| H | 1.52E−10 | 3.63E−10 | 2.70E−07 | −3.15E−07 | 0.00E+00 | −1.50E−05 |
| J | −2.31E−12 | −7.45E−12 | −1.08E−08 | 1.06E−08 | 0.00E+00 | 7.34E−07 |
| Surface | 11 | 12 | 13 | 14 | 15 | 16 |
| K | 4.70E+01 | 3.72E+01 | −9.90E+01 | −1.71E+00 | 0.00E+00 | 4.66E+00 |
| A | −3.70E−03 | 3.25E−03 | 3.33E−03 | 5.61E−03 | −4.64E−03 | −1.36E−02 |
| B | −1.84E−05 | 4.47E−05 | 1.38E−03 | −9.29E−04 | −1.22E−03 | 6.91E−04 |
| C | 1.93E−04 | −1.37E−04 | −7.34E−04 | 4.15E−06 | 3.52E−06 | −3.94E−05 |
| D | −5.14E−05 | −1.69E−05 | 4.89E−05 | −4.51E−05 | 8.80E−06 | 9.38E−07 |
| E | −3.64E−06 | 0.00E+00 | 1.99E−05 | 9.05E−06 | −1.91E−07 | 6.00E−08 |
| F | 0.00E+00 | 0.00E+00 | −4.18E−06 | 6.62E−07 | 0.00E+00 | 0.00E+00 |
| G | 0.00E+00 | 0.00E+00 | 3.35E−07 | −2.54E−07 | 0.00E+00 | 0.00E+00 |
| H | 0.00E+00 | 0.00E+00 | −1.26E−08 | 1.93E−08 | 0.00E+00 | 0.00E+00 |
| J | 0.00E+00 | 0.00E+00 | 1.82E−10 | −4.71E−10 | 0.00E+00 | 0.00E+00 |

### Fifteenth Embodiment

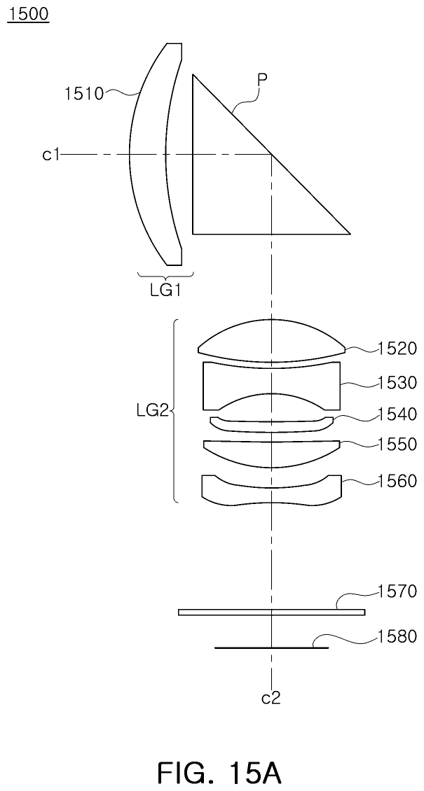

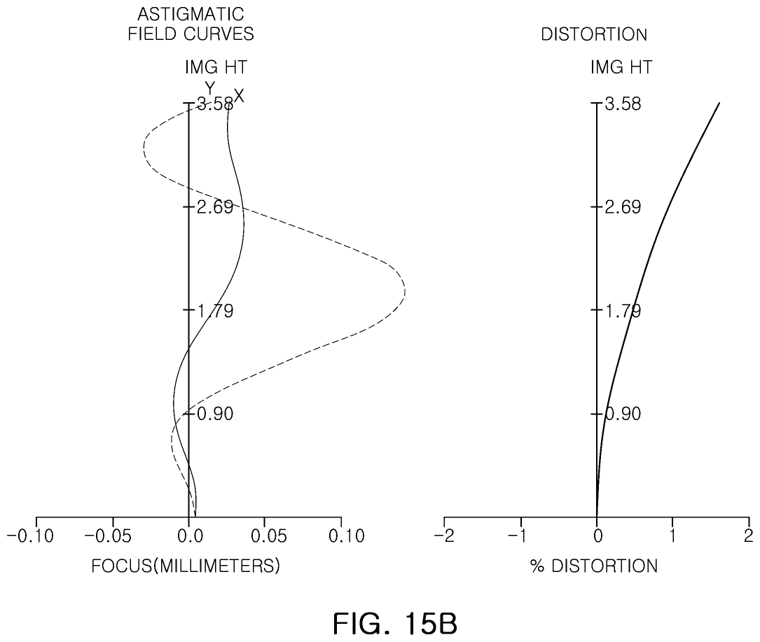

FIG. 15A is a block diagram of an optical imaging system according to a fifteenth embodiment of the present disclosure, and FIG. 15B is a graph illustrating aberration characteristics of an optical imaging system according to the fifteenth embodiment of the present disclosure.

An imaging optical system 1500 according to the fifteenth embodiment may include a first lens 1510, a second lens 1520, a third lens 1530, a fourth lens 1540, a fifth lens 1550, and a sixth lens 1560 arranged in order from an object side toward an image side, and may further include an infrared cut-off filter 1570 and an image sensor 1580 disposed on an image side of the sixth lens 1560.

The first lens 1510 may have positive refractive power. An object-side surface of the first lens 1510 may have a convex shape in the paraxial region, and an image-side surface of the first lens 1510 may have a concave shape in the paraxial region, that is, a meniscus shape convex toward the object side. The first lens 1510 may be formed of plastic. The first lens 1510 may be an aspherical lens. For example, the object-side surface and the image-side surface of the first lens 1510 may be aspherical.

The second lens 1520 may have positive refractive power. An object-side surface and an image-side surface of the second lens 1520 may have a convex shape in the paraxial region. The second lens 1520 may be formed of plastic. The second lens 1520 may be an aspherical lens. For example, the object-side surface and the image-side surface of the second lens 1520 may be aspherical.

The third lens 1530 may have negative refractive power. An object-side surface and an image-side surface of the third lens 1530 may have a concave shape in the paraxial region. The third lens 1530 may be formed of plastic. In detail, the third lens 1530 may be formed of a plastic material with optical properties (e.g., refractive index and Abbe number) different from the second lens 1520. The third lens 1530 may be an aspherical lens. For example, the object-side surface and the image-side surface of the third lens 1530 may be aspherical.

The fourth lens 1540 may have positive refractive power. An object-side surface of the fourth lens 1540 may have a concave shape in the paraxial region, and an image-side surface of the fourth lens 1540 may have a convex shape in the paraxial region. The fourth lens 1540 may be formed of plastic. In detail, the fourth lens 1540 may be formed of a plastic material with optical properties (e.g., refractive index and Abbe number) different from the third lens 1530. The fourth lens 1540 may be an aspherical lens. For example, the object-side surface and the image-side surface of the fourth lens 1540 may be aspherical.

The fifth lens 1550 may have positive refractive power. An object-side surface of the fifth lens 1550 may have a concave shape in the paraxial region, and an image-side surface of the fifth lens 1550 may have a convex shape in the paraxial region. The fifth lens 1550 may be formed of plastic. In detail, the fifth lens 1550 may be formed of a plastic material with optical properties (e.g., refractive index and Abbe number) different from the fourth lens 1540. The fifth lens 1550 may be an aspherical lens. For example, the object-side surface and the image-side surface of the fifth lens 1550 may be aspherical.

The sixth lens 1560 may have negative refractive power. An object-side surface and an image-side surface of the sixth lens 1560 may have a concave shape in the paraxial region. The sixth lens 1560 may be formed of plastic. In detail, the sixth lens 1560 may be formed of a plastic material with optical properties (e.g., refractive index and Abbe number) different from the fifth lens 1550. The sixth lens 1560 may be an aspherical lens. For example, the object-side surface and the image-side surface of the sixth lens 1560 may be aspherical.

A prism P may be disposed between the first lens 1510 and the second lens 1520. The first lens 1510 disposed on the object side with respect to the prism P may constitute a first lens group LG1, and the second to sixth lenses 1520 to 1560 disposed on the image side with respect to the prism P may constitute a second lens group LG2. Both the first lens group LG1 and the second lens group LG2 may have positive refractive power.

Table 29 illustrates optical and physical parameters of the optical imaging system 1500 according to the fifteenth embodiment of the present disclosure.

TABLE 29

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 8.682 | 1.300 | 1.536 | 55.7 | 3.88 |
| 3 | 12.847 | 1.150 | | | 3.62 |
| 4 | Infinity | 3.200 | 1.931 | 20.9 | 2.90 |
| 5 | Infinity | 3.200 | 1.931 | 20.9 | 4.24 |
| 6 | Infinity | 3.300 | | | 2.90 |
| 7 | 4.042 | 1.729 | 1.536 | 55.7 | 2.70 |
| 8 | −12.724 | 0.172 | | | 2.57 |
| 9 | −11.420 | 1.076 | 1.619 | 25.9 | 2.52 |
| 10 | 3.957 | 1.122 | | | 2.06 |
| 11 | −121.139 | 0.405 | 1.546 | 56.3 | 2.15 |
| 12 | −24.965 | 0.384 | | | 2.26 |
| 13 | −25.654 | 1.220 | 1.667 | 20.4 | 2.35 |
| 14 | −4.255 | 0.622 | | | 2.42 |
| 15 | −16.861 | 0.614 | 1.644 | 23.5 | 2.30 |
| 16 | 8.348 | 4.300 | | | 2.53 |
| 17 | Infinity | 0.210 | 1.518 | 64.2 | 3.40 |
| 18 | Infinity | 1.244 | | | 3.42 |
| Image | Infinity | | | | 3.60 |

Table 30 illustrates aspheric data of the optical imaging system 1500 according to the fifteenth embodiment of the present disclosure.

TABLE 30

| Surface | 2 | 3 | 7 | 8 | 9 | 10 |
|---|---|---|---|---|---|---|
| K | −8.05E+00 | 4.86E+00 | 8.89E−01 | −1.69E+00 | 2.52E+00 | −1.08E+00 |
| A | 2.59E−03 | 1.15E−03 | −5.59E−04 | 7.46E−03 | −2.55E−04 | −7.62E−03 |
| B | −3.93E−04 | −4.94E−04 | 2.21E−04 | −2.22E−03 | 2.19E−04 | 1.93E−03 |
| C | 1.02E−04 | 1.61E−04 | −6.03E−04 | 8.01E−04 | 2.55E−05 | 6.40E−04 |
| D | −1.76E−05 | −3.32E−05 | 4.02E−04 | −3.16E−04 | −2.33E−06 | −4.07E−04 |
| E | 2.13E−06 | 4.66E−06 | −1.53E−04 | 9.74E−05 | 0.00E+00 | 9.73E−05 |
| F | −1.69E−07 | −4.43E−07 | 3.50E−05 | −2.03E−05 | 0.00E+00 | 4.37E−06 |
| G | 8.63E−09 | 2.73E−08 | −4.80E−06 | 2.65E−06 | 0.00E+00 | −7.06E−06 |
| H | −2.54E−10 | −9.76E−10 | 3.64E−07 | −1.95E−07 | 0.00E+00 | 1.32E−06 |
| J | 3.27E−12 | 1.52E−11 | −1.19E−08 | 6.07E−09 | 0.00E+00 | −7.95E−08 |
| Surface | 11 | 12 | 13 | 14 | 15 | 16 |
| K | 4.70E+01 | 3.72E+01 | −9.90E+01 | −1.71E+00 | 0.00E+00 | 4.66E+00 |
| A | −9.88E+01 | 9.90E+01 | −9.76E+01 | −1.76E+00 | 0.00E+00 | −1.69E+00 |
| B | −4.27E−03 | 4.94E−03 | 4.96E−03 | 6.09E−03 | −6.62E−03 | −1.54E−02 |
| C | 1.14E−05 | −1.12E−04 | 1.35E−03 | 7.50E−04 | −1.42E−03 | 8.02E−04 |
| D | 2.14E−04 | −1.74E−04 | −9.62E−04 | −1.42E−03 | 4.68E−05 | −3.47E−05 |
| E | −5.07E−05 | −1.69E−05 | 1.61E−04 | 5.61E−04 | 1.48E−05 | 1.63E−06 |
| F | −4.39E−06 | 9.28E−07 | −6.43E−06 | −1.37E−04 | −1.33E−06 | −4.94E−08 |
| G | 2.98E−07 | 2.14E−07 | −8.22E−07 | 2.19E−05 | 0.00E+00 | 0.00E+00 |
| H | 9.43E−17 | −2.13E−08 | 1.00E−07 | −2.12E−06 | 0.00E+00 | 0.00E+00 |
| J | 1.35E−18 | −1.20E−18 | −4.03E−09 | 1.10E−07 | 0.00E+00 | 0.00E+00 |

### Sixteenth Embodiment

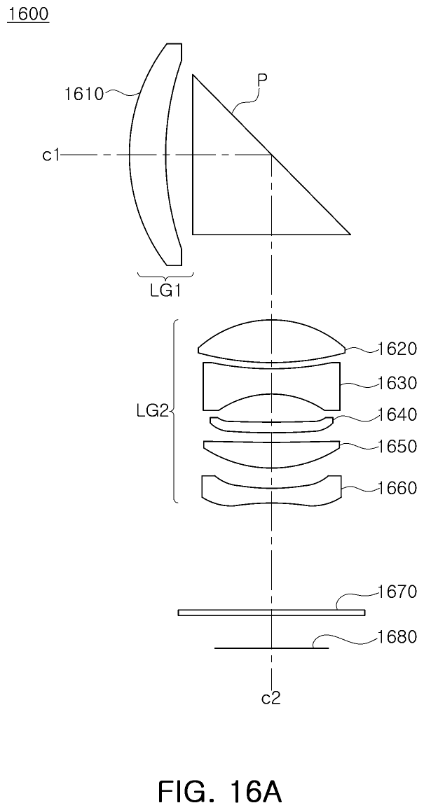

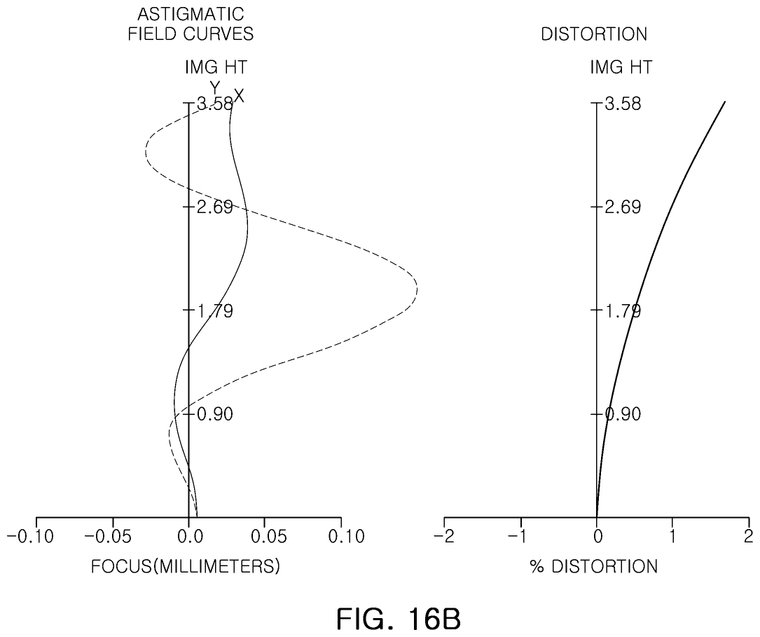

FIG. 16A is a block diagram of an optical imaging system according to a sixteenth embodiment of the present disclosure, and FIG. 16B is a graph illustrating aberration characteristics of an optical imaging system according to the sixteenth embodiment of the present disclosure.

An imaging optical system 1600 according to the sixteenth embodiment includes a first lens 1610, a second lens 1620, a third lens 1630, a fourth lens 1640, a fifth lens 1650, and a sixth lens 1660 arranged in order from an object side toward an image side, and may further include an infrared cut-off filter 1670 and an image sensor 1680 disposed on an image side of the sixth lens 1660.

The first lens 1610 may have positive refractive power. An object-side surface of the first lens 1610 may have a convex shape in the paraxial region, and an image-side surface of the first lens 1610 may have a concave shape in the paraxial region, that is, a meniscus shape convex toward the object side. The first lens 1610 may be formed of plastic. The first lens 1610 may be an aspherical lens. For example, the object-side surface and the image-side surface of the first lens 1610 may be aspherical.

The second lens 1620 may have positive refractive power. An object-side surface and an image-side surface of the second lens 1620 may have a convex shape in the paraxial region. The second lens 1620 may be formed of plastic. The second lens 1620 may be an aspherical lens. For example, the object-side surface and the image-side surface of the second lens 1620 may be aspherical.

The third lens 1630 may have negative refractive power. An object-side surface and an image-side surface of the third lens 1630 may have a concave shape in the paraxial region. The third lens 1630 may be formed of plastic. In detail, the third lens 1630 may be formed of a plastic material with optical properties (e.g., refractive index and Abbe number) different from the second lens 1620. The third lens 1630 may be an aspherical lens. For example, the object-side surface and the image-side surface of the third lens 1630 may be aspherical.

The fourth lens 1640 may have positive refractive power. An object-side surface of the fourth lens 1640 may have a concave shape in the paraxial region, and the image-side surface of the fourth lens 1640 may have a convex shape in the paraxial region. The fourth lens 1640 may be formed of plastic. In detail, the fourth lens 1640 may be formed of a plastic material with optical properties (e.g., refractive index and Abbe number) different from the third lens 1630. The fourth lens 1640 may be an aspherical lens. For example, the object-side surface and the image-side surface of the fourth lens 1640 may be aspherical.

The fifth lens 1650 may have positive refractive power. An object-side surface of the fifth lens 1650 may have a concave shape in the paraxial region, and an image-side surface of the fifth lens 1650 may have a convex shape in the paraxial region. The fifth lens 1650 may be formed of plastic. In detail, the fifth lens 1650 may be formed of a plastic material with optical properties (e.g., refractive index and Abbe number) different from the fourth lens 1640. The fifth lens 1650 may be an aspherical lens. For example, the object-side surface and the image-side surface of the fifth lens 1650 may be aspherical.

The sixth lens 1660 may have negative refractive power. The object-side surface and the image-side surface of the sixth lens 1660 may have a concave shape in the paraxial region. The sixth lens 1660 may be formed of plastic. In detail, the sixth lens 1660 may be formed of a plastic material with optical properties (e.g., refractive index and Abbe number) different from the fifth lens 1650. The sixth lens 1660 may be an aspherical lens. For example, the object-side surface and the image-side surface of the sixth lens 1660 may be aspherical.

A prism P may be disposed between the first lens 1610 and the second lens 1620. The first lens 1610 disposed on the object side with respect to the prism P may constitute a first lens group LG1, and the second to sixth lenses 1620 to 1660 disposed on the image side with respect to the prism P may constitute a second lens group LG2. Both the first lens group LG1 and the second lens group LG2 may have positive refractive power.

Table 31 illustrates optical and physical parameters of the optical imaging system 1600 according to the sixteenth embodiment of the present disclosure.

TABLE 31

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 8.679 | 1.300 | 1.536 | 55.7 | 3.88 |
| 3 | 12.841 | 1.1500 | | | 3.62 |
| 4 | Infinity | 3.200 | 1.931 | 20.9 | 2.90 |
| 5 | Infinity | 3.200 | 1.931 | 20.9 | 4.24 |
| 6 | Infinity | 3.300 | | | 2.90 |
| 7 | 4.041 | 1.713 | 1.536 | 55.7 | 2.68 |
| 8 | −12.621 | 0.172 | | | 2.57 |
| 9 | −11.342 | 1.082 | 1.619 | 25.9 | 2.51 |
| 10 | 3.970 | 1.095 | | | 2.06 |
| 11 | −108.544 | 0.403 | 1.546 | 56.3 | 2.14 |
| 12 | −24.967 | 0.395 | | | 2.25 |
| 13 | −25.851 | 1.243 | 1.667 | 20.4 | 2.35 |
| 14 | −4.256 | 0.630 | | | 2.42 |
| 15 | −17.286 | 0.619 | 1.644 | 23.5 | 2.30 |
| 16 | 8.206 | 4.300 | | | 2.53 |
| 17 | Infinity | 0.210 | 1.518 | 64.2 | 3.40 |
| 18 | Infinity | 1.240 | | | 3.42 |
| Image | Infinity | | | | 3.60 |

Table 32 illustrates aspheric data of the optical imaging system 1600 according to the sixteenth embodiment of the present disclosure.

TABLE 32

| Surface | 2 | 3 | 7 | 8 | 9 | 10 |
|---|---|---|---|---|---|---|
| K | −8.05E+00 | 4.85E+00 | 8.90E−01 | −1.64E+00 | 2.51E+00 | −1.08E+00 |
| A | 2.57E−03 | 1.11E−03 | −5.09E−04 | 7.43E−03 | −2.54E−04 | −7.49E−03 |
| B | −3.77E−04 | −4.49E−04 | 1.45E−04 | −2.22E−03 | 2.18E−04 | 1.52E−03 |
| C | 9.54E−05 | 1.37E−04 | −5.36E−04 | 7.97E−04 | 2.54E−05 | 1.17E−03 |
| D | −1.63E−05 | −2.61E−05 | 3.63E−04 | −3.14E−04 | −2.33E−06 | −8.06E−04 |
| E | 1.90E−06 | 3.41E−06 | −1.40E−04 | 9.66E−05 | 0.00E+00 | 2.85E−04 |
| F | −1.48E−07 | −3.08E−07 | 3.21E−05 | −2.00E−05 | 0.00E+00 | −5.03E−05 |
| G | 7.46E−09 | 1.86E−08 | −4.44E−06 | 2.61E−06 | 0.00E+00 | 2.54E−06 |
| H | −2.19E−10 | −6.69E−10 | 3.39E−07 | −1.91E−07 | 0.00E+00 | 3.96E−07 |
| J | 2.83E−12 | 1.07E−11 | −1.12E−08 | 5.96E−09 | 0.00E+00 | −4.22E−08 |
| Surface | 11 | 12 | 13 | 14 | 15 | 16 |
| K | −9.90E+01 | 9.90E+01 | −9.90E+01 | −1.75E+00 | 0.00E+00 | −1.66E+00 |
| A | −4.29E−03 | 4.95E−03 | 5.04E−03 | 6.09E−03 | −6.62E−03 | −1.54E−02 |
| B | 1.13E−05 | −1.10E−04 | 1.23E−03 | 7.43E−04 | −1.42E−03 | 8.02E−04 |
| C | 2.14E−04 | −1.73E−04 | −9.09E−04 | −1.44E−03 | 4.67E−05 | −3.48E−05 |
| D | −5.07E−05 | −1.68E−05 | 1.50E−04 | 5.73E−04 | 1.48E−05 | 1.63E−06 |
| E | −4.39E−06 | 9.34E−07 | −5.10E−06 | −1.40E−04 | −1.33E−06 | −5.18E−08 |
| F | 2.98E−07 | 2.15E−07 | −9.18E−07 | 2.24E−05 | 0.00E+00 | 0.00E+00 |
| G | 9.42E−17 | −2.15E−08 | 1.04E−07 | −2.17E−06 | 0.00E+00 | 0.00E+00 |
| H | 1.35E−18 | −1.20E−18 | −4.14E−09 | 1.13E−07 | 0.00E+00 | 0.00E+00 |
| J | 2.98E−20 | −1.50E−20 | 5.91E−11 | −2.40E−09 | 0.00E+00 | 0.00E+00 |

### Seventeenth Example

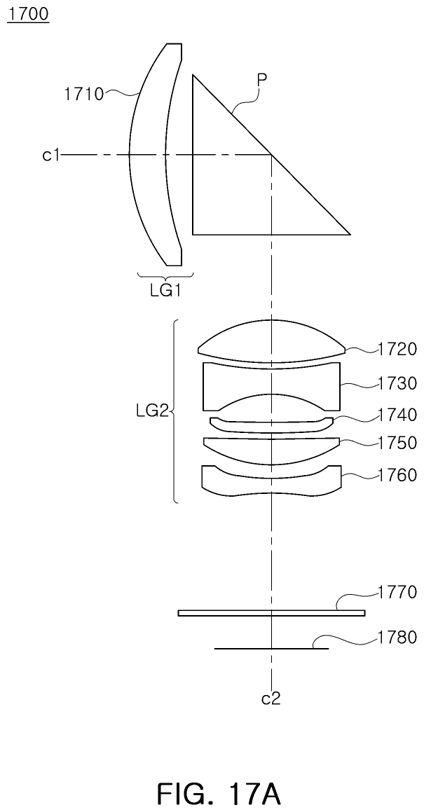

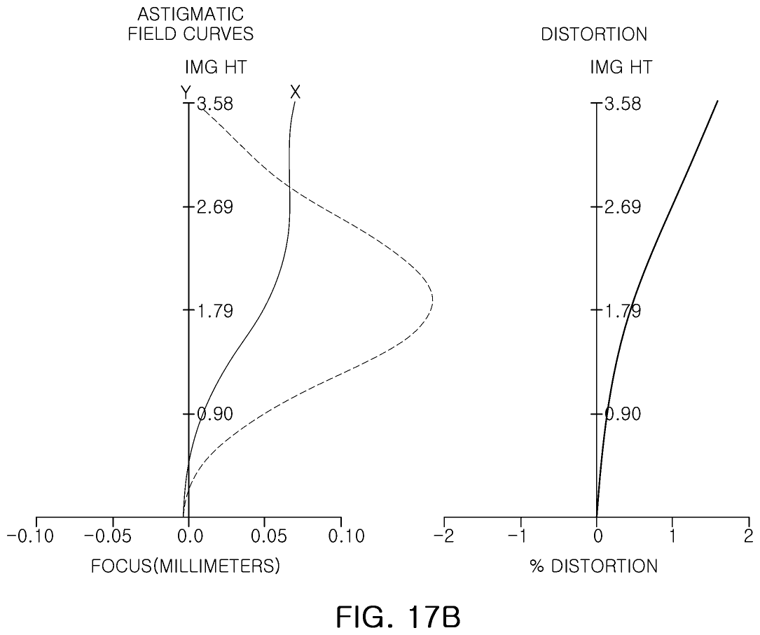

FIG. 17A is a block diagram of an optical imaging system according to a seventeenth embodiment of the present disclosure, and FIG. 17B is a graph illustrating aberration characteristics of an optical imaging system according to the seventeenth embodiment of the present disclosure.

An imaging optical system 1700 according to the seventeenth embodiment may include a first lens 1710, a second lens 1720, a third lens 1730, a fourth lens 1740, a fifth lens 1750, and a sixth lens 1760 arranged in order from an object side toward an image side, and may further include an infrared cut-off filter 1770 and an image sensor 1780 disposed on an image side of the sixth lens 1760.

The first lens 1710 may have positive refractive power. An object-side surface of the first lens 1710 may have a convex shape in the paraxial region, and an image-side surface of the first lens 1710 may have a concave shape in the paraxial region, that is, a meniscus shape convex toward the object side. The first lens 1710 may be formed of plastic. The first lens 1710 may be an aspherical lens. For example, the object-side surface and the image-side surface of the first lens 1710 may be aspherical.

The second lens 1720 may have positive refractive power. An object-side surface and an image-side surface of the second lens 1720 may have a convex shape in the paraxial region. The second lens 1720 may be formed of plastic. The second lens 1720 may be an aspherical lens. For example, the object-side surface and the image-side surface of the second lens 1720 may be aspherical.

The third lens 1730 may have negative refractive power. An object-side surface and an image-side surface of the third lens 1730 may have a concave shape in the paraxial region. The third lens 1730 may be formed of plastic. In detail, the third lens 1730 may be formed of a plastic material with optical properties (e.g., refractive index and Abbe number) different from the second lens 1720. The third lens 1730 may be an aspherical lens. For example, the object-side surface and the image-side surface of the third lens 1730 may be aspherical.

The fourth lens 1740 may have negative refractive power. An object-side surface of the fourth lens 1740 may have a concave shape in the paraxial region, and an image-side surface of the fourth lens 1740 may have a convex shape in the paraxial region. The fourth lens 1740 may be formed of plastic. In detail, the fourth lens 1740 may be formed of a plastic material with optical properties (e.g., refractive index and Abbe number) different from the third lens 1730. The fourth lens 1740 may be an aspherical lens. For example, the object-side surface and the image-side surface of the fourth lens 1740 may be aspherical.

The fifth lens 1750 may have positive refractive power. An object-side surface and an image-side surface of the fifth lens 1750 may have a convex shape in the paraxial region. The fifth lens 1750 may be formed of plastic. In detail, the fifth lens 1750 may be formed of a plastic material with optical properties (e.g., refractive index and Abbe number) different from the fourth lens 1740. The fifth lens 1750 may be an aspherical lens. For example, the object-side surface and the image-side surface of the fifth lens 1750 may be aspherical.

The sixth lens 1760 may have negative refractive power. An object-side surface and an image-side surface of the sixth lens 1760 may have a concave shape in the paraxial region. The sixth lens 1760 may be formed of plastic. In detail, the sixth lens 1760 may be formed of a plastic material with optical properties (e.g., refractive index and Abbe number) different from the fifth lens 1750. The sixth lens 1760 may be an aspherical lens. For example, the object-side surface and the image-side surface of the sixth lens 1760 may be aspherical.

A prism P may be disposed between the first lens 1710 and the second lens 1720. The first lens 1710 disposed on the object side with respect to the prism P may constitute a first lens group LG1, and the second to sixth lenses 1720 to 1760 disposed on the image side with respect to the prism P may constitute a second lens group LG2. Both the first lens group LG1 and the second lens group LG2 may have positive refractive power.

Table 33 illustrates optical and physical parameters of the optical imaging system 1700 according to the seventeenth embodiment of the present disclosure.

TABLE 33

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 8.313 | 1.300 | 1.536 | 55.7 | 3.88 |
| 3 | 12.008 | 1.150 | | | 3.62 |
| 4 | Infinity | 3.200 | 1.931 | 20.9 | 2.90 |
| 5 | Infinity | 3.200 | 1.931 | 20.9 | 4.24 |
| 6 | Infinity | 3.300 | | | 2.90 |
| 7 | 4.052 | 1.899 | 1.536 | 55.7 | 2.65 |
| 8 | −9.769 | 0.151 | | | 2.57 |
| 9 | −9.434 | 1.173 | 1.619 | 25.9 | 2.48 |
| 10 | 3.709 | 0.875 | | | 2.06 |
| 11 | −18.185 | 0.400 | 1.546 | 56.3 | 2.07 |
| 12 | −19.810 | 0.100 | | | 2.19 |
| 13 | 459.492 | 1.131 | 1.667 | 20.4 | 2.25 |
| 14 | −4.932 | 0.382 | | | 2.31 |
| 15 | −25.723 | 0.789 | 1.644 | 23.5 | 2.25 |
| 16 | 10.019 | 4.300 | | | 2.48 |
| 17 | Infinity | 0.110 | 1.518 | 64.2 | 3.40 |
| 18 | Infinity | 1.739 | | | 3.42 |
| Image | Infinity | | | | 3.60 |

Table 34 illustrates aspheric data of the optical imaging system 1700 according to the seventeenth embodiment of the present disclosure.

TABLE 34

| Surface | 2 | 3 | 7 | 8 | 9 | 10 |
|---|---|---|---|---|---|---|
| K | −7.92E+00 | 4.28E+00 | 9.19E−01 | 5.53E−01 | 2.37E+00 | −1.63E+00 |
| A | 2.37E−03 | 6.79E−04 | −3.12E−04 | 9.23E−03 | −2.20E−04 | −7.49E−03 |
| B | −2.79E−04 | −3.59E−04 | −2.25E−04 | −4.48E−03 | 1.95E−04 | −2.10E−03 |
| C | 7.69E−05 | 1.40E−04 | −3.39E−04 | 2.22E−03 | 2.69E−05 | 8.02E−03 |
| D | −1.44E−05 | −3.18E−05 | 2.62E−04 | −8.92E−04 | −4.24E−07 | −7.16E−03 |
| E | 1.73E−06 | 4.56E−06 | −1.04E−04 | 2.57E−04 | 0.00E+00 | 3.58E−03 |
| F | −1.33E−07 | −4.12E−07 | 2.41E−05 | −4.93E−05 | 0.00E+00 | −1.08E−03 |
| G | 6.24E−09 | 2.28E−08 | −3.35E−06 | 5.96E−06 | 0.00E+00 | 1.96E−04 |
| H | −1.63E−10 | −6.98E−10 | 2.58E−07 | −4.08E−07 | 0.00E+00 | −1.97E−05 |
| J | 1.82E−12 | 9.06E−12 | −8.62E−09 | 1.20E−08 | 0.00E+00 | 8.42E−07 |
| Surface | 11 | 12 | 13 | 14 | 15 | 16 |
| K | 4.42E+01 | 2.21E+01 | 9.90E+01 | −1.82E+00 | 0.00E+00 | 3.43E+00 |
| A | −3.74E−03 | 4.15E−03 | 3.31E−03 | 6.10E−03 | −5.00E−03 | −1.38E−02 |
| B | 2.98E−05 | 7.50E−05 | 2.03E−03 | 1.46E−04 | −1.26E−03 | 6.80E−04 |
| C | 2.07E−04 | −1.31E−04 | −1.07E−03 | −7.11E−04 | 3.30E−06 | −4.37E−05 |
| D | −4.91E−05 | −1.39E−05 | 1.09E−04 | 1.91E−04 | 8.26E−06 | 5.27E−07 |
| E | −3.34E−06 | 4.89E−07 | 1.61E−05 | −3.89E−05 | −5.86E−07 | 6.47E−08 |
| F | 3.65E−07 | 1.12E−07 | −4.33E−06 | 6.75E−06 | 0.00E+00 | 0.00E+00 |
| G | 6.74E−17 | −1.66E−09 | 3.69E−07 | −7.20E−07 | 0.00E+00 | 0.00E+00 |
| H | 5.70E−19 | −5.84E−19 | −1.42E−08 | 3.90E−08 | 0.00E+00 | 0.00E+00 |
| J | 2.55E−21 | −1.73E−20 | 2.11E−10 | −8.21E−10 | 0.00E+00 | 0.00E+00 |

### Eighteenth Embodiment

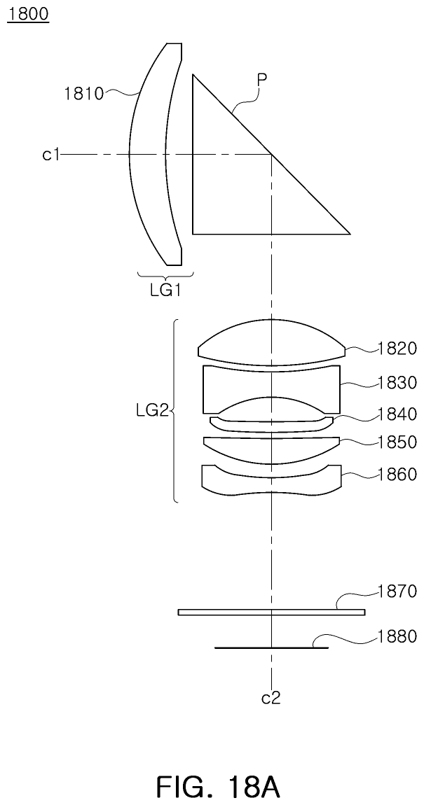

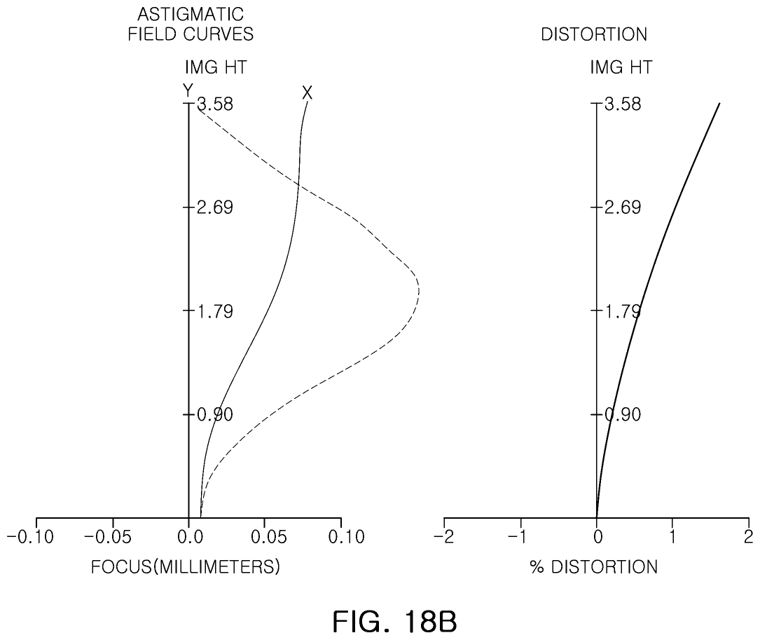

FIG. 18A is a block diagram of an optical imaging system according to an eighteenth embodiment of the present disclosure, and FIG. 18B is a graph illustrating aberration characteristics of an optical imaging system according to then eighteenth embodiment of the present disclosure.

An imaging optical system 1800 according to the eighteenth embodiment may include a first lens 1810, a second lens 1820, a third lens 1830, a fourth lens 1840, a fifth lens 1850, and a sixth lens 1860 arranged in order from an object side toward an image side, and may further include an infrared cut-off filter 1870 and an image sensor 1880 disposed on an image side of the sixth lens 1860.

The first lens 1810 may have positive refractive power. An object-side surface of the first lens 1810 may have a convex shape in the paraxial region, and an image-side surface of the first lens 1810 may be concave in the paraxial region, that is, a meniscus shape convex toward the object side. The first lens 1810 may be formed of plastic. The first lens 1810 may be an aspherical lens. For example, the object-side surface and the image-side surface of the first lens 1810 may be aspherical.

The second lens 1820 may have positive refractive power. An object-side surface and an image-side surface of the second lens 1820 may have a convex shape in the paraxial region. The second lens 1820 may be formed of plastic. The second lens 1820 may be an aspherical lens. For example, the object-side surface and the image-side surface of the second lens 1820 may be aspherical.

The third lens 1830 may have negative refractive power. An object-side surface and an image-side surface of the third lens 1830 may have a concave shape in the paraxial region. The third lens 1830 may be formed of plastic. In detail, the third lens 1830 may be formed of a plastic material with optical properties (e.g., refractive index and Abbe number) different from the second lens 1820. The third lens 1830 may be an aspherical lens. For example, the object-side surface and the image-side surface of the third lens 1830 may be aspherical.

The fourth lens 1840 may have negative refractive power. An object-side surface of the fourth lens 1840 may have a concave shape in the paraxial region, and an image-side surface of the fourth lens 1840 may have a convex shape in the paraxial region. The fourth lens 1840 may be formed of plastic. In detail, the fourth lens 1840 may be formed of a plastic material with optical properties (e.g., refractive index and Abbe number) different from the third lens 1830. The fourth lens 1840 may be an aspherical lens. For example, the object-side surface and the image-side surface of the fourth lens 1840 may be aspherical.

The fifth lens 1850 may have positive refractive power. An object-side surface of the fifth lens 1850 may have a concave shape in the paraxial region, and an image-side surface of the fifth lens 1850 may have a convex shape in the paraxial region. The fifth lens 1850 may be formed of plastic. In detail, the fifth lens 1850 may be formed of a plastic material with optical properties (e.g., refractive index and Abbe number) different from the fourth lens 1840. The fifth lens 1850 may be an aspherical lens. For example, an object-side surface and an image-side surface of the fifth lens 1850 may be aspherical.

The sixth lens 1860 may have negative refractive power. An object-side surface and an image-side surface of the sixth lens 1860 may have a concave shape in the paraxial region. The sixth lens 1860 may be formed of plastic. In detail, the sixth lens 1860 may be formed of a plastic material with optical properties (e.g., refractive index and Abbe number) different from the fifth lens 1850. The sixth lens 1860 may be an aspherical lens. For example, the object-side surface and the image-side surface of the sixth lens 1860 may be aspherical.

A prism P may be disposed between the first lens 1810 and the second lens 1820. The first lens 1810 disposed on the object side with respect to the prism P may constitute a first lens group LG1, and the second to sixth lenses 1820 to 1860 disposed on the image side with respect to the prism P may constitute a second lens group LG2. Both the first lens group LG1 and the second lens group LG2 may have positive refractive power.

Table 35 illustrates optical and physical parameters of the optical imaging system 1800 according to the eighteenth embodiment of the present disclosure.

TABLE 35

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 8.230 | 1.300 | 1.536 | 55.7 | 3.78 |
| 3 | 11.852 | 1.150 | | | 3.54 |
| 4 | Infinity | 3.200 | 1.931 | 20.9 | 2.90 |
| 5 | Infinity | 3.200 | 1.931 | 20.9 | 4.24 |
| 6 | Infinity | 3.300 | | | 2.90 |
| 7 | 4.036 | 1.929 | 1.536 | 55.7 | 2.65 |
| 8 | −9.521 | 0.612 | | | 2.57 |
| 9 | −9.095 | 1.110 | 1.619 | 25.9 | 2.48 |
| 10 | 3.684 | 0.895 | | | 2.06 |
| 11 | −17.030 | 0.400 | 1.546 | 56.3 | 2.07 |
| 12 | −18.230 | 0.116 | | | 2.20 |
| 13 | −52.386 | 1.061 | 1.667 | 20.4 | 2.27 |
| 14 | −4.512 | 0.398 | | | 2.34 |
| 15 | −23.687 | 0.860 | 1.644 | 23.5 | 2.29 |
| 16 | 10.777 | 4.300 | | | 2.55 |
| 17 | Infinity | 0.110 | 1.518 | 64.2 | 3.40 |
| 18 | Infinity | 1.750 | | | 3.42 |
| Image | Infinity | | | | 3.60 |

Table 36 illustrates aspheric data of the optical imaging system 1800 according to the eighteenth embodiment of the present disclosure.

TABLE 36

| Surface | 2 | 3 | 7 | 8 | 9 | 10 |
|---|---|---|---|---|---|---|
| K | −7.56E+00 | 4.58E+00 | 9.60E−01 | 9.95E−01 | 2.61E+00 | −1.71E+00 |
| A | 2.42E−03 | 8.24E−04 | −1.61E−04 | 9.01E−03 | −2.67E−04 | −7.44E−03 |
| B | −2.20E−04 | −2.74E−04 | −7.50E−04 | −3.62E−03 | 1.75E−04 | −3.19E−03 |
| C | 4.75E−05 | 8.12E−05 | 1.97E−05 | 1.51E−03 | 2.75E−05 | 1.02E−02 |
| D | −7.77E−06 | −1.54E−05 | 1.43E−04 | −5.74E−04 | 7.90E−07 | −9.48E−03 |
| E | 9.13E−07 | 1.98E−06 | −8.62E−05 | 1.67E−04 | 0.00E+00 | 5.04E−03 |
| F | −7.16E−08 | −1.67E−07 | 2.41E−05 | −3.35E−05 | 0.00E+00 | −1.63E−03 |
| G | 3.51E−09 | 8.63E−09 | −3.75E−06 | 4.29E−06 | 0.00E+00 | 3.17E−04 |
| H | −9.58E−11 | −2.42E−10 | 3.12E−07 | −3.14E−07 | 0.00E+00 | −3.42E−05 |
| J | 1.09E−12 | 2.67E−12 | −1.10E−08 | 9.86E−09 | 0.00E+00 | 1.57E−06 |
| Surface | 11 | 12 | 13 | 14 | 15 | 16 |
| K | 4.67E+01 | 2.61E+01 | 8.33E+01 | −1.83E+00 | 0.00E+00 | 3.26E+00 |
| A | −3.58E−03 | 4.02E−03 | 4.10E−03 | 6.59E−03 | −5.15E−03 | −1.39E−02 |
| B | 5.63E−05 | 6.42E−05 | 1.59E−03 | −5.04E−04 | −1.27E−03 | 6.75E−04 |
| C | 2.11E−04 | −1.34E−04 | −8.57E−04 | −2.84E−04 | 1.40E−06 | −4.33E−05 |
| D | −4.89E−05 | −1.50E−05 | 5.43E−05 | 3.85E−05 | 8.13E−06 | 5.78E−07 |
| E | −3.73E−06 | 2.10E−07 | 2.38E−05 | −6.46E−06 | −5.34E−07 | 7.02E−08 |
| F | 4.19E−08 | 6.47E−08 | −4.93E−06 | 2.51E−06 | 0.00E+00 | 0.00E+00 |
| G | 6.74E−17 | −1.01E−09 | 3.95E−07 | −3.87E−07 | 0.00E+00 | 0.00E+00 |
| H | 5.70E−19 | −5.87E−19 | −1.48E−08 | 2.46E−08 | 0.00E+00 | 0.00E+00 |
| J | 2.54E−21 | −1.74E−20 | 2.15E−10 | −5.62E−10 | 0.00E+00 | 0.00E+00 |

### Nineteenth Embodiment

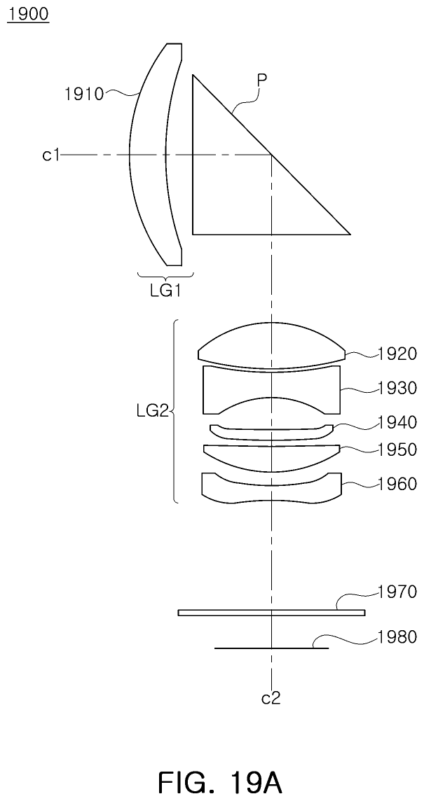

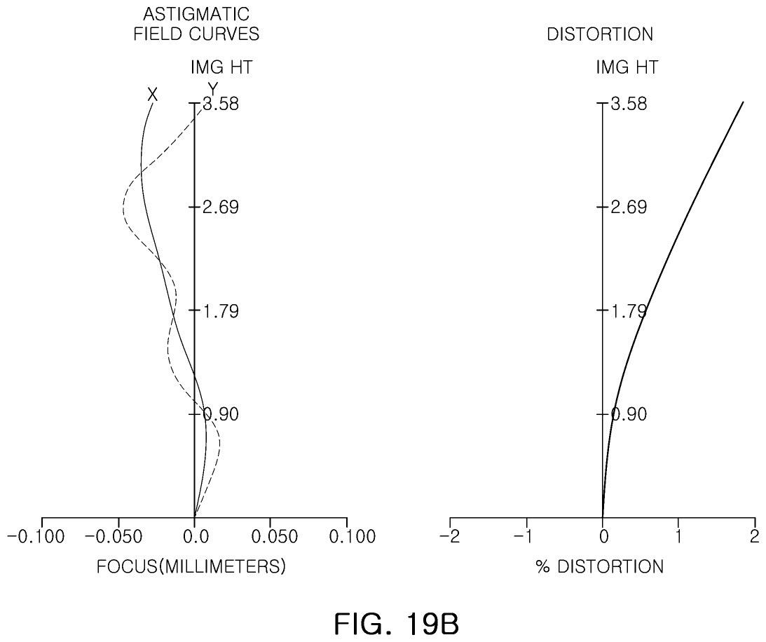

FIG. 19A is a block diagram of an optical imaging system according to a nineteenth embodiment of the present disclosure, and FIG. 19B is a graph illustrating aberration characteristics of an optical imaging system according to the nineteenth embodiment of the present disclosure.

An imaging optical system 1900 according to the nineteenth embodiment may include a first lens 1910, a second lens 1920, a third lens 1930, a fourth lens 1940, a fifth lens 1950, and a sixth lens 1960 arranged in order from an object side toward an image side, and may further include an infrared cut-off filter 1970 and an image sensor 1980 disposed on an image side of the sixth lens 1960.

The first lens 1910 may have positive refractive power. An object-side surface of the first lens 1910 may have a convex shape in the paraxial region, and an image-side surface of the first lens 1910 may have a concave shape in the paraxial region, that is, a meniscus shape convex toward the object side. The first lens 1910 may be formed of plastic. The first lens 1910 may be an aspherical lens. For example, the object-side surface and the image-side surface of the first lens 1910 may be aspherical.

The second lens 1920 may have positive refractive power. An object-side surface and an image-side surface of the second lens 1920 may have a convex shape in the paraxial region. The second lens 1920 may be formed of plastic. The second lens 1920 may be an aspherical lens. For example, the object-side surface and the image-side surface of the second lens 1920 may be aspherical.

The third lens 1930 may have negative refractive power. An object-side surface and an image-side surface of the third lens 1930 may have a concave shape in the paraxial region. The third lens 1930 may be formed of plastic. In detail, the third lens 1930 may be formed of a plastic material with optical properties (e.g., refractive index and Abbe number) different from the second lens 1920. The third lens 1930 may be an aspherical lens. For example, the object-side surface and the image-side surface of the third lens 1930 may be aspherical.

The fourth lens 1940 may have negative refractive power. An object-side surface of the fourth lens 1940 may have a concave shape in the paraxial region, and an image-side surface of the fourth lens 1940 may have a convex shape in the paraxial region. The fourth lens 1940 may be formed of plastic. In detail, the fourth lens 1940 may be formed of a plastic material with optical properties (e.g., refractive index and Abbe number) different from the third lens 1930. The fourth lens 1940 may be an aspherical lens. For example, the object-side surface and the image-side surface of the fourth lens 1940 may be aspherical.

The fifth lens 1950 may have positive refractive power. An object-side surface and an image-side surface of the fifth lens 1950 may have a convex shape in the paraxial region. The fifth lens 1950 may be formed of plastic. In detail, the fifth lens 1950 may be formed of a plastic material with optical properties (e.g., refractive index and Abbe number) different from the fourth lens 1940. The fifth lens 1950 may be an aspherical lens. For example, the object-side surface and the image-side surface of the fifth lens 1950 may be aspherical.

The sixth lens 1960 may have negative refractive power. An object-side surface and an image-side surface of the sixth lens 1960 may have a concave shape in the paraxial region. The sixth lens 1960 may be formed of plastic. In detail, the sixth lens 1960 may be formed of a plastic material with optical properties (e.g., refractive index and Abbe number) different from the fifth lens 1950. The sixth lens 1960 may be an aspherical lens. For example, the object-side surface and the image-side surface of the sixth lens 1960 may be aspherical.

A prism P may be disposed between the first lens 1910 and the second lens 1920. The first lens 1910 disposed on the object side with respect to the prism P may constitute a first lens group LG1, and the second to sixth lenses 1920 to 1960 disposed on the image side with respect to the prism P may constitute a second lens group LG2. Both the first lens group LG1 and the second lens group LG2 may have positive refractive power.

Table 37 illustrates optical and physical parameters of the optical imaging system 1900 according to the nineteenth embodiment of the present disclosure.

TABLE 37

| | Radius | Thickness/ | Refractive | Abbe | Semi- |
|---|---|---|---|---|---|
| Surface | Curvature | Distance | Index | number | Aperture |
| Object | Infinity | Infinity | | | |
| 1 | Infinity | 0.000 | | | |
| 2 | 8.418 | 1.300 | 1.536 | 55.7 | 3.78 |
| 3 | 12.226 | 1.150 | | | 3.54 |
| 4 | Infinity | 3.200 | 1.931 | 20.9 | 2.90 |
| 5 | Infinity | 3.200 | 1.931 | 20.9 | 4.24 |
| 6 | Infinity | 3.300 | | | 2.90 |
| 7 | 4.055 | 1.828 | 1.536 | 55.7 | 2.65 |
| 8 | −7.720 | 0.109 | | | 2.57 |
| 9 | −7.722 | 1.135 | 1.619 | 25.9 | 2.48 |
| 10 | 3.710 | 1.000 | | | 2.06 |
| 11 | −15.694 | 0.400 | 1.546 | 56.3 | 2.07 |
| 12 | −18.253 | 0.100 | | | 2.20 |
| 13 | 79.941 | 1.104 | 1.667 | 20.4 | 2.27 |
| 14 | −4.271 | 0.523 | | | 2.34 |
| 15 | −11.824 | 0.700 | 1.644 | 23.5 | 2.29 |
| 16 | 10.518 | 4.300 | | | 2.55 |
| 17 | Infinity | 0.110 | 1.518 | 64.2 | 3.40 |
| 18 | Infinity | 1.665 | | | 3.42 |
| Image | Infinity | | | | 3.60 |

Table 38 illustrates aspheric data of the optical imaging system 1900 according to the nineteenth embodiment of the present disclosure.

TABLE 38

| Surface | 2 | 3 | 7 | 8 | 9 | 10 |
|---|---|---|---|---|---|---|
| K | −7.64E+00 | 4.74E+00 | 1.02E+00 | 6.17E−01 | 2.41E+00 | −1.66E+00 |
| A | 2.17E−03 | 5.76E−04 | −3.27E−04 | 9.41E−03 | −2.07E−04 | −8.82E−03 |
| B | −9.41E−05 | −1.32E−04 | −5.98E−04 | −3.14E−03 | 1.76E−04 | 2.84E−04 |
| C | 8.83E−06 | 4.00E−05 | 5.98E−05 | 9.09E−04 | 2.78E−05 | 5.07E−03 |
| D | 1.33E−07 | −6.81E−06 | 7.18E−05 | −2.59E−04 | 1.27E−06 | −5.07E−03 |
| E | −1.82E−07 | 6.48E−07 | −5.70E−05 | 6.37E−05 | 0.00E+00 | 2.79E−03 |
| F | 2.75E−08 | −2.30E−08 | 1.82E−05 | −1.13E−05 | 0.00E+00 | −9.33E−04 |
| G | −2.02E−09 | −1.11E−09 | −3.14E−06 | 1.33E−06 | 0.00E+00 | 1.88E−04 |
| H | 7.55E−11 | 1.24E−10 | 2.87E−07 | −9.20E−08 | 0.00E+00 | −2.09E−05 |
| J | −1.14E−12 | −3.05E−12 | −1.11E−08 | 2.75E−09 | 0.00E+00 | 9.88E−07 |
| Surface | 11 | 12 | 13 | 14 | 15 | 16 |
| K | 4.66E+01 | 3.46E+01 | 4.44E+01 | −1.74E+00 | 0.00E+00 | 4.70E+00 |
| A | −3.50E−03 | 3.33E−03 | 3.35E−03 | 6.15E−03 | −4.76E−03 | −1.36E−02 |
| B | 2.84E−05 | 4.53E−05 | 1.20E−03 | −1.04E−03 | −1.22E−03 | 6.91E−04 |
| C | 2.02E−04 | −1.34E−04 | −6.36E−04 | 3.01E−05 | 3.40E−06 | −3.99E−05 |
| D | −5.00E−05 | −1.53E−05 | 3.09E−05 | −4.17E−05 | 8.52E−06 | 8.84E−07 |
| E | −3.61E−06 | 0.00E+00 | 1.99E−05 | 4.90E−06 | −3.18E−07 | 5.36E−08 |
| F | 0.00E+00 | 0.00E+00 | −3.84E−06 | 1.63E−06 | 0.00E+00 | 0.00E+00 |
| G | 0.00E+00 | 0.00E+00 | 2.95E−07 | −3.58E−07 | 0.00E+00 | 0.00E+00 |
| H | 0.00E+00 | 0.00E+00 | −1.07E−08 | 2.47E−08 | 0.00E+00 | 0.00E+00 |
| J | 0.00E+00 | 0.00E+00 | 1.51E−10 | −5.81E−10 | 0.00E+00 | 0.00E+00 |

Table 39 illustrates optical and physical parameters related to focal lengths and conditional expressions of the optical imaging system according to example embodiments of the present disclosure.

TABLE 39

| | Embodi- | Embodi- | Embodi- | Embodi- | Embodi- | Embodi- | Embodi- | Embodi- | Embodi- | Embodi- |
|---|---|---|---|---|---|---|---|---|---|---|
| | ment 1 | ment 2 | ment 3 | ment 4 | ment 5 | ment 6 | ment 7 | ment 8 | ment 9 | ment 10 |
| f | 20.000 | 21.000 | 20.000 | 18.000 | 21.000 | 22.000 | 21.000 | 19.000 | 21.000 | 16.570 |
| f1 | 39.986 | 40.106 | 46.624 | 74.606 | 75.155 | 75.289 | 73.849 | 76.899 | 60.000 | 45.000 |
| f2 | 6.964 | 6.892 | 5.821 | 7.439 | 7.476 | 7.464 | 7.464 | 7.453 | 7.470 | 5.864 |
| f3 | −4.840 | −4.824 | −3.950 | −5.092 | −5.138 | −5.132 | −5.130 | −5.105 | −5.062 | −4.748 |
| f4 | −1530.990 | −1138.571 | −361.860 | 28.835 | 115.338 | 242.273 | 67.006 | 30.434 | 89.283 | 127.051 |
| f5 | 8.274 | 7.951 | 5.669 | 6.894 | 7.062 | 6.871 | 6.802 | 6.741 | 6.509 | 7.758 |
| f6 | −13.830 | −12.613 | −8.361 | −7.141 | −8.814 | −8.815 | −7.957 | −6.906 | −7.655 | −8.923 |
| fLG1 | 39.900 | 40.106 | 46.624 | 74.606 | 75.155 | 75.289 | 73.849 | 76.899 | 60.000 | 45.000 |
| fLG2 | 36.080 | 40.650 | 31.660 | 22.911 | 28.798 | 30.933 | 28.939 | 24.563 | 33.075 | 23.680 |
| OAL | 27.584 | 28.204 | 27.141 | 27.313 | 28.526 | 29.077 | 28.634 | 27.702 | 28.058 | 25.260 |
| OAL1 | 5.733 | 5.700 | 5.510 | 5.400 | 5.200 | 5.250 | 5.400 | 5.400 | 5.200 | 5.650 |
| OAL2 | 21.851 | 22.504 | 21.631 | 21.913 | 23.326 | 23.827 | 23.234 | 22.302 | 22.858 | 19.610 |
| Fno | 2.770 | 2.930 | 3.000 | 2.400 | 2.900 | 3.140 | 2.880 | 2.630 | 2.830 | 2.250 |
| FOV | 22.6 | 21.8 | 21.8 | 24.7 | 21.2 | 20.3 | 21.5 | 23.5 | 21.1 | 24.04 |
| ODL1 | 4.00 | 4.00 | 4.25 | 4.18 | 4.00 | 3.90 | 4.05 | 4.00 | 4.10 | 4.40 |
| ODL2 | 3.05 | 3.05 | 2.97 | 3.48 | 3.48 | 3.48 | 3.48 | 3.48 | 3.48 | 3.20 |
| PSi | 2.70 | 2.70 | 2.80 | 2.90 | 2.90 | 2.90 | 2.90 | 2.90 | 2.90 | 2.90 |
| dP1 | 3.000 | 3.000 | 3.100 | 3.200 | 3.200 | 3.200 | 3.200 | 3.200 | 3.200 | 3.200 |
| dLG1 | 1.306 | 1.286 | 1.250 | 1.200 | 1.100 | 1.100 | 1.200 | 1.200 | 1.100 | 1.300 |
| dLG2 | 8.309 | 8.046 | 6.582 | 9.403 | 8.470 | 8.113 | 8.592 | 9.292 | 8.446 | 7.522 |
| d(LG1P) | 1.427 | 1.414 | 1.160 | 1.000 | 0.900 | 0.950 | 1.000 | 1.000 | 0.900 | 1.150 |
| d(PLG2) | 2.631 | 2.631 | 2.767 | 3.100 | 3.000 | 2.900 | 2.900 | 2.800 | 2.800 | 3.300 |
| d(LG12) | 10.058 | 10.045 | 10.127 | 10.500 | 10.300 | 10.250 | 10.300 | 10.200 | 10.100 | 10.850 |
| R1 | 9.370 | 9.365 | 9.284 | 9.224 | 9.249 | 9.246 | 9.221 | 9.215 | 9.205 | 9.186 |
| R2 | 15.813 | 15.772 | 14.058 | 11.440 | 11.503 | 11.491 | 11.471 | 11.326 | 12.353 | 14.092 |
| R3 | 4.480 | 4.477 | 4.347 | 5.418 | 5.411 | 5.415 | 5.420 | 5.438 | 5.447 | 4.105 |

| | Embodi- | Embodi- | Embodi- | Embodi- | Embodi- | Embodi- | Embodi- | Embodi- | Embodi- |
|---|---|---|---|---|---|---|---|---|---|
| | ment 11 | ment 12 | ment 13 | ment 14 | ment 15 | ment 16 | ment 17 | ment 18 | ment 19 |
| f | 16.570 | 16.570 | 16.570 | 16.570 | 16.570 | 16.567 | 16.567 | 16.567 | 16.567 |
| f1 | 44.965 | 45.000 | 44.892 | 45.000 | 45.000 | 45.000 | 44.831 | 44.588 | 45.000 |
| f2 | 5.898 | 5.958 | 5.895 | 5.087 | 5.930 | 5.917 | 5.607 | 5.559 | 5.239 |
| f3 | −4.710 | −4.578 | −4.850 | −3.782 | −4.626 | −4.628 | −4.161 | −4.102 | −3.902 |
| f4 | 85.205 | 49.570 | 141.237 | −211.430 | 57.530 | 59.311 | −444.614 | −537.037 | −217.126 |
| f5 | 7.881 | 7.621 | 7.849 | 5.954 | 7.482 | 7.472 | 7.328 | 7.343 | 6.115 |
| f6 | −9.072 | −8.818 | −8.898 | −8.204 | −8.588 | −8.559 | −11.100 | −11.394 | −8.538 |
| fLG1 | 44.965 | 45.000 | 44.892 | 45.000 | 45.000 | 45.000 | 44.831 | 44.588 | 45.000 |
| fLG2 | 23.497 | 23.150 | 23.676 | 22.595 | 23.240 | 23.294 | 22.948 | 22.754 | 22.503 |
| OAL | 22.250 | 22.250 | 22.250 | 22.250 | 22.250 | 22.250 | 25.200 | 25.200 | 25.120 |
| OAL1 | 5.650 | 5.650 | 5.650 | 5.650 | 5.650 | 5.650 | 5.650 | 5.650 | 5.650 |
| OAL2 | 19.600 | 19.600 | 19.600 | 19.600 | 19.600 | 19.600 | 19.550 | 19.550 | 19.470 |
| Fno | 2.300 | 2.300 | 2.300 | 2.400 | 2.300 | 2.300 | 2.300 | 2.300 | 2.300 |
| FOV | 24.04 | 24.04 | 24.04 | 24.04 | 24.04 | 24.04 | 24.04 | 24.04 | 24.04 |
| ODL1 | 4.44 | 4.44 | 4.26 | 4.44 | 4.28 | 4.28 | 4.28 | 4.18 | 4.18 |
| ODL2 | 3.20 | 3.12 | 3.23 | 3.12 | 3.10 | 3.08 | 3.05 | 3.05 | 3.05 |
| PSi | 2.90 | 2.90 | 2.90 | 2.90 | 2.90 | 2.90 | 2.90 | 2.90 | 2.90 |
| dP1 | 3.200 | 3.200 | 3.200 | 3.200 | 3.200 | 3.200 | 3.200 | 3.200 | 3.200 |
| dLG1 | 1.300 | 1.300 | 1.300 | 1.300 | 1.300 | 1.300 | 1.300 | 1.300 | 1.300 |
| dLG2 | 7.545 | 7.263 | 7.645 | 6.900 | 7.346 | 7.351 | 6.900 | 6.900 | 6.900 |
| d(LG1P) | 1.150 | 1.150 | 1.150 | 1.150 | 1.150 | 1.150 | 1.150 | 1.150 | 1.150 |
| d(PLG2) | 3.300 | 3.300 | 3.300 | 3.300 | 3.300 | 3.300 | 3.300 | 3.300 | 3.300 |
| d(LG12) | 10.850 | 10.850 | 10.850 | 10.850 | 10.850 | 10.850 | 10.850 | 10.850 | 10.850 |
| R1 | 9.196 | 9.031 | 9.041 | 8.496 | 8.682 | 8.679 | 8.313 | 8.230 | 8.418 |
| R2 | 14.126 | 13.700 | 13.746 | 12.406 | 12.847 | 12.841 | 12.008 | 11.852 | 12.226 |
| R3 | 4.101 | 4.063 | 4.109 | 4.053 | 4.042 | 4.041 | 4.052 | 4.036 | 4.055 |

The optical imaging system according to example embodiments of the present disclosure described above has the effect of improving low-light image capturing performance.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens group, including at least one lens disposed in a direction of a first optical axis;
a second lens group, including at least one lens disposed in a direction of a second optical axis, perpendicular to the first optical axis; and
a prism disposed between the first lens group and the second lens group and configured to convert a path of light from the direction of the first optical axis to the direction of the second optical axis,
wherein a conditional expression 0.20<d(LG1P)/d(PLG2)<0.60 is satisfied,
where d(LG1P) is a distance on the first optical axis from an image-side surface of a lens disposed closest to an image side of the first lens group to an incident surface of the prism, and d(PLG2) is a distance on the second optical axis from an exit surface of the prism to an object-side surface of a lens disposed closest to an object side of the second lens group.

2. The optical imaging system according to claim 1, wherein the first lens group includes a first lens having positive refractive power, and the second lens group includes a second lens having positive refractive power, a third lens having negative refractive power, a fourth lens having refractive power, a fifth lens having positive refractive power, and a sixth lens having negative refractive power.

3. The optical imaging system according to claim 1, wherein a conditional expression 0.70 (mm⁻¹)≤Fno/dP1<1.00 (mm⁻¹) is satisfied,
where Fno is an f-number of the optical imaging system, and dP1 is a distance on the first optical axis from the incident surface of the prism to a reflection surface of the prism.

4. The optical imaging system according to claim 1, wherein a conditional expression 0.95≤fLG1/fLG2≤3.50 is satisfied,
where fLG1 is a focal length of the first lens group, and fLG2 is a focal length of the second lens group.

5. The optical imaging system according to claim 1, wherein a conditional expression 2.20≤Fno<3.20 is satisfied,
where Fno is an f-number of the optical imaging system.

6. The optical imaging system according to claim 1, wherein a conditional expression 8.00 mm<dLG12<11.00 mm is satisfied,
where dLG12 is a distance from an image-side surface of a lens disposed closest to the image side in the first lens group to an object-side surface of a lens disposed closest to an object side in the second lens group.

7. The optical imaging system according to claim 1, wherein a conditional expression 0.10≤f/fLG1<0.60 is satisfied,
where f is a total focal length of the optical imaging system, and fLG1 is a focal length of the first lens group.

8. The optical imaging system according to claim 1, wherein a conditional expression 0.50≤f/fLG2<0.95 is satisfied,
where f is a total focal length of the optical imaging system, and fLG2 is a focal length of the second lens group.

9. The optical imaging system according to claim 1, wherein a conditional expression 0.20<dLG2/OAL≤0.40 is satisfied,
where dLG2 is a distance on an optical axis from an object-side surface of a lens disposed closest to an object side to an image-side surface of a lens disposed closest to an image side, among lenses included in the second lens group, and OAL is a sum of a distance on the first optical axis from the object-side surface of the lens disposed closest to the object side in the first lens group to the reflection surface of the prism and a distance on the second optical axis from the reflection surface of the prism to an image plane.

10. An optical imaging system, comprising:
a first lens, a second lens, a third lens, a fourth lens, a fifth lens, and a sixth lens disposed in order from an object side toward an image side; and
a prism disposed between the first lens and the second lens to convert a path of incident light from a direction of a first optical axis to a direction of a second optical axis,
wherein a conditional expression 8.00 mm<dLG12<11.00 mm is satisfied,
where dLG12 is a distance on an optical axis from an image-side surface of the first lens to an object-side surface of the second lens.

11. The optical imaging system according to claim 10, wherein the third lens has negative refractive power, and both an object-side surface and an image-side surface thereof have a concave shape.

12. The optical imaging system according to claim 10, wherein a conditional expression 17.00 mm<R1+R2<30.00 mm is satisfied,
where R1 is a radius of curvature of an object-side surface of the first lens, and R2 is a radius of curvature of an image-side surface of the first lens.

13. The optical imaging system according to claim 10, wherein the fourth lens has negative refractive power and a concave image-side surface.

14. The optical imaging system according to claim 10, wherein a conditional expression 0.20<dLG2/OAL≤0.40 is satisfied,
where dLG2 is a distance from an object-side surface of the second lens to an image-side surface of the sixth lens, and OAL is a sum of a distance on the first optical axis from an object-side surface of the first lens to a reflection surface of the prism and a distance on the second optical axis from the reflection surface of the prism to an image plane.

15. The optical imaging system according to claim 10, wherein a conditional expression 0.20≤OAL1/OAL2≤0.35 is satisfied,
where OAL1 is a distance on the first optical axis from an object-side surface of the first lens to a reflection surface of the prism, and OAL2 is a distance on the second optical axis from the reflection surface of the prism to an image plane.

16. The optical imaging system according to claim 10, wherein the first lens constitutes a first lens group, and the second to sixth lenses constitute a second lens group, and
wherein a conditional expression 0.95≤fLG1/fLG2≤3.50 is satisfied,
where fLG1 is a focal length of the first lens group, and fLG2 is a focal length of the second lens group.

17. The optical imaging system according to claim 10, wherein a conditional expression 1.25<ODL1/PSi<1.60 is satisfied,
where ODL1 is half an outer diameter of the first lens, and PSi is a length of an incident surface of the prism in a direction, perpendicular to the first optical axis.

18. An optical imaging system, comprising:
a first lens group including a first lens having refractive power;
a second lens group, including a second lens having refractive power, a third lens having negative refractive power, a fourth lens having refractive power, a fifth lens having refractive power, and a sixth lens having negative refractive power disposed in order from an object side toward an image side; and
a prism disposed between the first lens and the second lens to convert a path of incident light from a direction of a first optical axis to a direction of a second optical axis.

19. The optical imaging system according to claim 18, wherein the third lens has a concave object-side surface.

20. The optical imaging system according to claim 18, wherein a conditional expression 0.20≤OAL1/OAL2≤0.35 is satisfied,
where OAL1 is a distance on the first optical axis from an object-side surface of the first lens to a reflection surface of the prism, and OAL2 is a distance on the second optical axis from the reflection surface of the prism to an image plane.
